(19) United States
(12) Patent Application Publication
(10) Pub. No.: US 2026/0122254 A1
(43) Pub. Date: Apr. 30, 2026

(54) HARDWARE-ACCELERATED INTRA FRAME ENCODING

(71) Applicant: Intel Corporation, Santa Clara, CA (US)

(72) Inventors: James Michael Holland, Folsom, CA (US); Akshayy Narayanaram, Fremont, CA (US); Dmitry Ryzhov, Mountain View, CA (US); Atthar Hussain Mohammed, Folsom, CA (US); Ce Wang, Bellevue, WA (US); Tsung-Han Yang, Folsom, CA (US)

(73) Assignee: Intel Corporation, Santa Clara, CA (US)

(21) Appl. No.: 19/341,719

(22) Filed: Sep. 26, 2025

Related U.S. Application Data
(60) Provisional application No. 63/714,585, filed on Oct. 31, 2024.

(51) Int. Cl. H04N 19/176; H04N 19/147; H04N 19/196; H04N 19/436; H04N 19/593

(52) U.S. Cl. CPC H04N 19/176; H04N 19/147; H04N 19/196; H04N 19/593; H04N 19/436

(57) ABSTRACT

Example systems, apparatus, articles of manufacture, and methods to implement hardware-accelerated intra frame encoding are disclosed. Example hardware-accelerated intra frame video encoders disclosed herein are VC3 compliant. Some example video encoders disclosed herein quantize alternating current (AC) coefficients of a macroblock of an input image frame using a small set of anchor quantization scale factors (QSFs), and interpolate between the resulting bit counts for the first anchor QSFs to determine an estimated QSF meets a target bit budget. Some example video encoders disclosed herein perform bit coding with a round-robin packing strategy that distributes the packing of encoded symbols among macroblocks and discards excess symbols to avoid exceeding the specified frame size. Some example video encoders disclosed herein are configurable via control circuitry and/or a driver that selects target bit budgets, anchor QSFs, encoding modes, etc., thereby enabling single or multi pass operation and adjustable performance versus quality trade-offs.

### RELATED APPLICATION(S)

This patent claims the benefit of U.S. Provisional Patent Application No. 63/714,585, which was filed on Oct. 31, 2024. Priority to U.S. Provisional Patent Application No. 63/714,585 is hereby claimed. U.S. Provisional Patent Application No. 63/714,585 is hereby incorporated herein by reference in its entirety.

### BACKGROUND

Video codecs compliant with the Society of Motion Picture and Television Engineers (SMPTE) VC-3 standard, such as the DNxHD video codec and the DNxHR video codec by Avid®, and analogous codecs, such as the ProRes codec by Apple®, are used for video editing in the media industry. Such video codecs employ intra frame coding with the goal of achieving fast random-access editing speeds.

### BRIEF DESCRIPTION OF THE DRAWINGS

FIG. 1 is a block diagram of example video encoder circuitry implemented in accordance with teachings of this disclosure.

FIG. 2 is a block diagram of an example implementation of the video encoder circuitry of FIG. 1 that illustrates example control circuitry and control inputs included in the video encoder circuitry of FIG. 1.

FIG. 3 illustrates example control settings to configure the video encoder circuitry of FIG. 2 in different example target usage (TU) modes.

FIG. 4 illustrates a first example configuration of the video encoder circuitry of FIG. 2 to implement a first example TU mode.

FIG. 5 illustrates a second example configuration of the video encoder circuitry of FIG. 2 to implement a second example TU mode.

FIG. 6 illustrates a third example configuration of the video encoder circuitry of FIG. 2 to implement a third example TU mode.

FIG. 7 is a block diagram of example quantization scale factor (QSF) solver circuitry included in the video encoder circuitry of FIGS. 1 and/or 2.

FIG. 8 illustrates an example interpolation operation performed by the QSF solver circuitry of FIGS. 1, 2 and/or 7.

FIG. 9A is a block diagram of example bit coding circuitry included in the video encoder circuitry of FIGS. 1 and/or 2.

FIG. 9B illustrates an example operation of the bit coding circuitry of FIG. 9A.

FIGS. 10A-10D illustrate an example input/output (I/O) interface implemented by the video encoder circuitry of FIGS. 1 and/or 2.

FIG. 11 illustrates an example hardware pipeline that can be used to implement the video encoder circuitry of FIGS. 1 and/or 2.

FIGS. 12-14 illustrate example timing diagrams associated with the hardware pipeline of FIG. 11.

FIGS. 15A-15B illustrate an example single-pass operation of the video encoder circuitry of FIG. 2 to implement the first example TU mode.

FIGS. 16A-16B illustrate an example two-pass operation of the video encoder circuitry of FIG. 2 to implement the second example TU mode.

FIGS. 17A-17B illustrate an example two-pass operation of the video encoder circuitry of FIG. 2 to implement the third example TU mode.

FIGS. 18A-18B illustrate an example two-pass operation of the video encoder circuitry of FIG. 2 to implement a fourth example TU mode.

FIG. 19 is a flowchart representative of example machine-readable instructions and/or example operations that may be executed, instantiated, and/or performed by example programmable circuitry to configure the video encoder circuitry of FIG. 2 to implement the first example TU mode.

FIG. 20 is a flowchart representative of example machine-readable instructions and/or example operations that may be executed, instantiated, and/or performed by example programmable circuitry to configure the video encoder circuitry of FIG. 2 to implement the second example TU mode.

FIG. 21 is a flowchart representative of example machine-readable instructions and/or example operations that may be executed, instantiated, and/or performed by example programmable circuitry to configure the video encoder circuitry of FIG. 2 to implement the third example TU mode.

FIG. 22 is a flowchart representative of example machine-readable instructions and/or example operations that may be executed, instantiated, and/or performed by example programmable circuitry to configure the video encoder circuitry of FIG. 2 to implement the fourth example TU mode.

FIG. 23 is a block diagram of an example processing platform including programmable circuitry structured to execute, instantiate, and/or perform the example machine-readable instructions and/or perform the example operations of FIGS. 19-22 to implement an example encoder driver to configure operation of the video encoder circuitry of FIGS. 1 and/or 2.

FIG. 24 is a block diagram of an example implementation of the programmable circuitry of FIG. 23.

FIG. 25 is a block diagram of another example implementation of the programmable circuitry of FIG. 23.

FIG. 26 is a block diagram of an example software/firmware/instructions distribution platform (e.g., one or more servers) to distribute software, instructions, and/or firmware (e.g., corresponding to the example machine-readable instructions of FIGS. 19-22) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Intra frame video codecs, such as the DNxHD video codec and the DNxHR video codec by Avid®, and the ProRes codec by Apple®, are used for video editing in the media industry due to their fast random-access editing speeds. Such intra frame codecs forego more complex inter frame coding and motion-based prediction techniques, which can produce higher compression rates, in favor of intra frame coding techniques, which produce encoded frames that may be larger but retain more fidelity and do not have inter-frame dependencies. As such, the encoded frames produced by such intra frame codecs can be decoded in arbitrary order. Therefore, editing systems employing such intra frame codecs can feel more responsive when editing video that systems employing inter frame codecs.

However, the aforementioned intra frame codecs utilized for video editing have been in use since before the emergence of video codec employing hardware-accelerated compression and decompression, such as the video codecs associated with modern video standards, such as Advanced Video Coding (AVC), High-Efficiency Video Coding (HEVC), AOMedia Video 1 (AV1) and so on. As such, intra frame codecs utilized for video editing have been executed historically on computers using central processing unit (CPU) software.

An example VC-3 hardware-accelerated video encoder is disclosed herein. An important feature of this encoder is its speed, as hardware acceleration can save power and improve encoder speed and throughput relative to CPU implementations, especially on thin and light systems, thereby further enhancing the responsiveness and overall performance of video editing systems. Examples disclosed herein also solve other challenges that encoders face to optimize quality and performance. For example, one of the challenges VC-3 encoders face is balancing the maximization of the bits utilized to encode the image/video data (e.g., to maximize quality) while not exceeding the frame size bit limit set in the VC-3 specification by even one bit. The latter challenge is especially important to meet to enable video decoders to decode frames in arbitrary order. For example, by ensuring the encoded frame meets the specified frame size exactly, the decoder is able to jump to the start of any arbitrary frame by using the pointer arithmetic of Equation 1:

Pointer offset to initial bit of Nth frame=desired frame number N×fixed frame size Equation 1

To encode a frame to meet the specified frame size exactly, zero padding may be used to fill any unused bits, leaving potential quality on the table. Example VC-3 hardware accelerated encoders disclosed herein reduce or minimize this zero padding (to meaningfully use all available bits) while ensuring a video frame is encoded to meet its specified frame size exactly (to preserve instantaneous seek based on pointer offsets according to Equation 1).

Example VC-3 hardware-accelerated video encoders disclosed herein provide several features. For example, some VC-3 hardware-accelerated video encoders disclosed herein encode an intra video frame to approach but not exceed exact size limitations without any a priori information or requiring multiple frame encoding iterations. Some such disclosed example video encoders achieve such operation by determining precise quantized bit usage calculations for a given macroblock at multiple anchor quantization scale factors (QSFs) computed in parallel. Some such disclosed example video encoders also implement an interpolation technique between anchor QSFs to arrive at an estimated (e.g., approximate) QSF that meets a target bit budget for the given macroblock. Some such disclosed example video encoders implement a novel coefficient packing technique that efficiently discards excess encoded bits to achieve the specified target frame size with minimal visual impact.

Some disclosed example VC-3 hardware-accelerated video encoders collect information (e.g., metadata) during an initial (e.g., fully compliant) frame encoding iteration to enable an optional higher objective quality result upon a subsequent encoding iteration of the same frame. In some such examples, the subsequent encoding iteration of the same frame achieves an encoded frame that meets the specified target frame size but with improved objective quality relative to an encoded frame resulting from the initial frame encoding iteration. In some examples, the subsequent encoding iteration may be performed with or without software intervention.

For example, to perform the subsequent encoding iteration without software intervention, some disclosed example VC-3 hardware-accelerated video encoders use interpolation between the anchor QSFs to determine an estimated QSF (potentially with fractional precision) to encode the entire image frame and generates respective macroblock bit budgets by scaling the bit budget results found during the initial encoding iteration. As another example, to perform the subsequent encoding iteration with software intervention, some disclosed example VC-3 hardware-accelerated video encoders quilt together a combination of the anchor QSFs for the different macroblock of the image frame using metadata collected in the initial iteration. Such metadata may include the slopes of non-zero coefficients versus the bits saved to allow rate-distortion optimization (RDO) without requiring reconstruction.

The foregoing features enable 8K video to be encoded by disclosed example VC-3 hardware accelerated encoders in real-time at high quality while maintaining strict encoded frame bit limits without a priori information, and while meeting subjective and objective quality metrics. Moreover, low total die power (TDP) systems that include example VC-3 hardware accelerated encoders as disclosed herein can implement video editing packages without loud fan noise or poor battery life. Finally, through the flexibility provided by the features mentioned above, various applications can further trade performance vs. quality when encoding videos.

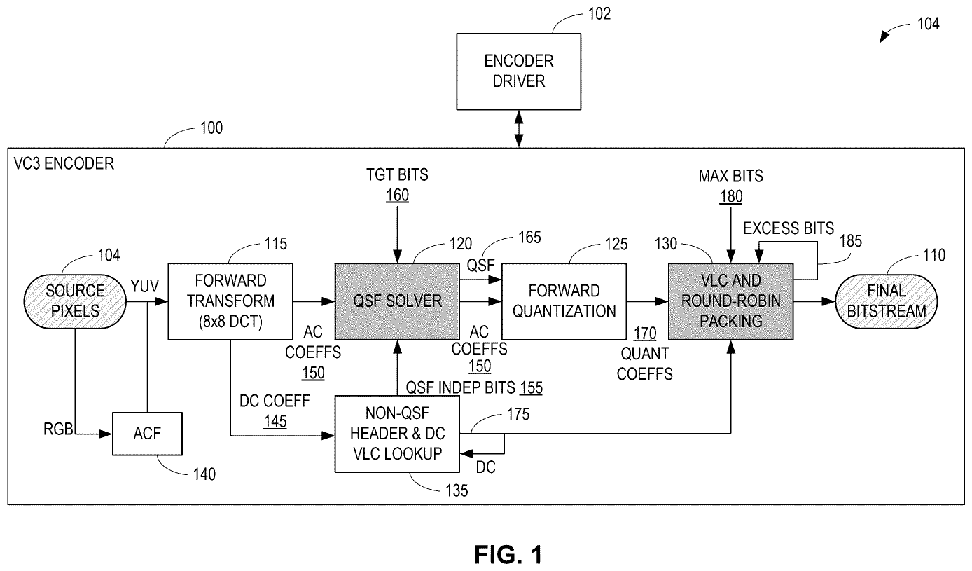

Turning to the figures, FIG. 1 is a block diagram of example video encoder circuitry 100 implemented in accordance with teachings of this disclosure. The video encoder circuitry 100 of FIG. 1 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the video encoder circuitry 100 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

The example video encoder circuitry 100 of FIG. 1 is shown in combination with an example encoder driver 102. The encoder driver 102 of the illustrated example operates to configure operation of the video encoder circuitry 100 to encode an input image frame 105 to generate an output encoded bitstream 110. The encoder driver 102 can be implemented by one or more of a software driver executed by one or more programmable circuits, a controller implemented by hardware circuitry, etc., or any combination thereof. In the illustrated example of FIG. 1, the video encoder circuitry 100 and encoder driver 102 are included in an example video encoding system 104.

The video encoder circuitry 100 of the illustrated example is a VC-3 compliant video encoder that accepts the input image frame 105, which includes source pixels, and generates the output encoded bitstream 110, which includes VC-3-encoded versions of the input image frame 105. For example, the video encoder circuitry 100 may comply with any past, present or future version of the VC-3 standards, such as SMPTE ST 2019-1, “VC-3 Picture Compression and Data Stream Format,” 2016. The video encoder circuitry 100 may store the output encoded bitstream 110 in one or more memories, storage devices, etc., transmit the output encoded bitstream 110 to one or more recipient devices, provide the output encoded bitstream 110 to one or more video editing systems, etc.

The example video encoder circuitry 100 includes example forward transform circuitry 115, example QSF solver circuitry 120, example forward quantization circuitry 125, example bit coding circuitry 130, example non-quantizable data encoder circuitry 135, and example color space conversion circuitry 140. In the illustrated example, the source pixels of the input image 105 can be encoded in RGB format with red (R), green (G) and blue (B) components, or in YUV format with luminance (Y) and chrominance (UV) components. If the source pixels of the input image 105 are in RGB format, the color space conversion circuitry 140 can optionally convert the source pixels of the input image 105 to YUV format (e.g., per macroblock).

The forward transform circuitry 115 of the illustrated example transforms the source pixels of the input image 105 (e.g., in YUV format) to generate transform coefficients representative of the input image 105. In the illustrated example, the forward transform circuitry 115 transforms the source pixels of the input image 105 in groups of macroblocks, such as groups of 16×16 pixels (e.g., having 256 pixels in total) or some other macroblock size. In some examples, the forward transform circuitry 115 transforms a macroblock of source pixels using a discrete cosine transform (DCT). For example, the forward transform circuitry 115 may divide a 16×16 macroblock into four (4) groups of 8×8 pixels (e.g., having 64 pixels each). The forward transform circuitry 115 may then employ an 8×8 DCT to transform, per color channel (e.g., R, G and B, or Y, U and V), each 8×8 group of pixels to generate 16×16 transform coefficients (e.g., having 256 transform coefficients in total) per color channel, which are representative of the 16×16 macroblock of source pixels.

The forward transform circuitry 115 separates the transform coefficients for a macroblock into a set of non-quantizable transform coefficients 145 and a set of quantizable transform coefficients 150. In the illustrated example, the non-quantizable transform coefficients 145 correspond to the zero frequency transform coefficients generated by the DCT transform, which are also referred to herein as direct current (DC) coefficients 145. In the illustrated example, the quantizable transform coefficients 150 correspond to the non-zero frequency transform coefficients generated by the DCT transform, which are also referred to herein as alternating current (AC) coefficients 150. The forward transform circuitry 115 provides the non-quantizable transform coefficients 145 to the non-quantizable data encoder circuitry 135, and provides the quantizable transform coefficients 150 to the QSF solver circuitry 120.

The non-quantizable data encoder circuitry 135 encodes the non-quantizable transform coefficients 145 (e.g., the DC coefficient) in a lossless format based on the VC-3 standard. For example, the quantizable data encoder circuitry 135 encodes the non-quantizable transform coefficients 145 (e.g., the DC coefficient), as well as other data, such as header data, associated with an input macroblock based on one or more lookup tables defined in the VC-3 standard. The non-quantizable data encoder circuitry 135 determines the number of bits used to encode the non-quantizable transform coefficients 145 (e.g., the DC coefficient) and other non-quantizable data associated with the input macroblock to the QSF solver circuitry 120. As used herein, the number of bits used to encode the non-quantizable transform coefficients 145 (e.g., the DC coefficients) and other non-quantizable data associated with the input macroblock is referred to as the number of QSF independent bits 155 for a given macroblock.

The QSF solver circuitry 120 of the illustrated example operates to determine a quantization scale factor (QSF) to be used to quantize the quantizable transform coefficients 150 (e.g., the AC coefficients) of the input macroblock to meet a target number of bits 160 for encoding the macroblock. The target number of bits 160 (represented by “tgt_bits” in FIG. 1) for the input macroblock is based on the bit rate specified for the output bitstream 110. In some examples, the bit rate for the output bitstream 110 is based on a compression profile identifier (CID) specified for the output bitstream 110. In some such examples, the encoder driver 102 obtains the CID for the output bitstream 110 as input information, computes the target bit rate associated with the output bitstream 110 based on the CID, computes the target number of bits for encoding the input frame 105 (also referred to herein as the target number of frame bits) based on the target bit rate, and computes the target number of bits 160 (also referred to as target number of macroblock bits) for the input macroblock based on the target number of bits for encoding the input frame 105. Additionally or alternatively, in some examples, the encoder driver 102 computes the target number of bits 160 for the current macroblock being encoded based on information (e.g., metadata, statistics, etc.) output from the video encoder circuitry 100 during a prior process iteration performed on the input frame 105. Further details concerning determination of the target number of macroblock bits 160 are provided below.

In the illustrated example, the QSF solver circuitry 120 determines a target QSF to encode the current macroblock of the input frame 105 based on the target number of macroblock bits 160. For example, the QSF solver circuitry 120 may determine the target QSF to meet a macroblock bit budget corresponding to the target number of macroblock bits 160 subtracted by the number of QSF independent bits 155. As such, the macroblock bit budget represents the amount of remaining bits to encode the macroblock after inclusion of the number of QSF independent bits 155 used to encode the non-quantizable transform coefficients 145 and other macroblock header data, etc.

In the illustrated example, the set of possible QSFs to be used to quantize the quantizable transform coefficients 150 of the macroblock span a relatively large range, such as a range of 2047 different possible QSFs. Rather than testing each possible QSF in this set of possible QSFs, the QSF solver circuitry 120 can be configured by the encoder driver 102 with a smaller set of anchor QSFs to be tested for encoding the quantizable transform coefficients 150 of the input macroblock. For example, the QSF solver circuitry 120 may be configured (e.g., programmed) with a set of ten (10) anchor QSFs, and the QSF solver circuitry 120 in turn quantizes the quantizable transform coefficients 150 of the macroblock based on those anchor QSFs to determine respective numbers of bits (referred to herein as respective numbers of macroblock bits) used to encode the quantizable transform coefficients 150 of the current macroblock based on the different corresponding anchor QSFs. For example, the QSF solver circuitry 120 may determine a first number of bits to encode the quantizable transform coefficients 150 based on a first anchor QSF, a second number of bits to encode the quantizable transform coefficients 150 based on a second anchor QSF, etc.

In some examples, the QSF solver circuitry 120 performs interpolation (referred to herein as macroblock-based interpolation) between the respective numbers of bits used to encode the quantizable transform coefficients 150 based on the different corresponding anchor QSFs to determine an estimated QSF (referred to herein as an estimated macroblock QSF) to satisfy the macroblock bit budget for encoding the quantizable transform coefficients 150 of the current macroblock. In some examples, this macroblock-based interpolation implemented by the QSF solver circuitry 120 is a piecewise linear interpolation. In some example, the QSF solver circuitry 120 applies a nonlinear function to the anchor QSFs to compute nonlinear values corresponding to the anchor QSFs, which the QSF solver circuitry 120 uses to perform the piecewise linear interpolation. Additionally or alternatively, in some examples, the QSF solver circuitry 120 applies a same or different nonlinear function to the respective numbers of bits associated with the corresponding anchor QSFs to compute nonlinear values corresponding to the respective numbers of bits associated with the corresponding anchor QSFs, which the QSF solver circuitry 120 uses to perform the piecewise linear interpolation. The nonlinear functions can be, but are not limited to, logarithmic functions, inverse functions, linear regression functions, machine learning (ML) functions, etc. Further details concerning the macroblock-based interpolation implemented by the QSF solver circuitry 120 are provided below. As disclosed in further detail below, in some examples, the estimated macroblock QSF is output by the QSF solver circuitry 120 is output as a target QSF 165 to be used by the forward quantization circuitry to encode the quantizable transform coefficients 150 of the current macroblock. As such, in some examples, the QSF solver circuitry 120 can determine an output a different macroblock QSF to be used to quantize some or all of the macroblocks of the input frame 105 in a current process iteration.

In some examples, the QSF solver circuitry 120 continues to quantize the quantizable transform coefficients 150 of successive macroblocks of the input frame 105 based on the different anchor QSFs to determine respective numbers of macroblock bits used to encode the quantizable transform coefficients 150 of those subsequent macroblocks based on the different corresponding anchor QSFs. In some such examples, the QSF solver circuitry 120 accumulates, for each anchor QSF, the numbers of macroblock bits used to encode the quantizable transform coefficients 150 of all macroblocks of the input frame 105 to determine a total number of bits (referred to herein as a total number of frame bits) used to encode the input frame 105 based on that particular QSF. Thus, in some examples, the QSF solver circuitry 120 determines respective numbers of frame bits used to encode the input frame 105 based on the corresponding different anchor QSFs.

In some such examples, the QSF solver circuitry 120 determines a target QSF to encode the current macroblock of the input frame 105 to meet a frame bit budget that corresponds to the target number of frame bits available based on the bit rate specified for the output bitstream 110 subtracted by the number of QSF independent bits 155 across all macroblocks of the input frame 105. For example, the QSF solver circuitry 120 may perform frame-based interpolation, similar to the macroblock-based interpolation described above, to determine an estimated QSF (referred to herein as an estimated frame QSF) to satisfy the frame bit budget for encoding the quantizable transform coefficients 150 of all macroblocks of the current input frame 105. Thus, in some examples, which are described in further detail below, the estimated frame QSF is output by the QSF solver circuitry 120 as the target QSF 165 to be used by the forward quantization circuitry to encode the quantizable transform coefficients 150 of the current macroblock. As such, in some examples, the QSF solver circuitry 120 can determine and output the estimated frame QSF as a same macroblock QSF to be used to quantize all of the macroblocks of the input frame 105 in a subsequent process iteration (e.g., because the estimated frame QSF is determined in the current process iteration).

However, in some examples, the QSF solver circuitry 120 evaluates the respective numbers of frame bits used to encode the input frame 105 based on the corresponding different anchor QSFs to output two (or more) of the anchor QSFs as candidate QSFs to be selected from by the encoder driver 102 for quantizing the macroblocks of the input frame 105. For example, the QSF solver circuitry 120 may output a first one of the anchor QSFs that resulted in a corresponding total number of frame bits that satisfied (e.g., was less than or equal to) the target frame bit budget, and may output a second one of the anchor QSFs that resulted in a corresponding total number of frame bits that did not satisfy (e.g., that exceeded or was greater than) the target frame bit budget. In some such examples, the anchor QSFs may be powers of 2, and the first one of the anchor QSFs and the second one of the anchor QSFs may be adjacent anchor QSFs, with the first one of the anchor QSFs being larger than the second one of the anchor QSFs. In some such examples, the encoder driver 102 determines the particular macroblock QSF to be used to quantize the quantizable transform coefficients 150 of a given macroblock of the input frame 105 by selecting either the first one of the anchor QSFs or the second one of the anchor QSFs, but keeping in mind that the total number of bits used to quantize the quantizable transform coefficients 150 over all the macroblocks of the input frame 105 is to satisfy the target frame bit budget for the frame.

For example, the encoder driver 102 may initialize the respective macroblock QSFs for the corresponding macroblocks of the input frame 105 to be equal to the first one of the anchor QSFs (e.g., the larger one of the anchor QSFs) that satisfied the target frame bit budget. In such examples, the encoder driver 102 may then promote select ones of the macroblock QSFs to be equal to the second one of the anchor QSFs (e.g., the smaller one of the anchor QSFs) that did not satisfy the target frame bit budget, provided that quantization of all the macroblocks based on the selected combination of the first one of the anchor QSFs and the second one of the anchor QSFs will satisfy (e.g., is equal to or less than) the frame bit budget. The resulting selection of macroblock QSFs are then used to quantize all of the macroblocks of the input frame 105 in a subsequent process iteration (e.g., because the selected first and second ones of the anchor QSFs were determined in the current process iteration).

As another example, the encoder driver 102 may initialize the respective macroblock QSFs for the corresponding macroblocks of the input frame 105 to be equal to the second one of the anchor QSFs (e.g., the smaller one of the anchor QSFs) that did not satisfy the target frame bit budget. In such examples, the encoder driver 102 may then demote select ones of the macroblock QSFs to be equal to the first one of the anchor QSFs (e.g., the larger one of the anchor QSFs) that satisfied the target frame bit budget to ensure that quantization of all the macroblocks based on the selected combination of the first one of the anchor QSFs and the second one of the anchor QSFs will satisfy (e.g., is equal to or less than) the frame bit budget. The resulting selection of macroblock QSFs are then used to quantize all of the macroblocks of the input frame 105 in a subsequent process iteration (e.g., because the selected first and second ones of the anchor QSFs were determined in the current process iteration). Further details concerning the QSF solver circuitry 120 are provided below.

The forward quantization circuitry 125 of the illustrated example quantizes the set of quantizable transform coefficients 150 for the current macroblock of the input frame 105 based on the target QSF 165 determined for that macroblock to determine quantized transform coefficients 170 for the current macroblock. As described above, the target QSF 165 can be provided by the QSF solver circuitry 120 as an estimated QSF determined during the current process iteration, or by the encoder driver 102 based on statistics (e.g., estimated frame QSFs, two or more anchor QSFs, etc.) provided by the QSF solver circuitry 120 during a prior process iteration. In the illustrated example, the forward quantization circuitry 125 provides quantized transform coefficients 170 to the bit coding circuitry 130.

The bit coding circuitry 130 of the illustrated example obtains the quantized transform coefficients 170 for the current macroblock of the input frame 105 from the forward quantization circuitry 125. The bit coding circuitry 130 of the illustrated example also obtains the encoded, non-quantizable data 175 (e.g., such as the encoded zero-frequence (DC) coefficients, encoded header data, etc.) associated with the current macroblock from the non-quantizable data encoder circuitry 135. In the illustrated example, the bit coding circuitry 130 then encodes the quantized transform coefficients 170 and the encoded, non-quantizable data 175 for the current macroblock using variable length coding (VLC). The bit coding circuitry 130 of the illustrated example further packs the resulting VLC-encoded bits to equal the target number of macroblock bits 180 (represented by “max bits” in FIG. 1) for encoding the current macroblock of the input frame 105 in the output bitstream 110. As described in further detail below, the target number of macroblock bits 180 may be the same for all macroblocks of the current frame 105, or different macroblocks may have different target numbers of macroblock bits 180.

For example, the bit coding circuitry 130 implements a round-robin bit packing procedure that packs the encoded, non-quantizable data 175 for the current macroblock of the input frame 105 into the output bitstream 110. The round-robin bit packing procedure of the bit coding circuitry 130 also packs the encoded, quantized transform coefficients 170 of the current macroblock into the output bitstream 110 in a round-robin manner until the target number of macroblock bits 180 for the current macroblock is reached. If the target number of macroblock bits 180 for the current macroblock is not reached, the bit coding circuitry 130 may zero pad the output bitstream 110 until the target number of macroblock bits 180 for the current macroblock is reached. However, in some examples, the bit coding circuitry 130 may track the number of unused bits in the current macroblock and treat the unused bits as available for packing subsequent macroblocks of the input frame 105 in the event one or more of those subsequent macroblocks exceed their respective target numbers of macroblock bits 180.

However, if during round-robin packing the target number of macroblock bits 180 is reached before all encoded, quantized transform coefficients 170 for the current macroblock have been packed, the bit coding circuitry 130 may discard the remaining, unpacked quantized transform coefficients 170 to ensure the target number of macroblock bits 180 is met exactly for the current macroblock. However, in some examples in which the bit coding circuitry 130 tracks unused bits from the packing of prior macroblocks, the bit coding circuitry 130 may continue to pack the encoded, quantized transform coefficients 170 for the current macroblock even after the target number of macroblock bits 180 for the current macroblock has been exceeded so long as there are remaining unused bits. If the remaining unused bits are exhausted, the bit coding circuitry 130 may then resort to discarding the remaining, unpacked quantized transform coefficients 170 to ensure the target number of macroblock bits 180 is met exactly for the current macroblock. Further details concerning the bit coding circuitry 130 are provide below.

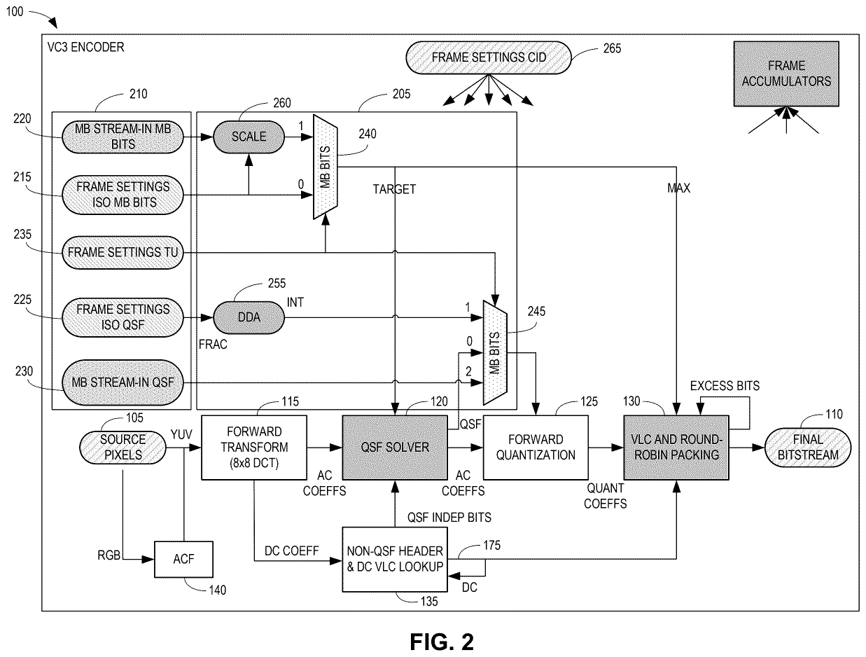

FIG. 2 is a block diagram of an example implementation of the video encoder circuitry 100 of FIG. 1. The video encoder circuitry 100 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the video encoder circuitry 100 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example video encoder 100 of FIG. 2 includes the forward transform circuitry 115, the QSF solver circuitry 120, the forward quantization circuitry 125, the bit coding circuitry 130, the non-quantizable data encoder circuitry 135, and the color space conversion circuitry 140 described above in connection with FIG. 1. The example video encoder 100 of FIG. 2 also includes example control circuitry 205 and associated example control inputs 210 to control operation of the video encoder circuitry 100.

In the illustrated example, the control circuitry 205 and the control inputs 210 enable configuration of the video encoder circuitry 100 to achieve different performance vs. quality tradeoffs. For example, the video encoder circuitry 100 of FIG. 2 includes the control inputs 210 to specify bit budgets and QSFs to be used by the video encoder circuitry 100 to encode the input frame 105 (which may be an input video frame of a video, an input image frame, etc.). The control inputs 210 of the illustrated example include inputs that are frame based (e.g., which apply to all macroblocks of the input frame 105) and inputs that are macroblock (MB) based (e.g., which apply to individual macroblocks of the input frame 105). For example, the control inputs 210 include an example ISO MB bits frame setting 215 that specifies a target number of macroblock bits for encoding each macroblock of the input frame 105, and which is a constant (or equal, same, etc.) value over all the macroblocks of the input frame 105. The control inputs 210 also include an example MB bits stream setting 220 that specifies a stream of respective target numbers of macroblock bits for encoding the corresponding different macroblocks of the input frame 105 and, thus, the target number of macroblock bits may vary over the macroblocks of the input frame 105. The control inputs 210 further include an example ISO QSF frame setting 225 that specifies a single QSF to be used to quantize each macroblock of the input frame 105, and which is a constant (or equal, same, etc.) value over all the macroblocks of the input frame 105. The control inputs 210 also include an example MB QSF stream setting 230 that specifies a stream of respective target QSFs to be used to quantize the corresponding different macroblocks of the input frame 105 and, thus, the target QSFs may vary over the macroblocks of the input frame 105. The control inputs 210 further include an example target usage (TU) mode frame setting that applies to all macroblocks of the input frame 105. TU modes are described in further detail below.

The control circuitry 205 of the illustrated example includes an example MB bits multiplexer 240 and an example QSF multiplexer 245. The multiplexers 240 and 245 are controlled by the TU mode frame setting 235 to select what target number(s) of macroblock bits and QSF(s) are routed into the circuit elements of the video encoder circuitry 100. For example, the MB bits multiplexer 240 determines which input target number of macroblock bits is provided to the QSF solver circuitry 120 and the bit coding circuitry 130. (In the illustrated example of FIG. 2, “Target” and “Max” refer to “tgt bits” and “max bits” illustrated in FIG. 1.) The QSF multiplexer 245 determines which input target QSF is provided to the forward quantization circuitry 125 for quantizing the current macroblock of the input frame 105. The control circuitry 205 of the illustrated example also includes an example direct differential analyzer (dda) 255 that converts a fractional QSF value to an integer QSF value (e.g., which is used in TU3 mode). The control circuitry 205 of the illustrated example further includes an example scale circuit 260 that scales the target numbers of macroblock bits that are provided by the MB bits stream setting 220 and correspond respectively to the different macroblocks of the input frame 105 (and which may correspond to a particular anchor QSF, as described below) by a scale factor provided by the ISO MB bits frame setting 215 (and which may correspond to a ratio based on the single QSF provided by the ISO QSF frame setting 225 and the particular anchor QSF corresponding to the MB bits stream setting 220) to compute respective target numbers of macroblock bits for encoding the corresponding different macroblocks of the input frame 105 when quantized using the single QSF provided by the ISO QSF frame setting 225 (e.g., in TU3 mode).

FIG. 2 also shows that the video encoder circuitry 100 of the illustrated example includes example compression profile identifier (CID) frame settings 265 that provide the CID specified for the input frame 105 to circuit elements of the video encoder circuitry 100. The CID input 265 is a frame setting that applies to all macroblocks of the input frame 105. In the illustrated example, the CID specifies an encoding profile or class, which corresponds to a target bit rate for the output bitstream 110 and, thus, corresponds to a target number of frame bits to be used to encode the input frame 105.

As described in further detail below, to achieve different performance and quality tradeoffs, the video encoder circuitry 100 of FIG. 2 can be used in a one-pass (or single process iteration) or two-pass (or two process iteration) encoding process. For example, the video encoder circuitry 100 implements multiple TU modes that corresponds to different performance and quality tradeoffs. Example TU modes supported by the video encoder circuitry 100 of the illustrated example include:
1) TU mode 4, also referred to as TU4, which is a single-pass encoding mode that is designed to yield high encoding performance at the expense of lower quality. In some examples, TU4 achieves acceptable subjective quality but may not meet one or more objective quality metrics.
2) TU mode 3, also referred to as TU3, is a two-pass (two iteration) hardware-only encoding mode that is designed to yield better quality than TU4 but at the expense of lower encoder performance than TU4. In some examples, TU3 achieves acceptable subjective quality and may also meet one or more objective quality metrics.
3) TU mode 2, also referred to as TU2, is a two-pass (two iteration) hardware encoding mode with processing by the encoder driver 102 (or some other software application, hardware circuitry, etc.) between the two hardware passes (iterations). TU2 is designed to yield better quality than TU3 but at the expense of lower encoder performance than TU2.
4) TU mode 1, also referred to as TU1, is a multi-pass (multi iteration) hardware encoding mode with artificial intelligence (AI) processing between passes (iterations). The number of hardware passes (iterations) may be two or more.

In the example video encoder circuitry 100 of FIG. 2, TU4 is based on a constant-bits per macroblock strategy, with a uniform bit distribution across the macroblocks of the input frame 105. As a result, the QSF varies per macroblock based on a piecewise linear (PWL) interpolation performed by the QSF solver circuitry 120, as described above. The example TU4 encoding mode implemented by the video encoder circuitry 100 of FIG. 2 utilizes one hardware pass (iteration) per input frame 105.

In the example video encoder circuitry 100 of FIG. 2, TU3 is based on a constant-QSF per macroblock strategy, with a uniform distribution of QSF across the macroblocks of the input frame 105. As a result, the bits vary per macroblock based on PWL QSF interpolation of accumulated frame statistics performed by the QSF solver circuitry 120, as described above. The example TU3 encoding mode implemented by the video encoder circuitry 100 of FIG. 2 utilizes two hardware passes (iterations) per input frame 105.

In the example video encoder circuitry 100 of FIG. 2, TU2 is based on a rate distortion optimization (RDO) strategy to select from a set of two or more anchor QSFs per macroblock (e.g., between a lower or higher anchor QSF in the case of two possible In the example video encoder circuitry 100 of FIG. 2, QSFs, but in other examples, selection can be from more than two anchor QSFs per macroblock) based on bits spent to encode a given macroblock vs. the preserved quality of the given macroblock. As a result, both the number of encoded bits and the QSF vary per macroblock. The example TU2 encoding mode implemented by the video encoder circuitry 100 of FIG. 2 utilizes two hardware passes (iterations) per input frame 105 with processing by the encoder driver 102 (e.g., to perform a software sort of the RDO associated with the different macroblocks of the input frame 105) between the two hardware passes (iterations).

In the example video encoder circuitry 100 of FIG. 2, TU1 can be implemented by re-using the TU2 control input configurations but with additional advanced pre-processing, AI processing and/or machine learning (ML) processing, in combination with statistics generated by the video encoder circuitry 100 in the first pass, used to drive QSF selection. An example TU1 encoding mode implemented by the video encoder circuitry 100 of FIG. 2 utilizes at least two hardware passes (iterations) per input frame 105 with optional pre-processing before the first hardware pass (iteration) and AI-driven QSF decision processing before second hardware pass (iteration).

Note that the TU names and numbers described herein are examples and other encoding mode names and numbers can be used.

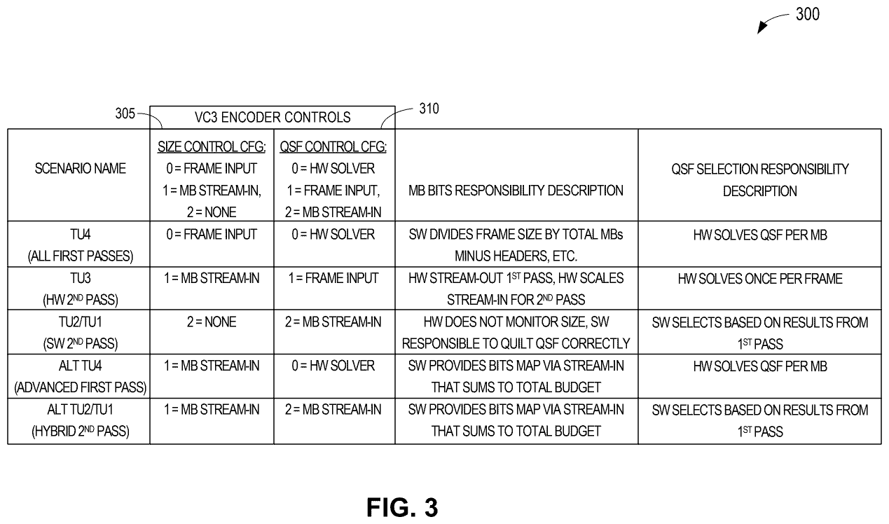

FIG. 3 illustrates example control settings 300 that can be used to configure the example video encoder circuitry 100 of FIG. 2 to support different example TU encoding modes. In the illustrated example, the different TU mode settings are configured by two example behavioral specification (bspec) fields: size_control_config 305 and qsf_control_config 310. The size_control_config field 305 controls the select input of the MB bits multiplexer 240 and the qsf_control_config field 310 controls the select input of the QSF multiplexer 245. In the illustrated example of FIG. 3, the size_control_config field 305 and the qsf_control_config field 310 each have three (3) possible values that can be set independently, for a total of nine (9) possible combinations. The first (3) of the nine (9) possible combinations of the control settings 300 illustrated in FIG. 3 correspond respectively to the specified TU4, TU3 and TU2 encoding modes described above and in further detail below. The next two (2) of the nine (9) combinations of the control settings 300 illustrated in FIG. 3 are potentially useful alternative TU modes that provide enhanced flexibility. The remaining four (4) of the nine (9) possible combinations of the control settings 300 are not discussed herein.

The table of FIG. 3 explains how the size_control_config field 305 and the qsf_control_config field 310 control the multiplexer select inputs of the MB bits multiplexer 240 and the QSF multiplexer 245 of the video encoder circuitry 100 of FIG. 2 in different TU modes. For example, when the TU mode frame setting 235 is set to TU4, the size_control_config field 305 is set to a value of 0, which causes the MB bits multiplexer 240 to connect the ISO MB bits frame setting 215 to the target number of macroblock bits input of the QSF solver circuitry 120 and the target number of macroblock bits input of the bit coding circuitry 130, and the qsf_control_config field 310 is set to a value of 0, which causes the target QSF output from the QSF solver circuitry 120 to be connected to the target QSF input of the forward quantization circuitry 125. When the TU mode frame setting 235 is set to TU3, the size_control_config field 305 is set to a value of 1, which causes the MB bits multiplexer 240 to connect the MB bits stream setting 220 to the target number of macroblock bits input of the bit coding circuitry 130, and the qsf_control_config field 310 is set to a value of 1, which causes the ISO QSF frame setting 225 to be connected to the target QSF input of the forward quantization circuitry 125. When the TU mode frame setting 235 is set to TU2, the size_control_config field 305 is set to a value of 2, which is ignored, and the qsf_control_config field 310 is set to a value of 2, which causes the MB QSF stream setting 230 to be connected to the target QSF input of the forward quantization circuitry 125.

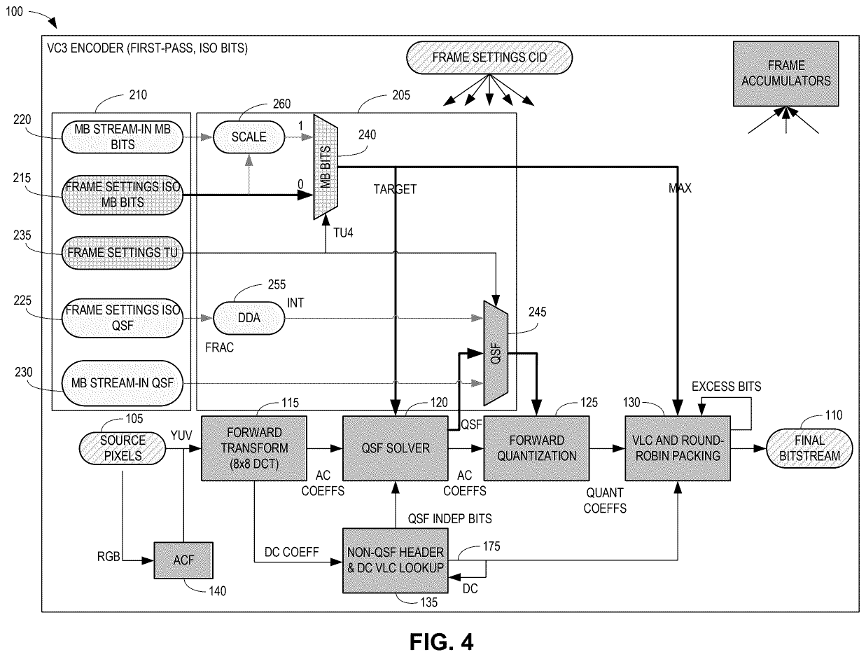

FIG. 4 illustrates an example configuration of the video encoder circuitry 100 of FIG. 2 based on the control settings 300 of FIG. 3 to support an example TU4 encoding mode. TU4 corresponds to a single-pass (single-iteration) encoding mode having a constant number of encoded bits for each macroblock of the input frame 1905. During the single pass (iteration), the encoder driver 102 sets the TU mode frame setting 235 to TU4, which causes the size_control_config field 305 to be set to “0=Frame Input” and the qsf_control_config field 310 to be set to “0=HW Solver,” as described above in connection with FIG. 3. As illustrated by the bolded lines in FIG. 4, the target number of macroblock bits, “Target” and “Max,” used by the QSF solver circuitry 120 and the bit coding circuitry 130, respectively, are controlled externally by the encoder driver 102 by setting the ISO MB bits frame setting 215 to a constant value for all macroblocks of the input frame 105. As a result, the QSF solver circuitry 120 is invoked to derive estimated QSFs for each macroblock of the input frame 105 such that a constant number of encoded bits is achieved over all macroblocks of the input frame 105.

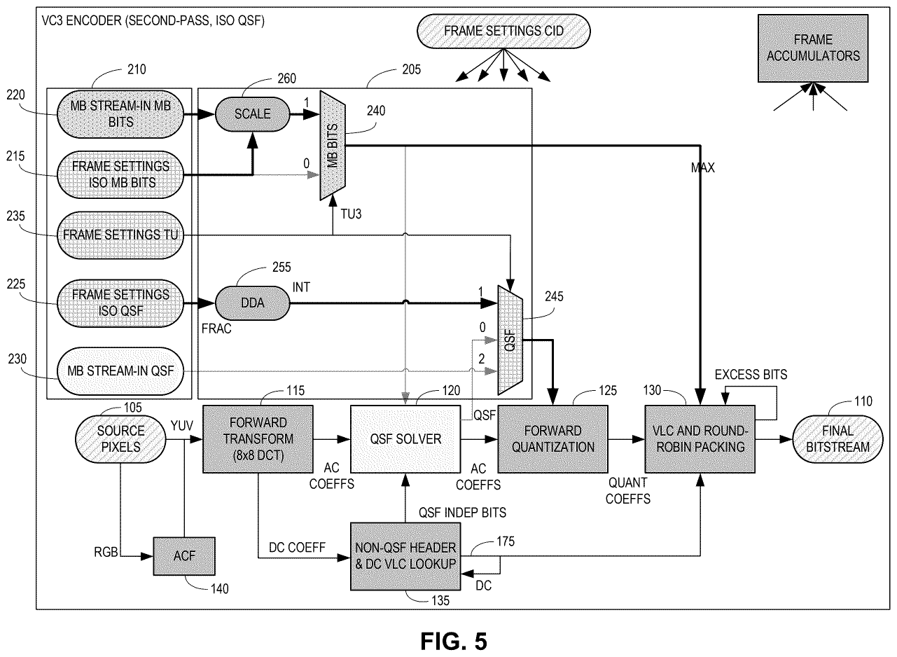

FIG. 5 illustrates an example configuration of the video encoder circuitry 100 of FIG. 2 based on the control settings 300 of FIG. 3 to support an example TU3 encoding mode. TU3 corresponds to a two-pass (two iteration) encoding mode having constant QSF for each macroblock of the input frame 105. During the first pass (first iteration), the video encoder circuitry 100 is configured by the encoder driver 102 according to the example of FIG. 4. During the second pass (second iteration), the encoder driver 102 sets the TU mode frame setting 235 to TU3, which causes the size_control_config field 305 to be set to “1=MB Stream-in” and the qsf_control_config field 310 is set to “1=Frame Input” as shown in FIG. 5. As illustrated in the example of FIG. 5, the target number of macroblock bits vary per macroblock based on the scaled stream-in sizes found during the first pass (e.g., based on the lowest QSF found that would meet the target frame bit budget). As illustrated by the bolded line in FIG. 5, the encoder driver 102 sets the ISO QSF frame setting 225 to be the single interpolated (and potentially fractional) frame-level QSF determined by the QSF solver circuitry 120 in the prior first pass (first iteration) to satisfy the frame bit budget. This same QSF is then used by the forward quantization circuitry to quantize each macroblock of the input frame 105.

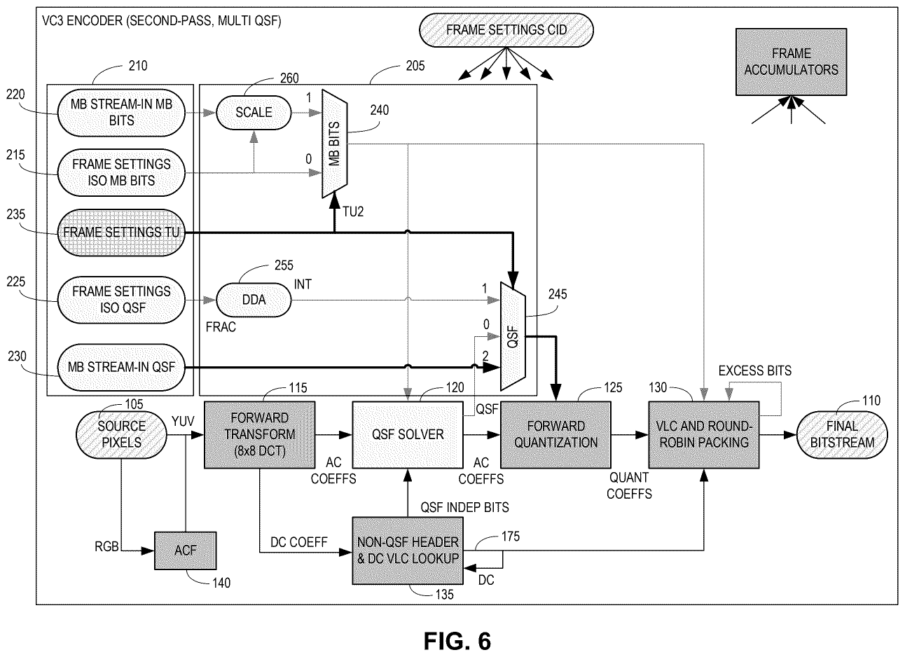

FIG. 6 illustrates an example configuration of the video encoder circuitry 100 of FIG. 2 based on the control settings 300 of FIG. 3 to support an example TU2 encoding mode. TU2 corresponds to a two-pass (two iteration) encoding mode based on at least two anchor QSFs and RDO sorted macroblocks. During the first pass (iteration), the video encoder circuitry 100 is configured according to the example of FIG. 4. During the RDO optimized second pass (iteration), the encoder driver 102 sets the TU mode frame setting 235 to TU2, which causes size_control_config field 305 to be set to “2=None” and the qsf_control_config to be set to “2=MB Stream-in” as shown in FIG. 6. Based on the first pass results, the encoder driver 102 will identify the nearest at least two (2) anchor QSFs, for example, that resulted in the smallest passing anchor QSF (that satisfied the target frame bit budget) and the largest failing anchor QSF (that did not satisfy the target frame bit budget). The encoder driver 102 performs an RDO sort to determine how each macroblock of the input frame 105 returns quality per bit by selecting the lower QSF, and uses the resulting sorted list to decide which macroblocks are promoted to the lower QSF so long as the total promoted macroblocks plus the total not promoted macroblocks exactly equals the desired frame size. In the illustrated example, the encoder driver 102 is ensuring that the desired frame size is met with the respective QSFs selected for the corresponding macroblocks of the input frame 105.

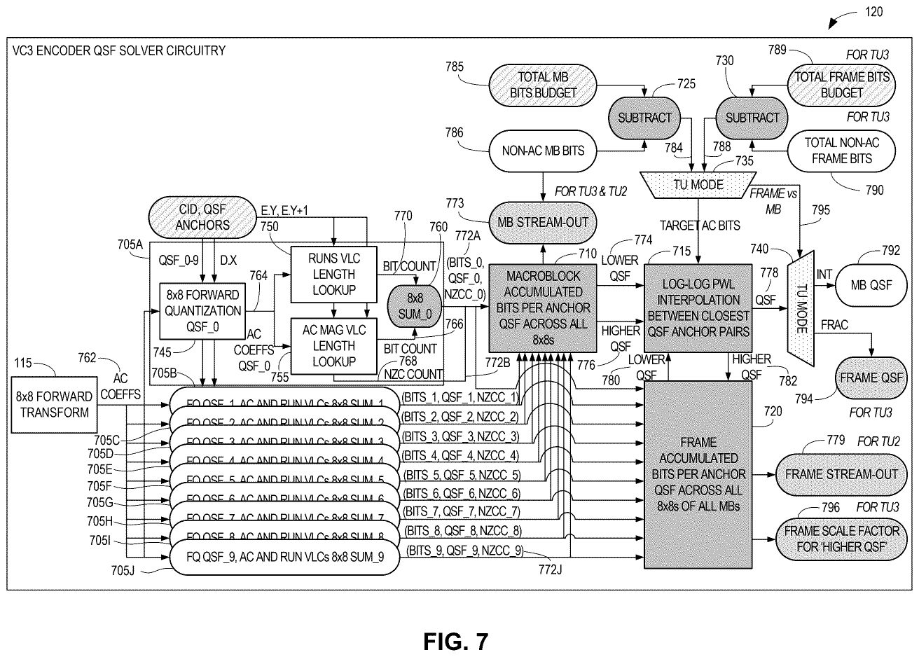

FIG. 7 is a block diagram of an example implementation of the QSF solver circuitry 120 included in the example video encoder circuitry 100 of FIGS. 1 and/or 2. The QSF solver circuitry 120 of FIG. 7 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the QSF solver circuitry 120 of FIG. 7 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 7 may, thus, be instantiated at the same or different times. Some or all of the circuitry of FIG. 7 may be instantiated, for example, in one or more threads executing concurrently on hardware and/or in series on hardware. Moreover, in some examples, some or all of the circuitry of FIG. 7 may be implemented by microprocessor circuitry executing instructions and/or FPGA circuitry performing operations to implement one or more virtual machines and/or containers.

The example QSF solver circuitry 120 of FIG. 7 includes example anchor QSF evaluation circuitry 705A-J, example macroblock bit accumulation circuitry 710, example anchor pair interpolation circuitry 715, example frame bit accumulation circuitry 720, example subtraction circuits 725 and 730, an example multiplexer 735 and an example demultiplexer 740. As described above, the QSF solver circuitry 120 operates on a block of AC transform coefficients output from the forward transform circuitry 115 for a given macroblock of the current input image frame 105 being encoded. For example, the QSF solver circuitry 120 operates on sixty-three (63) example AC transform coefficients 762 from a given 8×8 block of transform coefficients for the given macroblock. (As described above, the DC transform coefficient for the given 8×8 block is processed separately by the non-quantizable data encoder circuitry 135.)

As shown in the illustrated example of FIG. 7, the AC transform coefficients 762 are provided as input to each of the anchor QSF evaluation circuitry 705A-J of the QSF solver circuitry 120, which evaluate the quantization of the AC transform coefficients 762 using different possible anchor QSFs programmed by the encoder driver 102. The QSF solver circuitry 120 of the illustrated example includes ten (1) QSF evaluation circuits 705A-J corresponding to ten (10) different possible anchor QSFs to be evaluated. However, in some examples, more or fewer QSF evaluation circuits 705A-J are included in the QSF solver circuitry 120 to support evaluation of more or fewer possible anchor QSFs programmed by the encoder driver 102.

In the illustrated example QSF solver circuitry 120 of FIG. 7, each of the QSF evaluation circuits 705A-J includes respective example forward quantization circuitry 745, example run length lookup circuitry 750, example magnitude length lookup circuitry 755 and example summation circuitry 760. As shown in the illustrated example, each of the QSF evaluation circuits 705A-J is configured with a different one on of the anchor QSFs provided by the encoder driver 102. For example, the QSF evaluation circuit 705A is configured with a first anchor QSF (QSF_0), the QSF evaluation circuit 705B is configured with a second anchor QSF (QSF_1), and so on, with QSF evaluation circuit 705J being configured with a tenth anchor QSF (QSF_9). The QSF evaluation circuits 705A-J are also configured with the CID for the input frame 105 and tables associated with that CID. For example, the QSF evaluation circuits 705A-J are configured with a quantization matrix associated with the CID (which is represented by D.X in FIG. 7), a run length VLC table associated with the CID (which is represented by E.Y in FIG. 7), and an AC magnitude VLC table associated with the CID (which is represented by E.Y+1 in FIG. 7).

The QSF evaluation circuit 705A of the illustrated example invokes the forward quantization circuitry 745 to quantize the AC transform coefficients 762 of the current 8×8 block based on the anchor QSF, QSF_0, to produce example quantized AC transform coefficients 764. The magnitude length lookup circuitry 755 of the illustrated example uses the AC magnitude VLC table (E.Y+1) to determine an example bit count 766 of the number of bits to encode the magnitudes of the non-zero quantized AC transform coefficients 764 output from the forward quantization circuitry 745 for the current 8×8 block. The magnitude length lookup circuitry 755 also output an example NZC count 768 that specifies the number of non-zero quantized AC transform coefficients 764 output from the forward quantization circuitry 745 for the current 8×8 block. The run length lookup circuitry 750 of the illustrated uses the run length VLC table (E. Y) to determine an example bit count 770 of the number of bits to encode the run lengths of zero-valued, quantized AC transform coefficients 764 between the non-zero transformed coefficients for the current 8×8 block. The summation circuitry 760 sums the bit count 766 of the number of bits to encode the magnitudes of the non-zero quantized AC transform coefficients 764 and the bit count 770 of the number of bits to encode the run lengths of the zero-valued, quantized AC transform coefficients 764 to determine a total bit count for the anchor QSF, QSF_0, associated with the QSF evaluation circuit 705A. The QSF evaluation circuit 705A then outputs an example tuple 772A given by (bits_0, qsf_0, nzcc_0), which includes the total bit count for the anchor QSF (QSF_0), the values of the anchor QSF (QSF_0) and the number of non-zero transformed AC coefficients (nzcc_0) obtained for the anchor QSF (QSF_0) associated with the QSF evaluation circuit 705A.

The QSF evaluation circuits 705B-J of the illustrated example operate similarly to output similar corresponding example tuples 772B to 772J given by (bits_j, qsf_j, nzcc_j), for j=1 . . . . J. The particular tuple (bits_j, qsf_j, nzcc_j) includes the total bit count for the anchor QSF (QSF_j), the values of the anchor QSF (QSF_j) and the number of non-zero transformed AC coefficients (nzcc_j) obtained for the anchor QSF (QSF_j) associated with the QSF evaluation circuit 705j, for j=1 . . . . J.

As shown in the illustrated example QSF solver 120 of FIG. 7, the QSF evaluation circuits 705A-G provide their respective tuples (bits_j, qsf_j, nzcc_j), for j=0 . . . . J, to the macroblock bit accumulation circuitry 710. The macroblock bit accumulation circuitry 710 accumulates, for each anchor QSF, the total number of bits (bits_j) to encode the quantized AC transform coefficients for the different 8×8 blocks (e.g., per color channel) of the current macroblock (e.g., with the total number of 8×8 blocks based on how chroma subsampling is configured) to determine respective numbers of macroblock bits for the different anchor QSFs. Thus, the number of macroblock bits for a given anchor QSF represents the total number of bits to encode the quantized transformed AC coefficients for the current macroblock when quantization is performed with the given anchor QSF. In the illustrated example, the macroblock bit accumulation circuitry 710 also accumulates, for each anchor QSF, the non-zero transformed AC coefficients (nzcc_j) obtained for the different 8×8 blocks (e.g., per color channel) of the current macroblock to determine respective numbers of non-zero transformed AC coefficients for the different anchor QSFs. Thus, the number of non-zero transformed AC coefficients for a given anchor QSF represents the total number of non-zero transformed AC coefficients obtained for the current macroblock when quantization is performed with the given anchor QSF.

The macroblock bit accumulation circuitry 710 of the illustrated example stores and/or outputs the numbers of macroblock bits and the numbers of non-zero transformed AC coefficients for the different anchor QSFs as an example stream of macroblock metadata 773 on a macroblock-by-macroblock basis. In some examples, the encoder driver 102 uses the stream of macroblock metadata 773 to determine the macroblock QSFs and/or numbers of macroblock bits to associated with quantizing macroblocks of the current input frame 105, such as when operating in TU3, TU2 or TU1 mode. For example, in TU3 mode, the encoder driver 102 can use the numbers of macroblock bits for the different anchor QSFs to configure the respective AC macroblock bit budget for each macroblock (because the number of macroblock bits may vary over the macroblocks due to the same QSF being used to encode all macroblocks of the frame). As another example, in TU2 mode, the encoder driver 102 can use the numbers of non-zero transformed AC coefficients for the different anchor QSFs as a measure of quality in its RDO evaluations when selecting ones of the different anchor QSFs to be the macroblock QSFs to be used to quantize the macroblocks of the current input frame 105 (e.g., to determine which macroblocks would be beneficial to promote to a smaller QSF). As another example, in TU1 mode, the encoder driver 102 can use the numbers of non-zero transformed AC coefficients for the different anchor QSFs as inputs to an AI model that selects ones of the different anchor QSFs (and/or other QSFs) to be the macroblock QSFs to be used to quantize the macroblocks of the current input frame 105.

The macroblock bit accumulation circuitry 710 of the illustrated example also determines a closest macroblock QSF anchor pair for the current macroblock. The closest macroblock QSF anchor pair is a pair of QSF anchors that define the lower and upper bounds of an actual QSF that would quantize the AC transform coefficients to satisfy the target macroblock AC bit budget for the current macroblock. As such, the closest macroblock QSF anchor pair for the current macroblock includes the smallest anchor QSF that satisfies (e.g., is less than or equal to) the target macroblock AC bit budget for the current macroblock and the largest anchor QSF that does not satisfy (e.g., exceeds) the target macroblock AC bit budget for the current macroblock. Because the smallest anchor QSF that satisfies the target macroblock AC bit budget will be larger than the largest anchor QSF that does not satisfy the target macroblock AC bit budget, the largest anchor QSF that does not satisfy the target macroblock AC bit budget corresponds to the example lower macroblock anchor QSF 774 output by the macroblock bit accumulation circuitry 710, and the smallest anchor QSF that satisfies the target macroblock AC bit budget corresponds to the example higher macroblock anchor QSF 776 output by the macroblock bit accumulation circuitry 710. The macroblock bit accumulation circuitry 710 of the illustrated example outputs the closest macroblock QSF anchor pair for the current macroblock to the anchor pair interpolation circuitry 715.

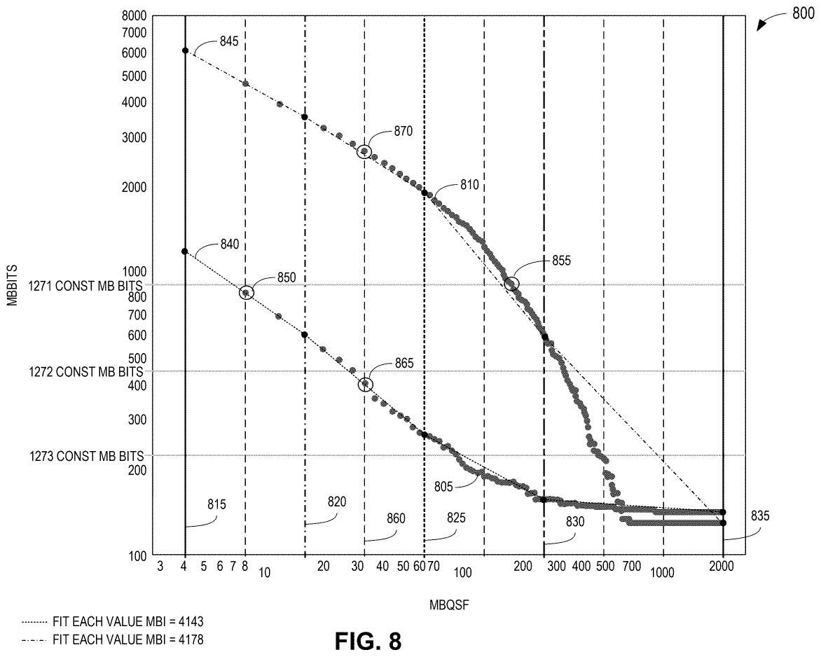

The anchor pair interpolation circuitry 715 of the illustrated example interpolates, as described above and illustrated further in the example of FIG. 8, between the lower macroblock anchor QSF 774 and the higher macroblock anchor QSF 776 of the closest macroblock QSF anchor pair for the current macroblock to determine an estimated QSF to quantize the current macroblock. For example, the anchor pair interpolation circuitry 715 applies a logarithmic transform (e.g., such as a natural logarithmic transform) to the lower macroblock anchor QSF 774 and the higher macroblock anchor QSF 776 of the closest macroblock QSF anchor pair for the current macroblock. In some examples, the anchor pair interpolation circuitry 715 applies a logarithmic transform (e.g., such as a natural logarithmic transform) to the total numbers of macroblock bits accumulated by the macroblock bit accumulation circuitry 710 respectively for the lower macroblock anchor QSF 774 and the higher macroblock anchor QSF 776 of the closest macroblock QSF anchor pair for the current macroblock. The anchor pair interpolation circuitry 715 then computes a linear interpolation between the pairs of log QSF values and corresponding log total number of macroblock bits in the closest macroblock QSF anchor pair for the current macroblock, and identifies an estimated QSF, also referred to herein as the estimated macroblock QSF, that lies on the linear interpolation and yields the target macroblock AC bit budget for the current macroblock. In some examples, the interpolated macroblock QSF is initially a fractional value, which the anchor pair interpolation circuitry 715 rounds to be an integer estimated macroblock QSF. In some examples, the anchor pair interpolation circuitry 715 is configured (e.g., by the encoder driver 102) with a rounding bias to be used when rounding the fractional interpolated macroblock QSF to be the integer estimated macroblock QSF). For example, the rounding bias can cause the anchor pair interpolation circuitry 715 to perform rounding based on a lower or higher cutoff than the usual rounding cutoff of 0.5. The anchor pair interpolation circuitry 715 outputs this estimated macroblock QSF as an example output QSF 778.

As also shown in the illustrated example QSF solver 120 of FIG. 7, the QSF evaluation circuits 705A-G provide their respective tuples (bits_j, qsf_j, nzcc_j), for j=0 . . . . J, to the frame bit accumulation circuitry 720. The frame bit accumulation circuitry 710 accumulates, for each anchor QSF, the total number of bits to encode the quantized AC transform coefficients for the different 8×8 blocks over all macroblocks (e.g., 4 8×8 blocks per macroblock) of the current input frame 105 to determine respective numbers of frame bits for the different anchor QSFs. Thus, the number of frame bits for a given anchor QSF represents the total number of bits to encode the quantized transformed AC coefficients for all macroblocks of the current input frame 105 when quantization is performed with the given anchor QSF. The frame bit accumulation circuitry 710 of the illustrated example outputs the respective numbers of frame bits for the different anchor QSFs as an example stream of frame metadata 779. In some examples, the encoder driver 102 uses the stream of frame metadata 779 to determine the macroblock QSFs to be used to quantize macroblocks of the current input frame 105, such as when performing RDO in TU2 mode.

The frame bit accumulation circuitry 720 of the illustrated example also determines a closest frame QSF anchor pair for the current input frame 105. The closest frame QSF anchor pair is a pair of QSF anchors that define the lower and upper bounds of an actual QSF that would quantize the AC transform coefficients to satisfy the target frame AC bit budget for the current input frame 105. As such, the closest frame QSF anchor pair for the current input frame 105 includes the smallest anchor QSF that satisfies (e.g., is less than or equal to) the target frame AC bit budget for the current frame and the largest anchor QSF that does not satisfy (e.g., exceeds) the target frame AC bit budget for the current frame. Because the smallest anchor QSF that satisfies the target frame AC bit budget will be larger than the largest anchor QSF that does not satisfy the target frame AC bit budget, the largest anchor QSF that does not satisfy the target frame AC bit budget corresponds to the example lower frame anchor QSF 780 output by the frame bit accumulation circuitry 720, and the smallest anchor QSF that satisfies the target frame AC bit budget corresponds to the example higher frame anchor QSF 782 output by the frame bit accumulation circuitry 720. The frame bit accumulation circuitry 710 of the illustrated example outputs the closest QSF anchor pair for the current frame to the anchor pair interpolation circuitry 715.

Similar to operation at the macroblock level, the anchor pair interpolation circuitry 715 of the illustrated example interpolates, as described above and illustrated further in the example of FIG. 8, between the lower frame anchor QSF 780 and the higher frame anchor QSF 782 of the closest fame QSF anchor pair for the current frame 105 to determine an estimated QSF to quantize the current frame 105. For example, the anchor pair interpolation circuitry 715 applies a logarithmic transform (e.g., such as a natural logarithmic transform) to the lower frame anchor QSF 780 and the higher frame anchor QSF 782 of the closest frame QSF anchor pair for the current input frame 105. In some examples, the anchor pair interpolation circuitry 715 applies a logarithmic transform (e.g., such as a natural logarithmic transform) to the total numbers of frame bits accumulated by the frame bit accumulation circuitry 720 respectively for the lower frame anchor QSF 780 and the higher frame anchor QSF 782 of the closest frame QSF anchor pair for the current input frame 105. The anchor pair interpolation circuitry 715 then computes a linear interpolation between the pairs of log QSF values and corresponding log total number of frame bits in the closest frame QSF anchor pair for the current input frame 105, and identifies an estimated QSF, also referred to herein as the estimated frame QSF, that lies on the linear interpolation and yields the target frame AC bit budget for the current input frame 105. The anchor pair interpolation circuitry 715 outputs this estimated frame QSF via the output QSF 778 (e.g., after outputting the estimated macroblock QSFs for all macroblocks of the current input frame 105).

The subtraction circuit 725 of the illustrated example computes the total target macroblock AC bit budget 784 for the current macroblock being encoded. In the illustrated example, the subtraction circuit 725 determines the total target macroblock AC bit budget 784 based on the total macroblock bit budget 785 for the current macroblock subtracted by the number of QSF independent bits 786 associated with the current macroblock. In the illustrated example, the encoder driver 102 configures the QSF solver circuitry 120 with the total macroblock bit budget 785, which the encoder driver 102 computes as the total frame bit budget based on the CID for the current input frame 105 divided by the number of macroblocks in the current input frame 105 (e.g., after subtracting any frame-level header and other data not associated with macroblock data from the total frame bit budget). Thus, the total macroblock bit budget 785 is constant across the macroblocks of the current input frame 105 As described above, the number of QSF independent bits 786 associated with the current macroblock corresponds to the number of QSF independent bits 155 determined by the non-quantizable data encoder circuitry 135 for the current macroblock. As described above, the QSF independent bits 155 for the current macroblock include the DC transform coefficient, the header data, the end of block data, etc.

The subtraction circuit 730 of the illustrated example computes the total target frame AC bit budget 788 for the current macroblock being encoded. In the illustrated example, the subtraction circuit 730 determines the total target frame AC bit budget 788 based on the total frame bit budget 789 for the current input frame 105 subtracted by the number of frame-level, macroblock independent bits 790 associated with the current frame 105. In the illustrated example, the encoder driver 102 configures the QSF solver circuitry 120 with the total frame bit budget 789 based on the CID for the current input frame 105. In the illustrated example, the encoder driver 102 also configures the QSF solver circuitry 120 with the number of frame-level, macroblock independent bits 790 associated with the current frame 105. The number of frame-level, macroblock independent bits 790 include any frame-level header data and other non-macroblock data included in the input frame 105.

The QSF solver circuitry 120 includes the multiplexer 735 to select between providing the target macroblock AC bit budget 784 or the target frame AC bit budget 788 to the anchor pair interpolation circuitry 715. The QSF solver circuitry 120 includes the demultiplexer 740 to select between outputting the estimated macroblock QSF 792 for the current macroblock or the estimated frame QSF 794 for the current frame 105 from the anchor pair interpolation circuitry 715. The multiplexer 735 and the demultiplexer 740 of the illustrated example are controlled via an example selection input 795. For example, the selection input 795 may configure the multiplexer 735 to select the target macroblock AC bit budget 784 and may configure the demultiplexer 740 to select the estimated macroblock QSF 792 while new macroblock data is being applied to the QSF solver circuitry 120 for each macroblock of the current frame 105. Then, after all macroblocks have been processed, the selection input 795 may switch to configure the multiplexer 735 to select the target frame AC bit budget 788 and to configure the demultiplexer 740 to select the estimated frame QSF 794 (e.g., after the frame bit accumulation circuitry 720 has finished accumulating data for the entire frame). As shown in the example of FIG. 7, the estimated macroblock QSF 792 is an integer value (e.g., rounded by the anchor pair interpolation circuitry 715 to a nearest integer), whereas the estimated frame QSF 794 can be a fractional value.

In the illustrated example QSF solver circuitry 120 of FIG. 7, the frame bit accumulation circuitry 720 outputs a scale factor 796 to be used to configure the target AC macroblock bit budgets for the different macroblocks of the current frame 105 when the video encoder circuitry 100 is operating in TU3 mode and is configured with a constant QSF for all macroblocks of the input frame. As described above, in TU3 mode, the target AC macroblock bit budgets may vary over different macroblocks due to the same QSF being used to quantize the different macroblocks of the input frame 105. The constant QSF used in TU3 mode corresponds to the estimated frame QSF 794 output from the anchor pair interpolation circuitry 715. Because the estimated frame QSF 794 may not correspond to one of the anchor QSFs, and the macroblock bit accumulation circuitry 710 and the frame bit accumulation circuitry 720 accumulate the numbers of macroblock bit and the numbers of frame bits for only the anchor QSFs, the QSF solver circuitry 120 may not know the particular number of macroblock bits produced when quantizing a particular macroblock based on the estimated frame QSF 794. However, the frame bit accumulation circuitry 720 does know the particular number of frame bits produced when quantizing the current input frame 105 at the next higher anchor QSF relative to the macroblock estimated frame QSF 794. For example, if the anchor QSFs are powers of 2 and the estimated QSF 794 is 25, the frame bit accumulation circuitry 720 knows the particular number of frame bits produced when quantizing the current input frame 105 based on the anchor QSF of 32. The frame bit accumulation circuitry 720 computes the scale factor 796 as a ratio of the total target frame AC bit budget 788 (which corresponds to the expected number of frame bits to be produced when quantizing the frame using the estimated QSF 794) divided by the particular number of frame bits produced when quantizing the current input frame 105 at the next higher anchor QSF. The scale factor 796 can then be used to scale the numbers of macroblock bits included in the stream of macroblock metadata 773 for the next higher anchor QSF to determine the macroblock AC bit budgets for the different macroblocks of the input frame 105 when quantized using the estimated QSF 794 (see the scale circuit 260 of FIG. 2).

FIG. 8 illustrates an example interpolation operation performed the example QSF solver circuitry 120 of FIGS. 1, 2 and/or 7. The example interpolation operation is illustrated by way of a graph 800 that depicts example plots of possible QSFs values vs. resulting numbers of macroblock bits for two example macroblocks of an example test input image. The first example macroblock with MB identifier (MBI) 4143 represents a normal video region, whereas the second example macroblock with MBI 4178 represents a noise region. The graph 800 illustrates example reference plots 805 and 810 that show the resulting numbers of macroblock bits for the respective macroblocks 4143 and 4148 by quantizing macroblocks 4143 and 4178 based on the different QSFs included in the set of 2047 QSFs supported by the QSF solver circuitry 120. Both reference plots 805 and 810 demonstrate a correlation between changes in the QSF and the resulting numbers of macroblock bits for the respective macroblocks 4143 and 4178. In particular, the sizes of the resulting numbers of macroblock bits for the respective macroblocks 4143 and 4148 decrease as the QSF increases. Furthermore, when a logarithmic transform is applied to the QSF values and the resulting numbers of macroblock bits as in the case of the log-log graph 800, the reference plots 805 and 810 exhibit piecewise linear relationships between changes in the QSF and the resulting numbers of macroblock bits for the respective macroblocks 4143 and 4148.

The example QSF solver circuitry 120 takes advantage of these relationships by computing resulting numbers of macroblock bits for a given macroblock based on just a relatively small set of anchor QSFs rather than examining the relatively large, complete set of possible QSFs. In the illustrated example of FIG. 8, the QSF solver circuitry 120 computes the resulting numbers of macroblock bits for the macroblocks 4143 and 4148 for the set of anchor QSFs 815-835 represented by the vertical lines in the graph 800. The QSF solver circuitry 120 then applies a logarithmic function to the anchor QSFs to compute logarithmic values corresponding to the anchor QSFs, and applies the logarithmic function to the resulting numbers of macroblock bits associated with the corresponding different anchor QSFs. The QSF solver circuitry 120 further performs piecewise linear interpolation based on the logarithmic values, which is represented by the example curves 840 and 845 for the respective macroblocks 4143 and 4178. While the curves 840 and 845 associated with the different macroblocks 4143 and 4178 have different slopes and offsets, the curves 840 and 845 show that the intermediate QSFs between the QSF anchor points exhibit linear correlation in the log-log domain. As such, the curves 840 and 845 demonstrate that the QSF solver circuitry 120 can examine a finite number of anchor QSFs without a priori knowledge of the image frame content and then perform piecewise linear interpolation to solve for a QSF that achieves the desired number of macroblock bits for the given macroblock being encoded. Furthermore, the estimation error associated with the piecewise linear interpolation can be decreased as the number of anchor QSFs is increased and the spacing between anchor points is optimized per CID.

For example, assume that the encoder driver 102 specifies a target number of bit per macroblock to be 900 bits for a given CID, such as CID 1271 in the illustrated example. As shown in the example of FIG. 8, the QSF solver circuitry 120 can perform linear interpolation between the anchor QSFs 815 and 820 to determine an estimated QSF 850 for the macroblock 4143. Likewise, the QSF solver circuitry 120 can perform linear interpolation between the anchor QSFs 825 and 830 to determine an estimated QSF 855 for the macroblock 4178. As shown by the graph 800, the estimated QSFs 850 and 855 are close to the actual QSFs that would achieve the specified target number of bits for the macroblocks 4143 and 4178. The graph 800 also demonstrates that the QSF solver circuitry 120 can perform linear interpolation between the anchor QSFs 825 and 830 to determine an estimated number of macroblock bits to be produced with a given target QSF. For example, an example target QSF represented by the vertical dashed line 860, the QSF solver circuitry 120 can use piecewise linear interpolation in the log-log domain to determine that the target QSF will yield an example estimated number of bits 865 for macroblock 4143 and an example estimated number of bits 870 for macroblock 4178.

As mentioned above, the estimation error associated with the piecewise linear interpolation performed by the QSF solver circuitry 120 can be reduced by tailoring the anchor QSFs to the particular CID specified for the input frame 105 or, more generally, by tailoring the anchor QSFs to the bit rate associated with the output bitstream 110. Thus, in some examples, the encoder driver 102 selects the set of anchor QSFs for the QSF solver circuitry 120 based on the CID specified for the input frame 105 being encoded. For example, for some CIDs, the encoder driver 102 may select the set of anchor QSFs to cover (evenly or unevenly) the entire range of possible QSFs (e.g., such as the entire range of the 2047 possible QSFs described above). However, for other CIDs, the encoder driver 102 may select the set of anchor QSFs to cover (evenly or unevenly) a subset of the entire range of possible QSFs (e.g., such as in a particular range of the 2047 possible QSFs described above).

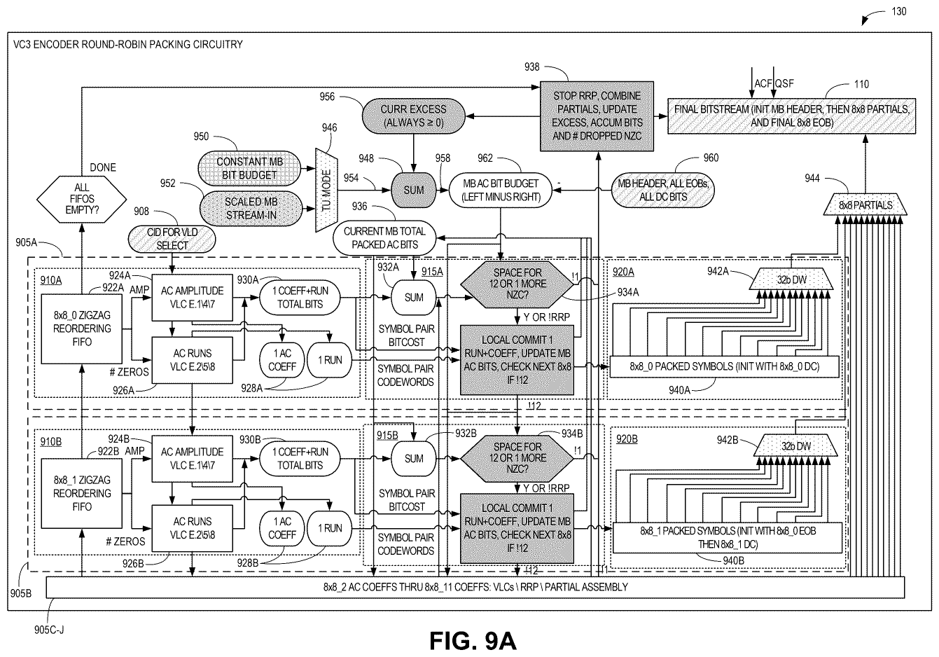

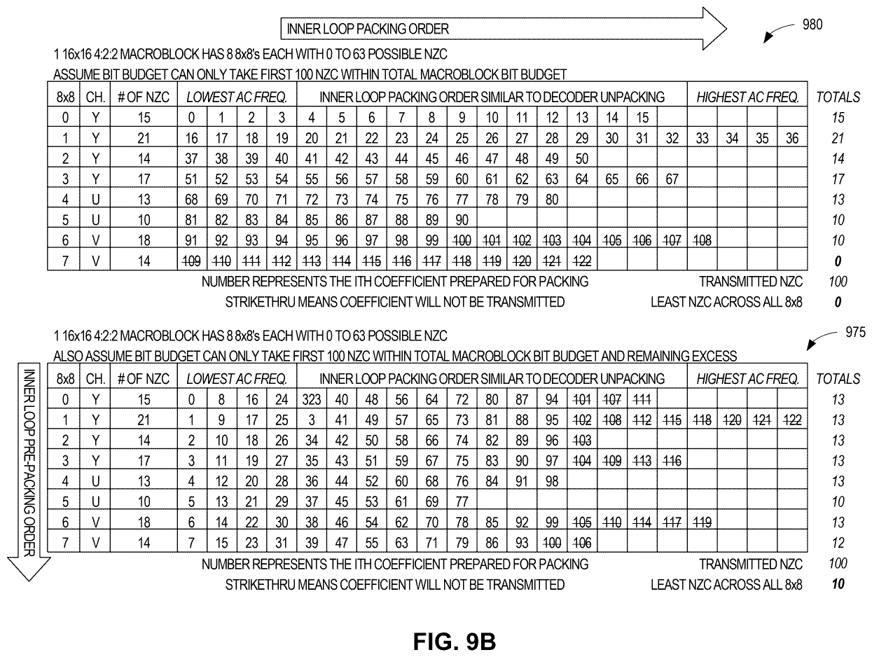

FIG. 9A is a block diagram of an example implementation of the bit coding circuitry 130 included in the example video encoder circuitry 100 of FIGS. 1 and/or 2. The bit coding circuitry 130 of FIG. 9A may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the bit coding circuitry 130 of FIG. 9A may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 9A may, thus, be instantiated at the same or different times. Some or all of the circuitry of FIG. 9A may be instantiated, for example, in one or more threads executing concurrently on hardware and/or in series on hardware. Moreover, in some examples, some or all of the circuitry of FIG. 9A may be implemented by microprocessor circuitry executing instructions and/or FPGA circuitry performing operations to implement one or more virtual machines and/or containers.

The example bit coding circuitry 130 of FIG. 9A includes example block bit packing circuits 905A-L that support processing of up to 12, 8×8 blocks of a given macroblock in parallel. The number of individual block bit packing circuits 905A-L that are active (e.g., enabled) for a given macroblock is based on the CID 908 configured by the encoder driver 102 for the given macroblock. For example, if the CID 908 specifies 4:4:4 chroma sampling, then all 12 block bit packing circuits 905A-L will be active to support encoding and packing of 4, 8×8 Y blocks, 4, 8×8 U blocks and 4, 8×8 V blocks. However, if the CID 908 specifies 4:2:2 chroma subsampling or 4:2:0 chroma subsampling, for example, then fewer than the 12 block bit packing circuits 905A-L will be active to support encoding and packing of 4, 8×8 Y blocks and some subset of the 8×8 U and V blocks.

The example of FIG. 9A illustrates example circuitry included in the block bit packing circuits 905A and 905B. Similar circuitry is included in the block bit packing circuits 905C-L. The block bit packing circuit 905A of the illustrated example includes an example VLC encoding circuit 910A, an example round robin packing (RRP) circuit 915A and an example partial assembly circuit 920A. Likewise, the block bit packing circuit 905B of the illustrated example includes an example VLC encoding circuit 910B, an example RRP circuit 915B and an example partial assembly circuit 920B.

The VLC encoding circuit 910A performs VLC encoding of a first 8×8 block (labeled block 8×8_0) of the current macroblock. The VLC encoding circuit 910A of the illustrated example includes an example reordering FIFO 922A, an example AC amplitude VLC encoder circuit 924A, and an example AC runs VLC encode circuit 926A. The FIFO 922A accepts the DC coefficient and quantized AC coefficients of the first 8×8 block of the macroblock and performs reordering of the coefficients according to the VC3 standard. The AC amplitude VLC encoder circuit 924A encodes the non-zero quantized AC coefficients into corresponding AC coefficient codewords based on one or more VC3 tables associated with the CID configured for the current macroblock. The AC runs VLC encode circuit 926A encodes the runs of zero-valued AC coefficients into corresponding run codewords based on one or more VC3 tables associated with the CID configured for the current macroblock. For each non-zero AC coefficient, the AC amplitude VLC encoder circuit 924A and the AC runs VLC encode circuit 926A output a symbol pair codeword 928A including the AC coefficient codeword for the non-zero AC coefficient and the run codeword encoding the run of zero-valued AC coefficients associated with that non-zero AC coefficient. For each non-zero AC coefficient, the AC amplitude VLC encoder circuit 924A and the AC runs VLC encode circuit 926A also output the number of bits 930A used to encode the symbol pair codeword for that non-zero AC coefficient.

Similarly, the VLC encoding circuit 910B performs VLC encoding of a second 8×8 block (labeled block 8×8_1) of the current macroblock. The VLC encoding circuit 910B of the illustrated example includes an example reordering FIFO 922B, an example AC amplitude VLC encoder circuit 924B, and an example AC runs VLC encode circuit 926B. The FIFO 922B accepts the DC coefficient and quantized AC coefficients of the second 8×8 block of the macroblock and performs reordering of the coefficients according to the VC3 standard. The AC amplitude VLC encoder circuit 924B encodes the non-zero quantized AC coefficients into corresponding AC coefficient codewords based on one or more VC3 tables associated with the CID configured for the current macroblock. The AC runs VLC encode circuit 926B encodes the runs of zero-valued AC coefficients into corresponding run codewords based on one or more VC3 tables associated with the CID configured for the current macroblock. For each non-zero AC coefficient, the AC amplitude VLC encoder circuit 924B and the AC runs VLC encode circuit 926B output a symbol pair codeword 928B including the AC coefficient codeword for the non-zero AC coefficient and the run codeword encoding the run of zero-valued AC coefficients associated with that non-zero AC coefficient. For each non-zero AC coefficient, the AC amplitude VLC encoder circuit 924B and the AC runs VLC encode circuit 926B also output the number of bits 930B used to encode the symbol pair codeword for that non-zero AC coefficient.

The RRP circuit 915A perform RRP operations associated with the first 8×8 block (labeled block 8×8_0) of the current macroblock. At a high-level, the bit coding circuitry 130 of the illustrated example selects symbol pair codewords for packing into the output bitstream 110 individually from successive 8×8 blocks of the current macroblock in a round-robin manner until a stopping condition is met. In some examples, the stopping condition is met when all symbol pair codewords from all 8×8 blocks have been packed into the output bitstream 110, or there is no more room to pack symbol pair codewords into the output bitstream 110. This is in contrast to how other VC3 encoders may select symbol pair codewords for packing, which is to select all symbol pair codewords for the first 8×8 block, followed by all symbol pair codewords for the second 8×8 block and so on until either all 8×8 blocks have been packed into the output bitstream, or there is no more room to pack symbol pair codewords into the output bitstream. In such prior techniques, it is possible to run out of room before one or more 8×8 blocks have any symbol pair codewords packed into the output bitstream, which can lead to unpleasing visual artifacts in the decoded image. In contrast, the RRP procedure implemented by the bit coding circuitry 130 cycles through the different 8×8 blocks repeatedly to select an individual symbol pair codeword from each different 8×8 block successively, thereby attempting to ensure that at least some of the symbol pair codewords from all of the 8×8 blocks of the current macroblock are included in the output bitstream, which can reduce the presence of unpleasing visual artifacts in the decoded image relative to other VC3 encoders.

To implement such an RRP procedure, the RRP circuit 915A of the illustrated example includes an example sum circuit 932A and an example RRP decision circuit 934A. The sum circuit 932A tracks the number of symbol pair codeword bits associated with the first 8×8 block (labeled block 8×8_0) that have been selected by the RRP circuit 915A so far for packing into the output bitstream 110. The sum circuit 932A compares the number of symbol pair codeword bits packed so far for first 8×8 block to a total current number of bits 936 for all symbol pair codewords selected across all 8×8 blocks for packing so far to determine a number of available bits remaining for bit packing.

The RRP decision circuit 934A of the illustrated example uses the number of available bits output from the sum circuit 932A to determine whether a next symbol pair codeword of the first 8×8 block can be selected for packing into the output bitstream 110. For example, if the number of available bits is sufficient to pack the next symbol pair codeword of the first 8×8 block, or if RRP is disabled, then the RRP decision circuit 934A causes the next symbol pair codeword of the first 8×8 block to be provided to the partial assembly circuit 920A for packing into the output bitstream 110, and the total current number of bits 936 is updated to include the bits for this next symbol pair codeword. (For example, RRP may be disabled in TU2 mode because, in TU2 mode, the encoder driver 102 configures the QSF for the given macroblock to cause the number of encoded macroblock bits to fit exactly into the output bitstream 110 and, thus, RRP is unnecessary.) However, a stopping condition is met, such as if the number of available bits is insufficient to pack the next symbol pair codeword of the first 8×8 block, the RRP decision circuit 934A causes the RRP processing to stop and an example RRP stop circuit 938 is invoked to trigger final combining of the partial bit packing results for each of the 8×8 blocks of the current macroblock. In some examples, the RRP decision circuit 934A also tracks other bit packing statistics, such as the total number of non-zero AC coefficients that were dropped during bit packing, and a number of excess bits accumulated during packing of the current macroblock and any preceding macroblocks of the current input frame 105.

The RRP circuit 915B of the illustrated example includes an example sum circuit 932B and an example RRP decision circuit 934B. The sum circuit 932B and the example RRP decision circuit 934B operate similarly to the sum circuit 932A and the RRP decision circuit 934A described above, but in association with the second 8×8 block (e.g., block 8×8_1) of the current macroblock being packed into the output bitstream.

The partial assembly circuit 920A includes example memory 940A to store the AC symbol pair codewords selected from the first 8×8 block (block 8×8_0) by the RRP circuit 915A for packing into the output bitstream 110. The partial assembly circuit 920A also stores the encoded DC coefficient and other encoded QSF-independent data associated with the first 8×8 block (block 8×8_0) of the current macroblock being encoded and packed into the output bitstream 110. The partial assembly circuit 920A further includes an example multiplexer 942A to read the encoded DC coefficient, the other encoded QSF-independent data, and the selected AC symbol pair codewords for the first 8×8 block (block 8×8_0) out from the memory 940A in sequential order for packing in the output bitstream 110. The multiplexer 942A can be a 32-bit multiplexer, a 64-bit multiplexer, or any other multiplexer.

Similarly, the partial assembly circuit 920B includes example memory 940B to store the AC symbol pair codewords selected from the second 8×8 block (block 8×8_1) by the RRP circuit 915B for packing into the output bitstream 110. The partial assembly circuit 920B also stores the encoded DC coefficient and other encoded QSF-independent data associated with the second 8×8 block (block 8×8_1) of the current macroblock being encoded and packed into the output bitstream 110. The partial assembly circuit 920B further includes an example multiplexer 942B to read the encoded DC coefficient, the other encoded QSF-independent data, and the selected AC symbol pair codewords for the second 8×8 block (block 8×8_1) out from the memory 940B in sequential order for packing in the output bitstream 110. The multiplexer 942B can be a 32-bit multiplexer, a 64-bit multiplexer, or any other multiplexer.

The bit coding circuitry 130 of the illustrated example includes an example final assembly multiplexer 944 to assemble the encoded data stored for the different 8×8 blocks of the current macroblock in the respective partial assembly circuits 920A-J. In the illustrated example, the final assembly multiplexer 944 accesses all the encoded data for the first 8×8 block (block 8×8_0) from the partial assembly circuit 920A, followed by all the encoded data for the second 8×8 block (block 8×8_1) from the partial assembly circuit 920B, and so on, until all the selected encoded data for the current macroblock has been packed into the output bitstream 110.

The bit coding circuitry 130 of the illustrated example also includes an example mode multiplexer 946 and an example sum circuit 948 to control operation of the RRP circuits 915A, B, etc. included in the block bit packing circuits 905A-L. For example, the mode multiplexer 946 selects between a constant macroblock bit budget 950 (e.g., associated with TU4 mode) or a scaled macroblock bit budget 952 (e.g., associated with TU3 mode) provided by the encoder driver 102. The sum circuit 948 adds the macroblock bit budget 954 output from the mode multiplexer 946 to a current number of excess bits 956 available for packing to determine a total number of currently available macroblock bits 958. The bit coding circuitry 130 subtracts the number of QSF-independent bits 960 (e.g., such as the DC coefficient, the macroblock header data, the macroblock end of block data, etc.) for the current macroblock from the total number of currently available macroblock bits 958 top determine a total current macroblock AC bit budget currently available for encoding the AC coefficients of the current macroblock.

In the illustrated example, the bit coding circuitry 130 tracks the excess bits 956 available for packing data into the output bitstream 110. In some examples, the excess bits are obtained from the current and/or preceding blocks when there are leftover bits that remain to be packed into the output bitstream 110 after all the available data for a given macroblock has been packed into the output bitstream 110. Rather than packing the leftover bits with zeros, bit coding circuitry 130 tracks the number of these leftover bits as excess bits that can be used for encoding and packing the current and subsequent macroblocks of the input frame 105. For example, if a subsequent macroblock has encoded data that exceed the bit budget for that macroblock, the bit coding circuitry 130 may be able to pack the excess data into the excess bits 956 and, thus, avoid dropping some of the encoded data associated with that macroblock. If there are still excess bits 956 available at the end of encoding and packing all macroblocks into the output bitstream 110, the bit coding circuitry 130 may packing the remaining excess bits with zeros.

FIG. 9B illustrates an example bit packing operation 975 of the bit coding circuitry 130 of FIG. 9A. For reference, FIG. 9B also illustrates another example bit packing operation 980 performed by other VC3 encoders. As described above, in the bit packing operation 980 of the illustrated example, the VC3 encoder selects all the available non-zero AC coefficients (e.g., the symbol pair codewords) from each 8×8 block of the macroblock in order until there are insufficient remaining bits to continue to pack the available non-zero AC coefficients into the output bitstream. In the examples of FIG. 8, the CID for the current macroblock specifies 4:2:2 chroma subsampling and, thus, there are eight (8), 8×8 blocks in the current macroblock, and there is space for 100 non-zero AC coefficients (e.g., the symbol pair codewords) in the output bitstream. The VC3 encoder selects all the available non-zero AC coefficients (e.g., the symbol pair codewords) from the first 8×8 block (e.g., block 8×8_0) for packing, followed by all the available non-zero AC coefficients (e.g., the symbol pair codewords) from the second 8×8 block for packing, and so on, until the VC3 encoder reaches the seventh 8×8 block (e.g., block 8×8_6). When attempting to pack the seventh 8×8 block (e.g., block 8×8_6), the VC3 encoder reaches the 100th non-zero AC coefficient for packing and, thus, drops the remaining AC coefficients from the output bitstream. As such, the VC3 encoder drops all the AC coefficients from the eighth 8×8 block (e.g., block 8×8_7), which can produce undesirable effects in the decoded image.

In contrast, the bit packing operation 975 of the illustrated example, the bit coding circuitry 130 example selects non-zero AC coefficients (e.g., the symbol pair codewords) for packing into the output bitstream 110 individually from successive 8×8 blocks of the current macroblock in a round-robin manner until there are insufficient remaining bits to continue to pack the available non-zero AC coefficients into the output bitstream. In other words, the bit coding circuitry 130 cycles through the different 8×8 blocks repeatedly to select an individual non-zero AC coefficient (e.g., the symbol pair codeword) from each different 8×8 block successively, thereby attempting to ensure that at least some of the non-zero AC coefficients (e.g., the symbol pair codewords) from all of the 8×8 blocks of the current macroblock are included in the output bitstream, which can reduce the presence of unpleasing visual artifacts in the decoded image relative to other VC3 encoders.

For example, in the bit packing operation 975, the bit coding circuitry 130 selects a first non-zero AC coefficient (e.g., a first symbol pair codeword) from the first 8×8 block (e.g., block 8×8_0) for packing, followed by a first non-zero AC coefficient (e.g., a first symbol pair codeword) from the second 8×8 block for packing, and so on, until the bit coding circuitry 130 reaches the eighth 8×8 block (e.g., block 8×8_7) and selects a first non-zero AC coefficient (e.g., a first symbol pair codeword) from that block for packing. In the bit packing operation 975, there are still remaining bits in the output bitstream 110 and, thus, the bit coding circuitry 130 cycles back to the first 8×8 block (e.g., block 8×8_0) and selects a second non-zero AC coefficient (e.g., a second symbol pair codeword) from the first 8×8 block (e.g., block 8×8_0) for packing, followed by a second non-zero AC coefficient (e.g., a second symbol pair codeword) from the second 8×8 block for packing, and so on, until the bit coding circuitry 130 reaches the eighth 8×8 block (e.g., block 8×8_7) and selects a second non-zero AC coefficient (e.g., a second symbol pair codeword) from that block for packing. This process continues for 12 cycles through the eight, 8×8 blocks of the current block. Then during the 13^{th} cycle, the bit coding circuitry 130 reaches the 100^{th} non-zero AC coefficient for packing and, thus, drops the remaining AC coefficients from the output bitstream. As can seen in the illustrated example, the bit packing operation 975 performed by the bit coding circuitry 130 results in non-zero AC coefficients (e.g., a second symbol pair codewords) from all 8×8 blocks of the current macroblock being packed into the output bitstream 110.

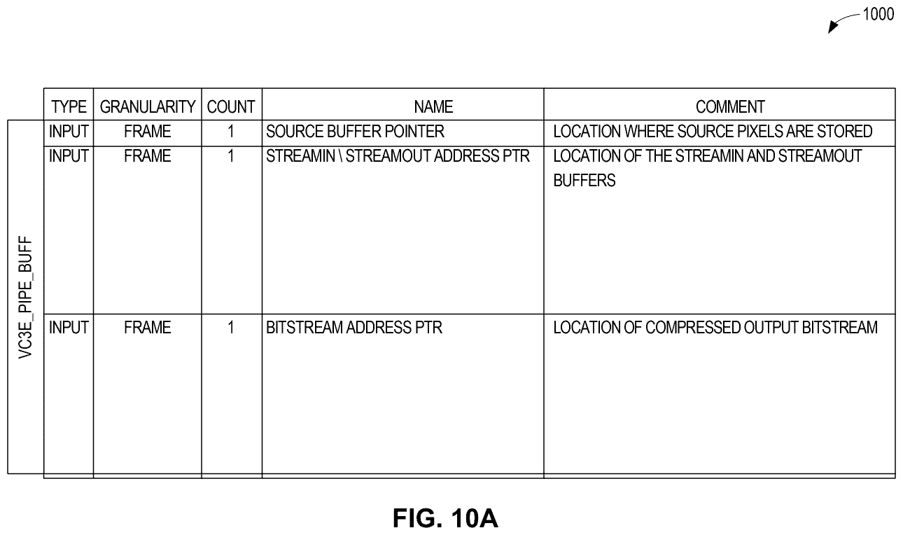

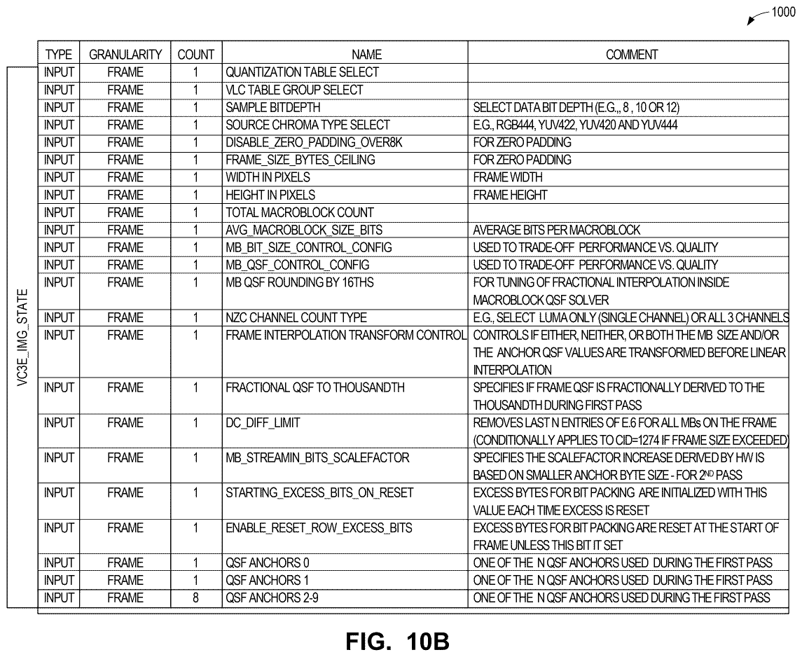

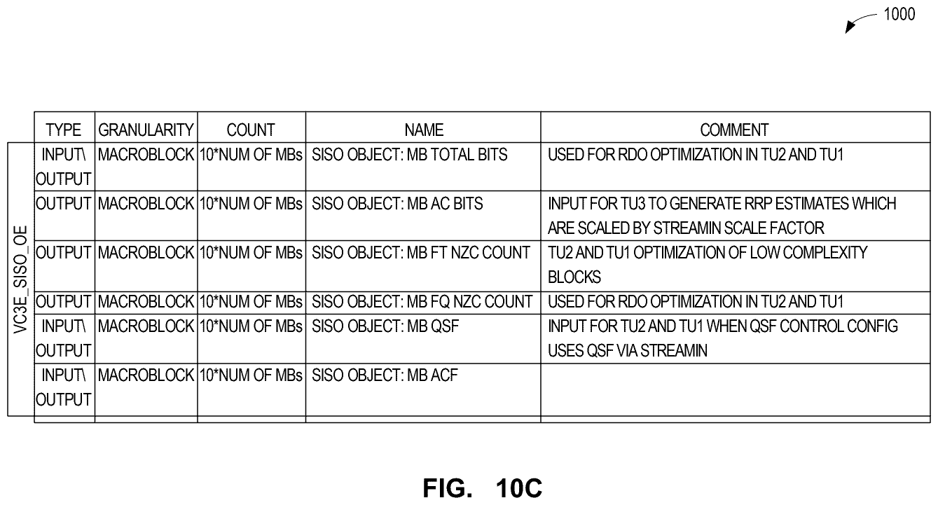

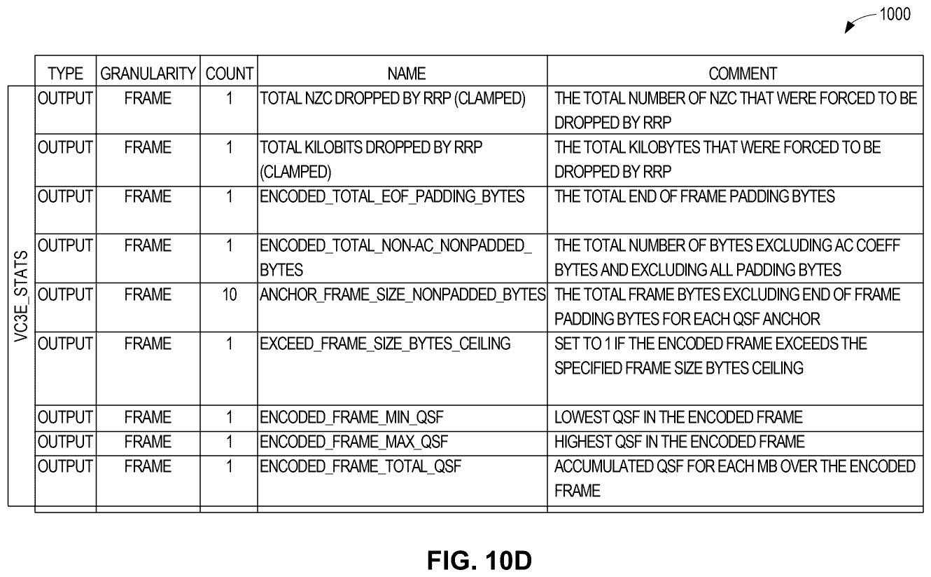

FIGS. 10A-10D illustrate an example input/output (I/O) interface 1000 implemented by the video encoder circuitry 100 of FIGS. 1 and/or 2 to interface with the encoder driver 102. The I/O interface 1000 of the illustrated example includes generic hardware programming control fields, such as memory address pointers of the raw source and compressed bitstream. In addition to such general controls, the example I/O interface 1000 includes several fields that can be used by the encoder driver 102 to configure operation of the video encoder circuitry 100 in a particular TU mode, as described in connection with FIGS. 1-18B. Furthermore, the example I/O interface 1000 includes several fields that can be used to output date from the video encoder circuitry 100 to the encoder driver 102.

For example, the I/O interface 1000 includes frame level inputs (e.g., corresponding to one (1) field per frame) including normative fields related to the CID, such as VLC table and quantization table indices, information about the source, such as width, height, bitdepth and chroma subsampling arrangement, and controls to enable zero padding and the amount to pad up to if the video encoder circuitry 100 has not used all available bits.

The I/O interface 1000 of the illustrated example also includes several frame level controls related to algorithmic tradeoffs for the encoder, which may not be required for all passes of a given TU. Examples of such controls include the target number of macroblock bits, the mb_bit_size_control and mb_qsf_control configs which set the TU, rounding controls for QSF interpolation, mono or trichannel NZC (nonzero coefficient) count select, log before interpolation enable, optional restriction of large DC delta VLC entries, frame average QSF with fractional precision, scalefactor for per macroblock specific bit budget streamin, initialization and reset frequency for round-robin packing excess bits, the number (N) of QSF anchors, etc.

The I/O interface 1000 of the illustrated example further includes a macroblock granularity interface that contains a structure of either input or output data depending on the TU settings. In some examples, information in the macroblock streamin and/or streamout buffer(s) contains number of total bits, number of AC coefficient bits, number of non-zero coefficients (NZCs) following forward transform and after quantization, the QSF value, the ACF setting, etc. In some examples, there are M total macroblocks present in the input frame, and either 1 or N total collections of these buffers (for each anchor QSF) where 1 corresponds to the case of streamin, and N corresponds to the case of streamout.

The I/O interface 1000 of the illustrated example also includes multiple frame level outputs such as total NZC and bits dropped during round-robin packing, total number of zeros padded, total number of all bits excluding AC bits and end of frame (EOF) padding bits, total frame sizes of each anchor QSF, error flag to indicate frame size exceeded due to programming issue, and min/max and average QSF observed in the final bitstream.

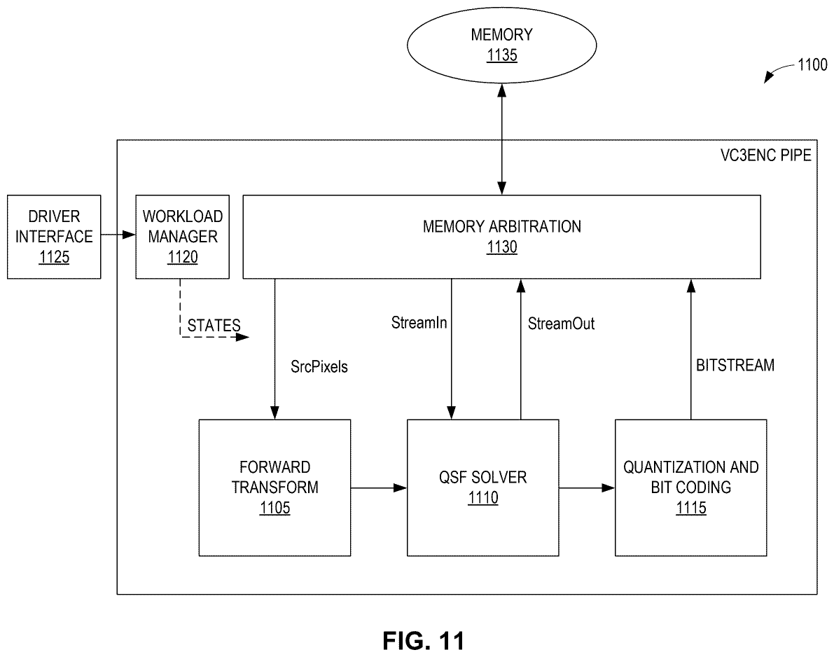

FIG. 11 illustrates an example hardware pipeline 1100 that can be used to implement the video encoder circuitry of FIGS. 1 and/or 2. The hardware pipeline 1100 of FIG. 11 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the hardware pipeline 1100 of FIG. 11 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 11 may, thus, be instantiated at the same or different times. Some or all of the circuitry of FIG. 11 may be instantiated, for example, in one or more threads executing concurrently on hardware and/or in series on hardware. Moreover, in some examples, some or all of the circuitry of FIG. 11 may be implemented by microprocessor circuitry executing instructions and/or FPGA circuitry performing operations to implement one or more virtual machines and/or containers.

The hardware pipeline 1100 of the illustrated example includes example circuit blocks that can be invoked or executed independently and in parallel to achieve a desired pipeline operating flow. The circuit blocks of the illustrated example include an example forward transform circuit block 1105, an example QSF solver and quantizer circuit block 1110 and an example bit coding circuit block 1115. The forward transform circuit block 1105 of the illustrated example implements the forward transform circuitry 115 of the video encoder circuitry 100. The QSF solver and quantizer circuit block 1110 of the illustrated example implements the QSF solver circuitry 120 and the forward quantization circuitry 125 of the video encoder circuitry 100. The bit coding circuit block 1115 of the illustrated example implements the bit coding circuitry 130 of the video encoder circuitry 100. Because the forward transform circuit block 1105, the QSF solver and quantizer circuit block 1110 and bit coding circuit block 1115 can be invoked/executed independently and in parallel, the forward transform circuitry 115, the combination of the QSF solver circuitry 120 and the forward quantization circuitry 125, and the bit coding circuitry 130 of the video encoder circuitry 100 can be invoked/executed independently and in parallel based on a timing diagram to achieve a desired pipeline operating flow, a described in further detail below.

The hardware pipeline 1100 of the illustrated example also includes example workload manager circuitry 1120 to manage (e.g., configure, control, schedule, etc.) invocation/execution of the forward transform circuit block 1105, the QSF solver and quantizer circuit block 1110 and the bit coding circuit block 1115 based on a timing diagram to achieve a desired pipeline operating flow. In the illustrated example, operation of the workload manager circuitry 1120 is controlled by the encoder driver 102 via an example driver interface 1125.

The hardware pipeline 1100 of the illustrated example further includes example memory arbitration circuitry 1130 to arbitrate access to example memory 1135 used to exchange data among the forward transform circuit block 1105, the QSF solver and quantizer circuit block 1110 and the bit coding circuit block 1115. Because the forward transform circuit block 1105, the QSF solver and quantizer circuit block 1110 and the bit coding circuit block 1115 can be invoked/executed independently and in parallel, the memory arbitration circuitry 1130 is provided to ensure there are no memory access conflicts when the forward transform circuit block 1105, the QSF solver and quantizer circuit block 1110 and the bit coding circuit block 1115 attempt to access the memory (e.g., to read from the memory 1135, to write to the memory 1135, etc.).

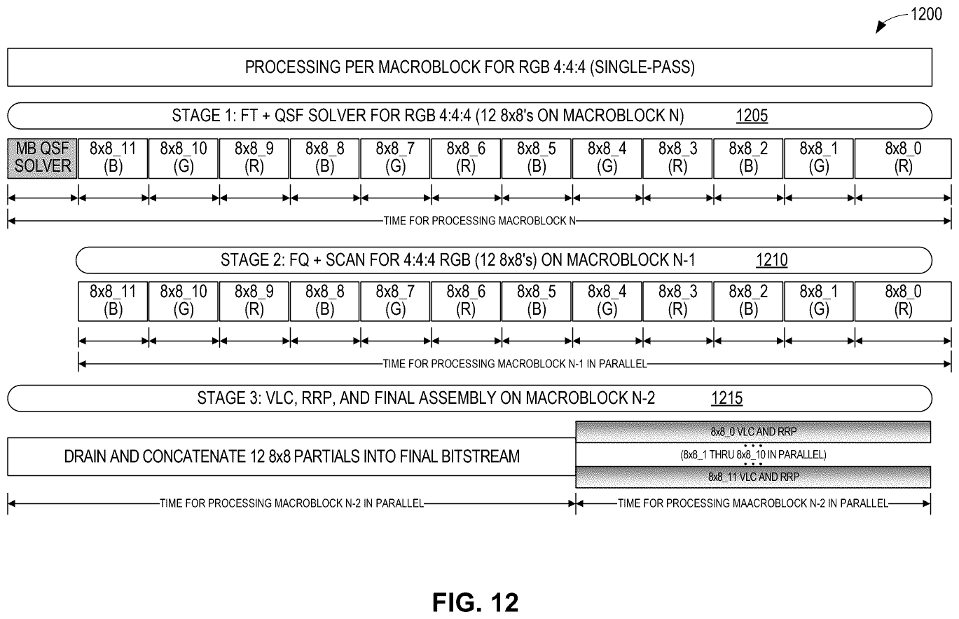

FIGS. 12-14 illustrate example timing diagrams associated with the hardware pipeline 1100 of FIG. 11. The example timing diagram 1200 of FIG. 12 depicts a 3-stage macroblock pipeline based on the chroma subsampling of 4:4:4. The timing diagram 1200 does not show an initial stage in which the video encoder circuitry 100 loads the input source image frame 105 from memory. As shown in the timing diagram 1200, an example first stage 1205 of the macroblock pipeline corresponds to operation of the forward transform circuit block 1105 on a current macroblock (e.g., represented as Macroblock N in FIG. 12) followed by operation of the QSF solver and quantizer circuit block 1110 on the current macroblock. An example second stage 1210 of the macroblock pipeline corresponds to operation of the QSF solver and quantizer circuit block 1110 on the next adjacent preceding macroblock (e.g., represented as Macroblock N−1 in FIG. 12). An example third stage 1215 of the macroblock pipeline corresponds to operation of the bit coding circuit block 1115 on the next adjacent preceding macroblock (e.g., represented as Macroblock N−2 in FIG. 12). As shown in the timing diagram 1200, the first stage 1205, the second stage 1210 and the third stage 1215 operate in parallel with the QSF solver and quantizer circuit block 1110 able to be shared among the first stage 1205 and the second stage 1210 based on the non-overlapping invocation/execution of the QSF solver and quantizer circuit block 1110 in those two stages. As such, implementing the video encoder circuitry 100 based on architecture of the hardware pipeline 1100 can achieve improvements in encoder performance due to the parallel pipeline operation.

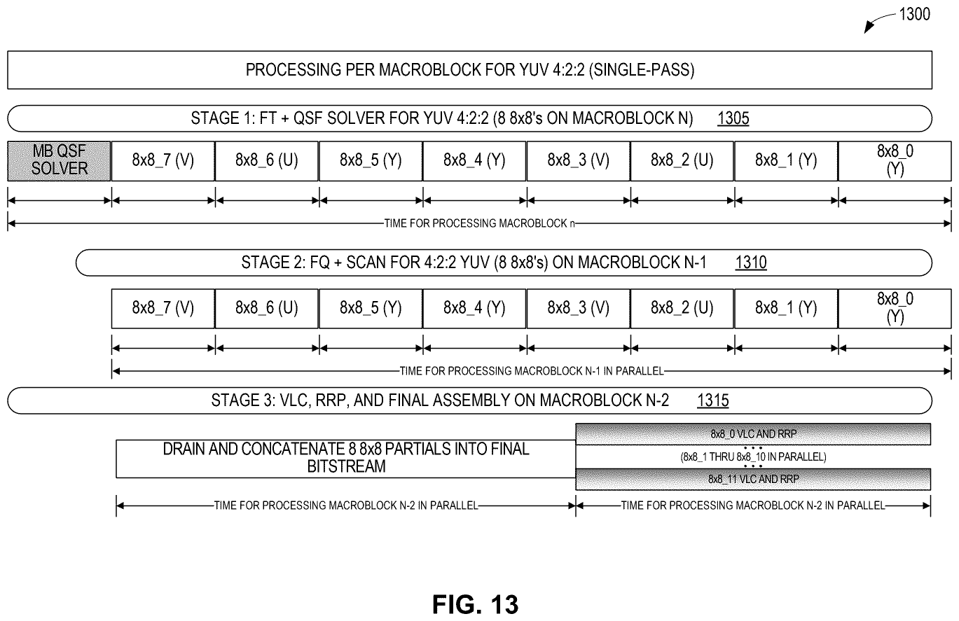

The example timing diagram 1300 of FIG. 13 depicts a 3-stage macroblock pipeline based on the chroma subsampling of 4:2:2. The timing diagram 1300 does not show an initial stage in which the video encoder circuitry 100 loads the input source image frame 105 from memory. As shown in the timing diagram 1300, an example first stage 1305 of the macroblock pipeline corresponds to operation of the forward transform circuit block 1105 on a current macroblock (e.g., represented as Macroblock N in FIG. 13) followed by operation of the QSF solver and quantizer circuit block 1110 on the current macroblock. An example second stage 1310 of the macroblock pipeline corresponds to operation of the QSF solver and quantizer circuit block 1110 on the next adjacent preceding macroblock (e.g., represented as Macroblock N−1 in FIG. 13). An example third stage 1315 of the macroblock pipeline corresponds to operation of the bit coding circuit block 1115 on the next adjacent preceding macroblock (e.g., represented as Macroblock N−2 in FIG. 13). As shown in the timing diagram 1300, the first stage 1305, the second stage 1310 and the third stage 1315 operate in parallel with the QSF solver and quantizer circuit block 1110 able to be shared among the first stage 1305 and the second stage 1310 based on the non-overlapping invocation/execution of the QSF solver and quantizer circuit block 1110 in those two stages. As such, implementing the video encoder circuitry 100 based on architecture of the hardware pipeline 1100 can achieve improvements in encoder performance due to the parallel pipeline operation.

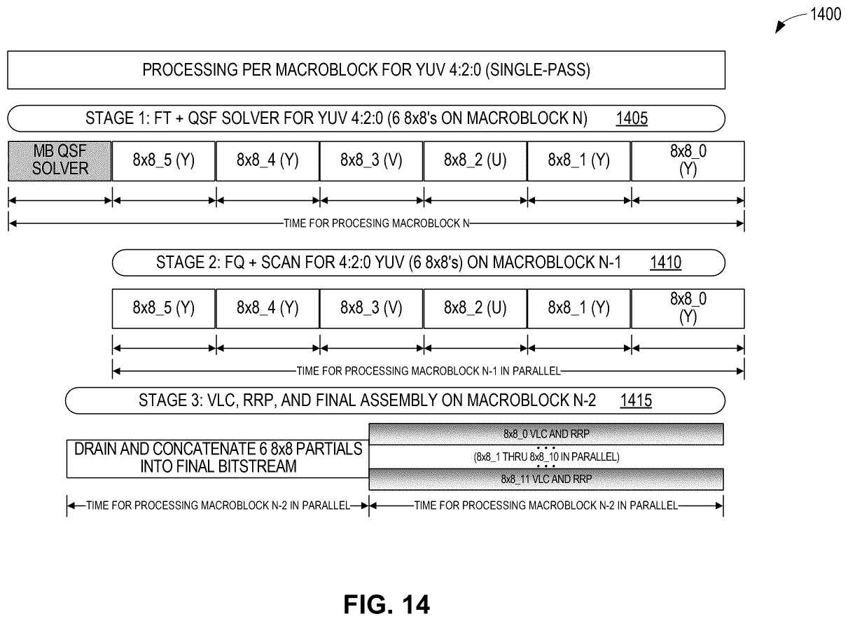

The example timing diagram 1400 of FIG. 14 depicts a 3-stage macroblock pipeline based on the chroma subsampling of 4:2:0. The timing diagram 1400 does not show an initial stage in which the encoder circuitry 100 loads the input source image frame 105 from memory. As shown in the timing diagram 1400, an example first stage 1405 of the macroblock pipeline corresponds to operation of the forward transform circuit block 1105 on a current macroblock (e.g., represented as Macroblock N in FIG. 13) followed by operation of the QSF solver and quantizer circuit block 1110 on the current macroblock. An example second stage 1410 of the macroblock pipeline corresponds to operation of the QSF solver and quantizer circuit block 1110 on the next adjacent preceding macroblock (e.g., represented as Macroblock N−1 in FIG. 13). An example third stage 1415 of the macroblock pipeline corresponds to operation of the bit coding circuit block 1115 on the next adjacent preceding macroblock (e.g., represented as Macroblock N−2 in FIG. 13). As shown in the timing diagram 1400, the first stage 1405, the second stage 1410 and the third stage 1415 operate in parallel with the QSF solver and quantizer circuit block 1110 able to be shared among the first stage 1405 and the second stage 1410 based on the non-overlapping invocation/execution of the QSF solver and quantizer circuit block 1110 in those two stages. As such, implementing the video encoder circuitry 100 based on architecture of the hardware pipeline 1100 can achieve improvements in encoder performance due to the parallel pipeline operation.

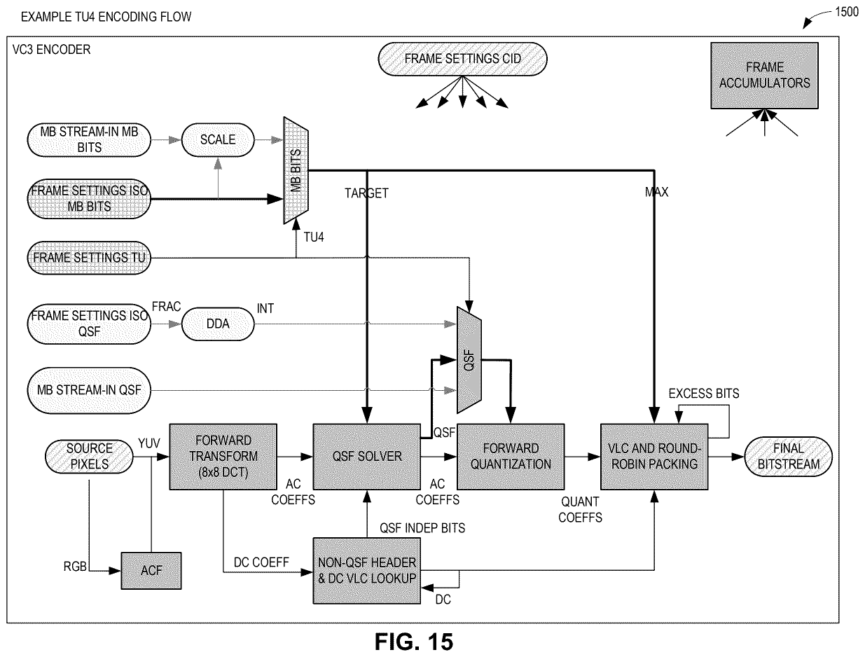

FIGS. 15A-15B illustrate an example TU4 encoding flow 1500 implemented using the example configuration depicted in FIG. 4 for the example video encoder circuitry 100 of FIG. 2. The example TU4 encoding flow implements a single-pass mode that has no a priori hint regarding how to distribute the bits. Thus, each macroblock is given an even distribution. In some examples, subjective quality is good, but objective quality metrics are not.

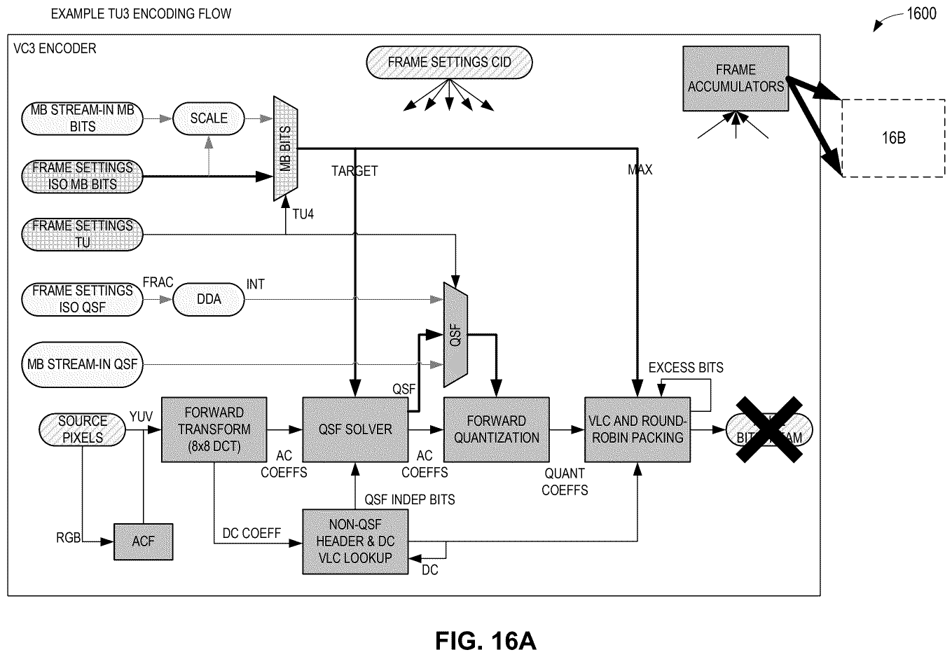

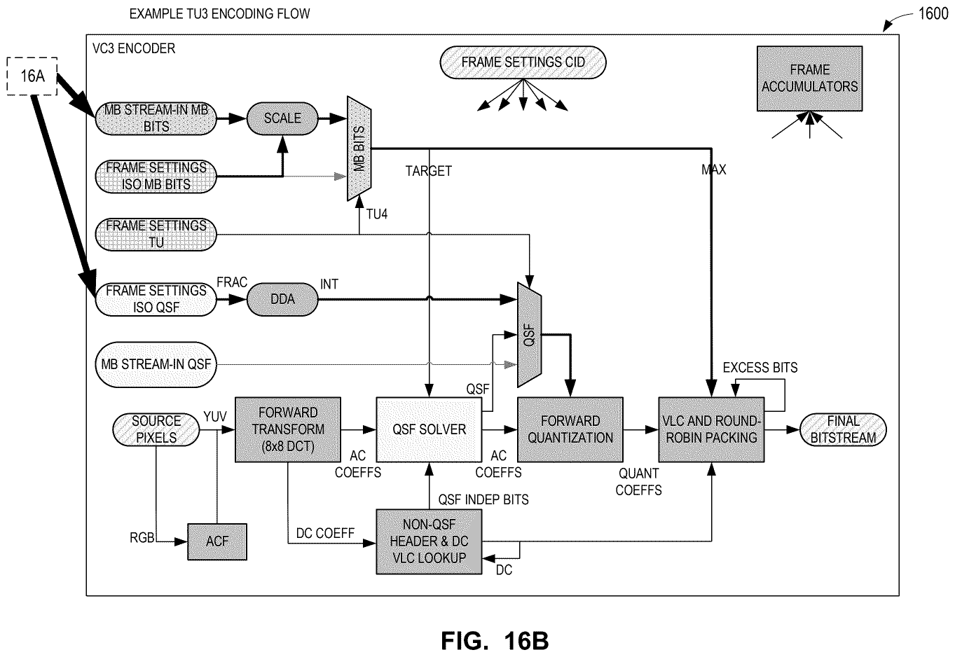

FIGS. 16A-16B illustrate an example TU3 encoding flow 1600 implemented using the example configurations depicted in FIGS. 4 and 5 for the example video encoder circuitry 100 of FIG. 2. In the example TU3 encoding flow, after the first pass, the lowest average QSF across the frame can be derived by the QSF solver circuitry 120 with frame statistics instead of macroblock statistics, and without assistance by the encoder driver 102. In some examples, objective quality is improved, and subjective quality is similar to TU4 for most CIDs except CID 1274. In some examples, the estimated frame QSF derived by the QSF solver circuitry 120 in the first pass is an interpolated value between a higher anchor QSF that satisfied the frame bit budget and a lower anchor QSF that did not satisfy the frame bit budget, as described above. In some such examples, the estimated frame QSF is a fractional value. In some such examples, the DDA 255 of the video encoder circuitry 100 converts the fractional frame QSF to an integer frame QSF. For example, the DDA 255 can round the fractional frame QSF down or up to the next integer frame QSF. In some examples, the DDA 255 rounds the fractional frame QSF down to the next lower integer QSF for some macroblocks of the frame and rounds the fractional frame QSF up to the next higher integer QSF for other macroblocks of the frame provided that the total frame bit budget is satisfied.

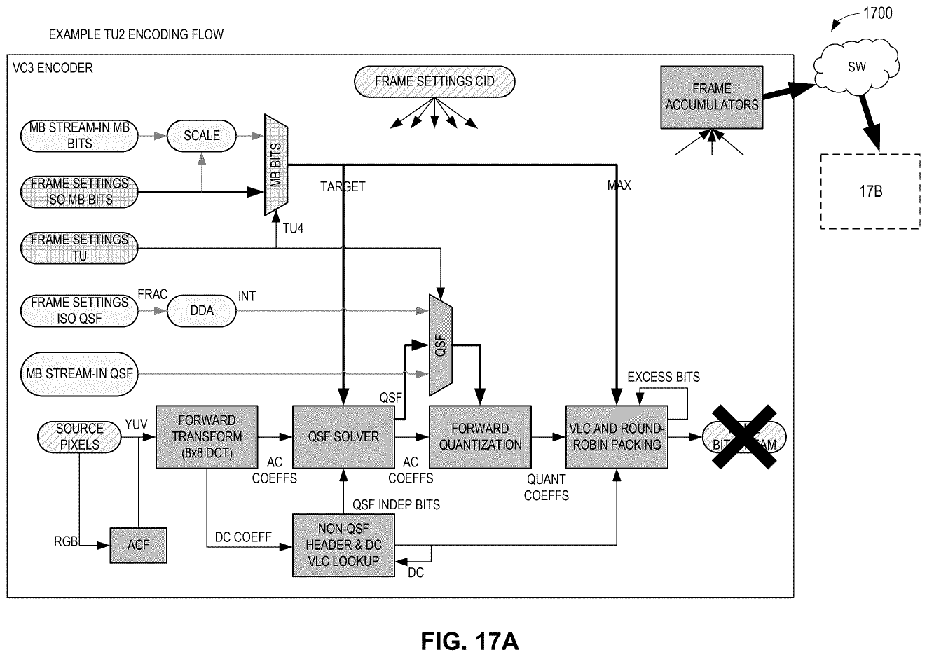

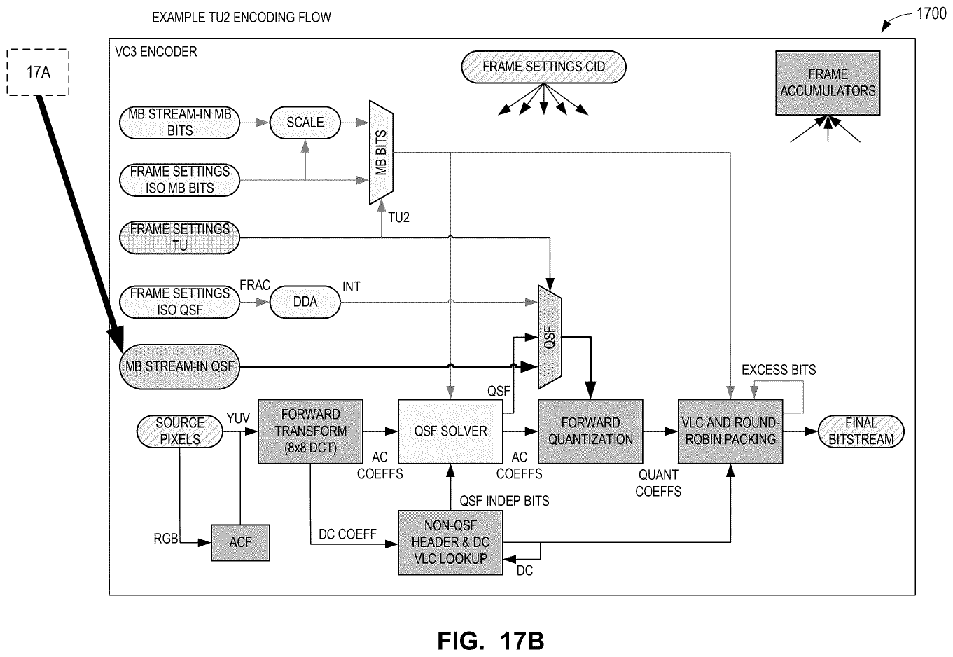

FIGS. 17A-17B illustrate an example TU2 encoding flow 1700 implemented using the example configurations depicted in FIGS. 4 and 6 for the example video encoder circuitry 100 of FIG. 2. In the example TU2 encoding flow, the encoder driver 102 performs quilting to assign a lower QSF for macroblocks that have higher RDO and assign a higher QSF for the other macroblocks. The number of macroblocks that can be promoted to the lower QSF is found by sorting and promoting the best RDO candidates until all available bits are exhausted. In some examples, objective quality is improved over TU3.

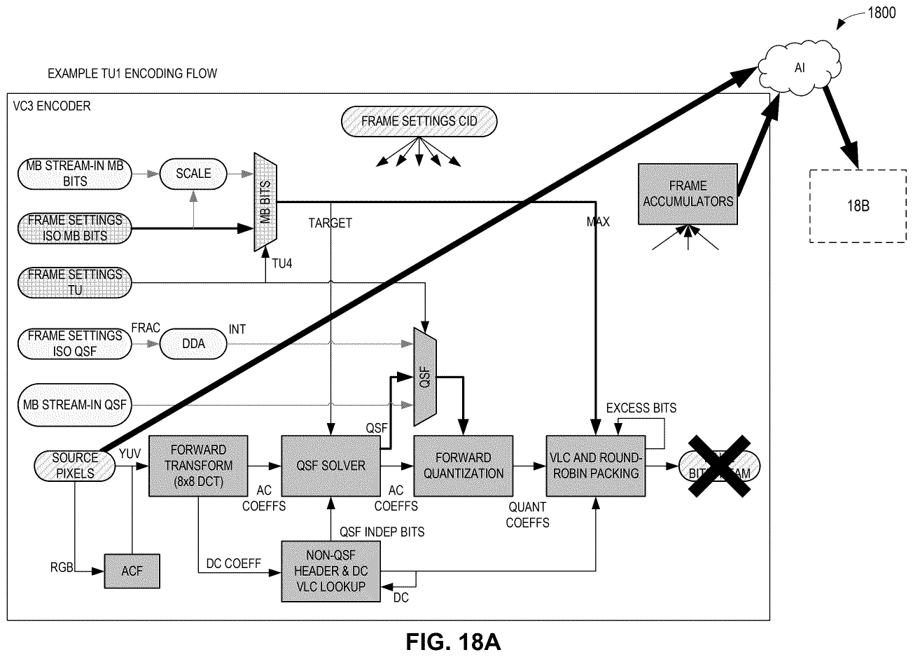

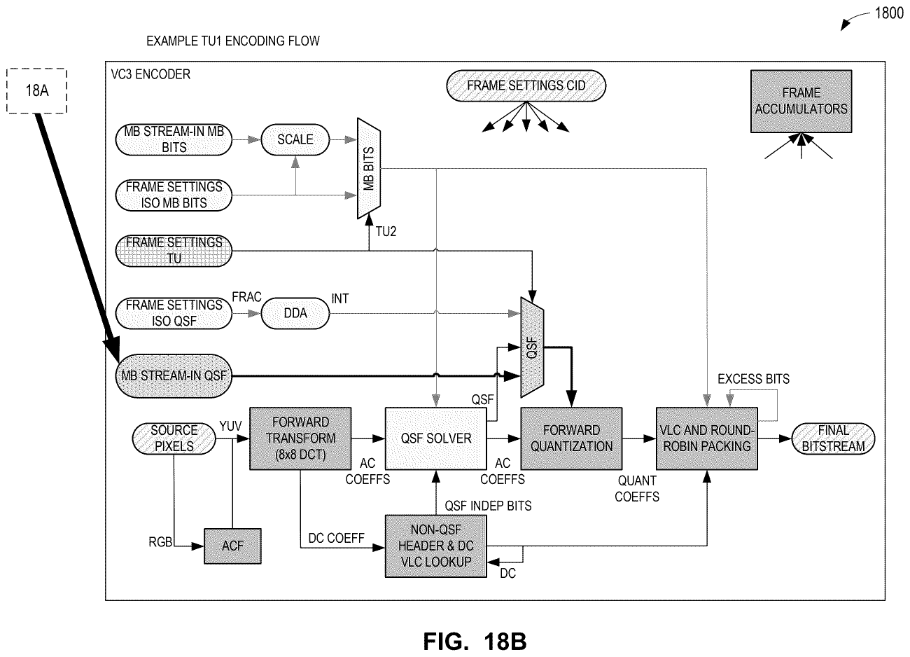

FIGS. 18A-18B illustrates an example TU1 encoding flow implemented using the example configurations depicted in FIGS. 4 and 6 for the example video encoder circuitry 100 of FIG. 2. In some examples, the TU1 encoding flow corresponds to an AI optimized quality mode. In the example TU1 encoding flow, the interfaces used by the TU2 encoding flow can be combined with other pixel analytics and/or pre-processing to achieve improved quality relative to TU2, but with a potential decrease in performance.

As described above, FIG. 3 illustrates example control settings 300 that can be used to configure the example video encoder circuitry 100 of FIG. 2 to support different example TU encoding modes. The examples of FIGS. 15A-B, 16A-B, 17A-B and 18A-B illustrated example configurations of the video encoder circuitry 100 that respectively support TU modes TU4, TU3, TU2 and TU1, as disclosed herein. FIG. 3 also illustrates two other alternative TU modes that can be configured based on example bspec fields size_control_config 305 and qsf_control_config 310. The first alternative TU mode depicted in FIG. 3 is referred to herein as an alternative TU4 mode, and the second alternate TU mode depicted in FIG. 3 is referred to herein as an alternate TU2/TU1 mode.

For example, when the TU mode frame setting 235 is set to the alternate TU4 mode, the size_control_config field 305 is set to a value of 1, which causes the MB bits multiplexer 240 to connect the MB bits stream setting 220 to the target number of macroblock bits input of the bit coding circuitry 130, and the qsf_control_config field 310 is set to a value of 0, which causes the target QSF output from the QSF solver circuitry 120 to be connected to the target QSF input of the forward quantization circuitry 125. In this alternate TU4 mode, the encoder driver 102 is able to configure the video encoder circuitry 100 to perform a one iteration encoding procedure with respective (e.g., different) target macroblock bit budgets for different macroblocks of the input frame 105 (e.g., rather than a same bit budget for all macroblocks as in TU4), and the QSF solver circuitry 120 uses those respective macroblock bit budgets to derive the corresponding QSFs to be used to quantize the respective macroblocks.

As another example, when the TU mode frame setting 235 is set to the alternate TU2/TU1 mode, the size_control_config field 305 is set to a value of 1, which causes the MB bits multiplexer 240 to connect the MB bits stream setting 220 to the target number of macroblock bits input of the bit coding circuitry 130, and the qsf_control_config field 310 is set to a value of 2, which causes the MB QSF stream setting 230 to be connected to the target QSF input of the forward quantization circuitry 125. In this alternate TU2/TU1 mode, the encoder driver 102 is able to configure the video encoder circuitry 100 to perform two iteration encoding procedure similar to TU2 mode or TU1 mode, but with respective (e.g., different) target macroblock bit budgets specified for different macroblocks of the input frame 105 (e.g., rather than a macroblock bit budgets being ignored as in TU2 mode and TU1 mode.)

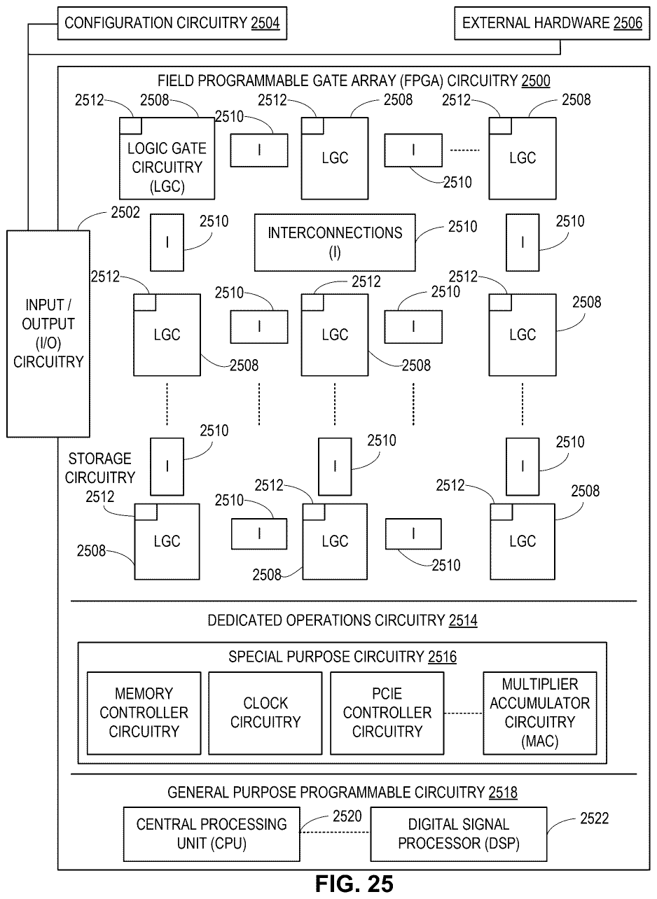

In some examples, the video encoding system 104 described above includes means for encoding video. For example, the means for encoding video may be implemented by the video encoder circuitry 100. In some examples, the video encoder circuitry 100 may be instantiated by hardware logic circuitry, which may be implemented by an ASIC, XPU, or the FPGA circuitry 2500 of FIG. 25 configured and/or structured to perform operations as described above in connection with FIGS. 1-18. Additionally or alternatively, the video encoder circuitry 100 may be instantiated by any other combination of hardware, software, and/or firmware. For example, the video encoder circuitry 100 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to perform some or all of the operations as described above in connection with FIGS. 1-18, but other structures are likewise appropriate.

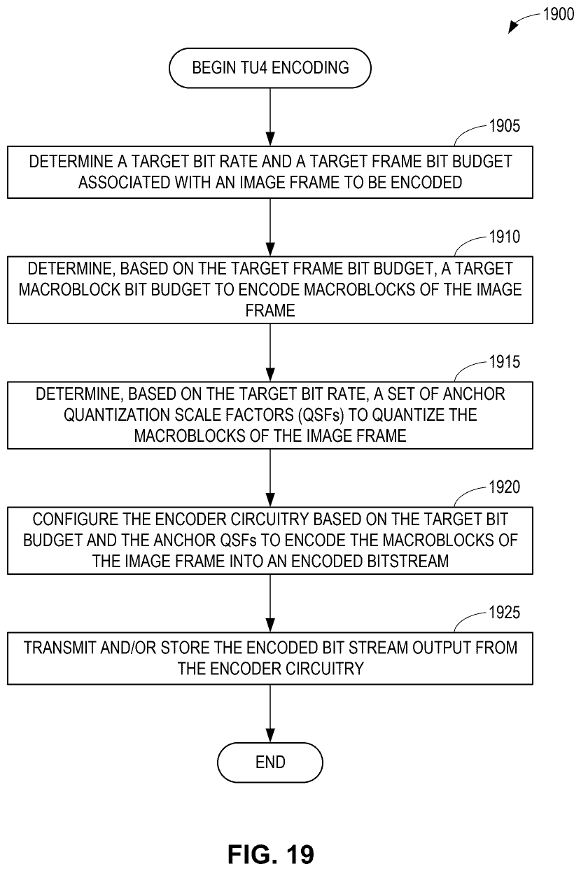

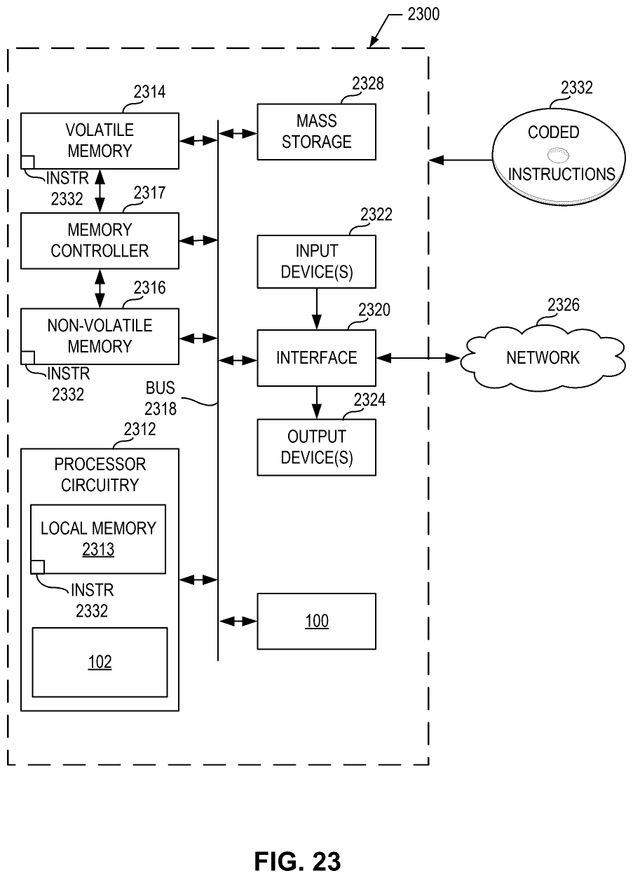

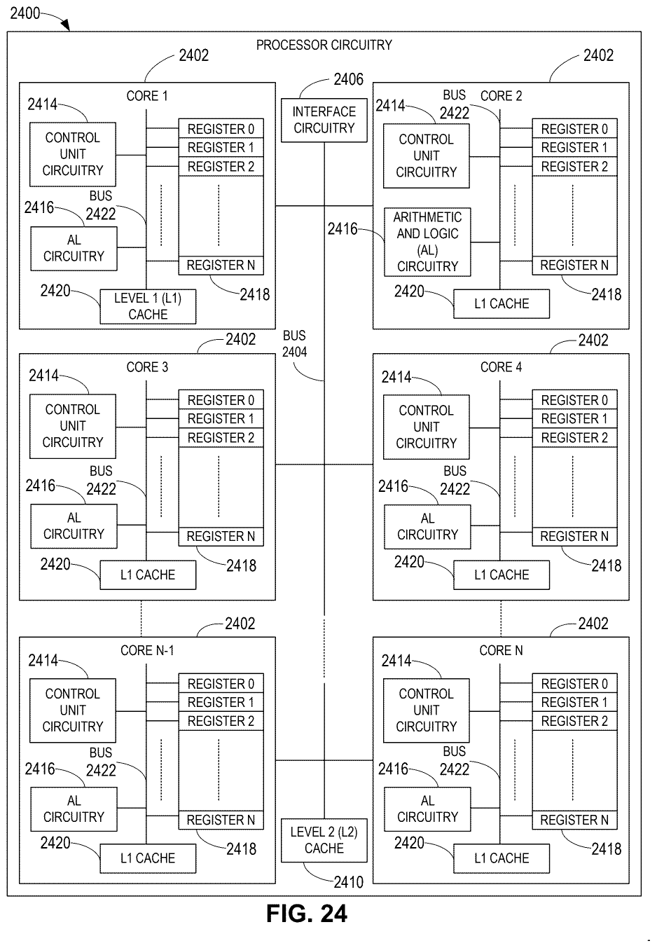

In some examples, the video encoding system 104 described above includes means for configuring video encoder circuitry. For example, the means for configuring video encoder circuitry may be implemented by the encoder driver 102. In some examples, the encoder driver 102 may be instantiated by programmable circuitry such as the example programmable circuitry 2312 of FIG. 23. For instance, the encoder driver 102 may be instantiated by the example microprocessor 2400 of FIG. 24 executing machine executable instructions such as those implemented by at least FIGS. 19-22. In some examples, the encoder driver 102 may be instantiated by hardware logic circuitry, which may be implemented by an ASIC, XPU, or the FPGA circuitry 2500 of FIG. 25 configured and/or structured to perform operations corresponding to the machine-readable instructions. Additionally or alternatively, the encoder driver 102 may be instantiated by any other combination of hardware, software, and/or firmware. For example, the encoder driver 102 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the video encoder circuitry 100 is illustrated in FIGS. 1 and/or 2, one or more of the elements, processes, and/or devices illustrated in FIGS. 1 and/or 2 may be combined, divided, re-arranged, omitted, eliminated, and/or implemented in any other way. Further, the example encoder driver 102, the example forward transform circuitry 115, the example QSF solver circuitry 120, the example forward quantization circuitry 125, the example bit coding circuitry 130, the example non-quantizable data encoder circuitry 135, the example color space conversion circuitry 140, the example control circuitry 205, the example MB bits multiplexer 240, the example QSF multiplexer 245, the example dda 255, the example scale circuit 260 and/or, more generally, the example video encoder circuitry 100 of FIGS. 1 and/or 2, may be implemented by hardware alone or by hardware in combination with software and/or firmware. Thus, for example, any of the example encoder driver 102, the example forward transform circuitry 115, the example QSF solver circuitry 120, the example forward quantization circuitry 125, the example bit coding circuitry 130, the example non-quantizable data encoder circuitry 135, the example color space conversion circuitry 140, the example control circuitry 205, the example MB bits multiplexer 240, the example QSF multiplexer 245, the example dda 255, the example scale circuit 260, and/or, more generally, the example video encoder circuitry 100, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example video encoder circuitry 100 of FIGS. 1 and/or 2 may include one or more elements, processes, and/or devices in addition to, or instead of, those illustrated in FIGS. 1 and/or 2, and/or may include more than one of any or all of the illustrated elements, processes and devices.

Flowchart(s) representative of example machine-readable instructions, which may be executed by programmable circuitry to implement and/or instantiate the video encoder circuitry 100 of FIGS. 1 and/or 2 and/or representative of example operations which may be performed by programmable circuitry to implement and/or instantiate the video encoder circuitry 100 of FIGS. 1 and/or 2, are shown in FIGS. 19-22. The machine-readable instructions may be one or more executable programs or portion(s) of one or more executable programs for execution by programmable circuitry such as the programmable circuitry 2312 shown in the example processor platform 2300 discussed below in connection with FIG. 23 and/or may be one or more function(s) or portion(s) of functions to be performed by the example programmable circuitry (e.g., an FPGA) discussed below in connection with FIGS. 24 and/or 25. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 19-22, many other methods of implementing the example video encoder circuitry 100 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 19-22 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 19 is a flowchart representative of example machine-readable instructions and/or example operations 1900 that may be executed, instantiated, and/or performed by programmable circuitry implementing the encoder driver 102 to configure the video encoder circuitry 100 of FIGS. 1 and/or 2 in an example TU4 encoding mode. The example machine-readable instructions and/or the example operations 1900 of FIG. 19 begin at block 1905, at which the encoder driver 102 determines a target bit rate and a target frame bit budget associated with the input image frame 105 to be encoded, as described above. For example, the encoder driver 102 determines the target bit rate and the target frame bit budget based on a CID specified for the input image frame 105. At block 1905, the encoder driver 102 determines, based on the target frame bit budget, a target macroblock bit budget to encode macroblocks of the input image frame 105, as described above. For example, the encoder driver 102 may divide the target frame bit budget (e.g., after subtracting a number of frame-level header bits that are separate from the macroblock data from the target frame bit budget) by the number of macroblocks in the input image frame 105 to determine the target macroblock bit budget for the input image frame 105, as described above.

At block 1915, the encoder driver 102 determine, based on the target bit rate and/or the CID, a set of anchor QSFs to quantize the macroblocks of the input image frame 105, as described above. At block 1920, the encoder driver 102 configures, as described above, the video encoder circuitry 100 based on the target bit budget and the anchor QSFs to encode the macroblocks of the input image frame 105 into the output encoded bitstream 110. For example, the encoder driver 102 may configure the video encoder circuitry 100 according to the examples of FIGS. 4 and/or 15 described above. At block 1925, the encoder driver 102 causes the output encoded bitstream 110 from the video encoder circuitry 100 to be transmitted to one or more recipient devices and/or stored in one or more memories, storage devices, etc. The example machine-readable instructions and/or the example operations 1900 then end.

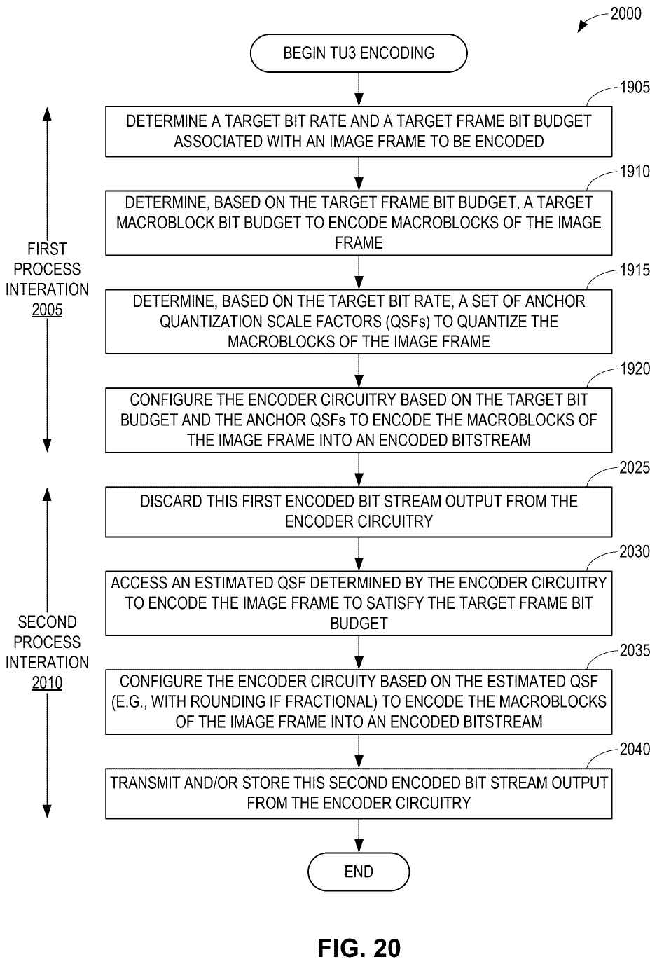

FIG. 20 is a flowchart representative of example machine-readable instructions and/or example operations 2000 that may be executed, instantiated, and/or performed by programmable circuitry implementing the encoder driver 102 to configure the video encoder circuitry 100 of FIGS. 1 and/or 2 in an example TU3 encoding mode. The example machine-readable instructions and/or the example operations 2000 of FIG. 20 begin with the encoder driver 102 configuring the video encoder circuitry 100 to perform an example first process iteration 2005 based on the operations of blocks 1905-1920 described above in connection with FIG. 19.

Next, the encoder driver 102 configures the video encoder circuitry 100 to perform an example second process iteration 2010 beginning at block 2025. At block 2025, the encoder driver 102 discards the first encoded bitstream output from the encoder circuitry during the first process iteration 2005, as shown above in connection with the example of FIG. 16. At block 2030, the encoder driver 102 accesses an estimated QSF determined by the video encoder circuitry 100 in the first process iteration 2005 to encode the image frame to satisfy the target frame bit budget, as described above. At block 2035, the encoder driver 102 configures, as described above, the video encoder circuitry 100 based on the estimated frame QSF to encode the macroblocks of the input image frame 105 into the output encoded bitstream 110. For example, the encoder driver 102 may configure the video encoder circuitry 100 according to the examples of FIGS. 5 and/or 16 described above. In some examples, the estimated frame QSF is a fractional QSF that will be rounded up or down to an integer frame QSF by the DDA circuitry 255 of the video encoder circuitry 100, as described above. At block 2040, the encoder driver 102 causes the output encoded bitstream 110 from the video encoder circuitry 100 to be transmitted to one or more recipient devices and/or stored in one or more memories, storage devices, etc. The example machine-readable instructions and/or the example operations 2000 then end.

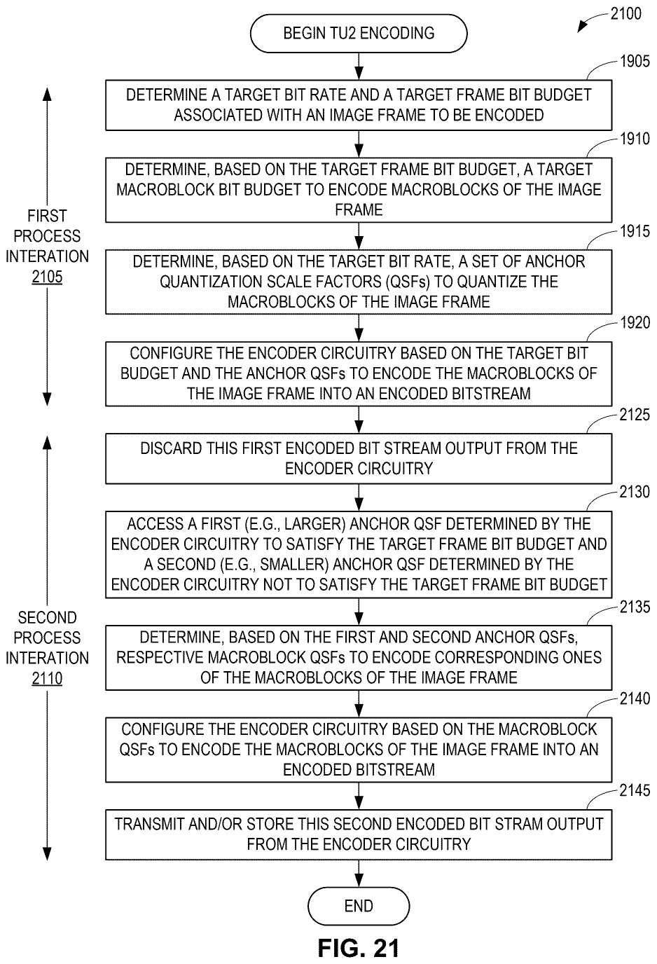

FIG. 21 is a flowchart representative of example machine-readable instructions and/or example operations 2100 that may be executed, instantiated, and/or performed by programmable circuitry implementing the encoder driver 102 to configure the video encoder circuitry 100 of FIGS. 1 and/or 2 in an example TU2 encoding mode. The example machine-readable instructions and/or the example operations 2100 of FIG. 21 begin with the encoder driver 102 configuring the video encoder circuitry 100 to perform an example first process iteration 2105 based on the operations of blocks 1905-1920 described above in connection with FIG. 19.

Next, the encoder driver 102 configures the video encoder circuitry 100 to perform an example second process iteration 2110 beginning at block 2125. At block 2125, the encoder driver 102 discards the first encoded bitstream output from the encoder circuitry during the first process iteration 2105, as shown above in connection with the example of FIG. 17. At block 2130, the encoder driver 102 accesses a first (e.g., larger) anchor QSF determined by the video encoder circuitry 100 in the first process iteration 2105 to satisfy the target frame bit budget, and accesses a second (e.g., smaller) anchor QSF determined by the video encoder circuitry 100 in the first process iteration 2105 not to satisfy the target frame bit budget, as described above. At block 2135, the encoder driver 102 determines, based on the first and second anchor QSFs, respective macroblock QSFs to encode corresponding ones of the macroblocks of the input image frame 105, as described above. For example, the encoder driver 102 can promote a given macroblock to the second anchor QSF or demote the given macroblock to the first anchor QSF based on an RDO sort, as described above.

At block 2140, the encoder driver 102 configures, as described above, the video encoder circuitry 100 based on the macroblock QSFs selected for the different macroblocks to encode the macroblocks of the input image frame 105 into the output encoded bitstream 110. For example, the encoder driver 102 may configure the video encoder circuitry 100 according to the examples of FIGS. 6 and/or 17 described above. At block 2140, the encoder driver 102 causes the output encoded bitstream 110 from the video encoder circuitry 100 to be transmitted to one or more recipient devices and/or stored in one or more memories, storage devices, etc. The example machine-readable instructions and/or the example operations 2100 then end.

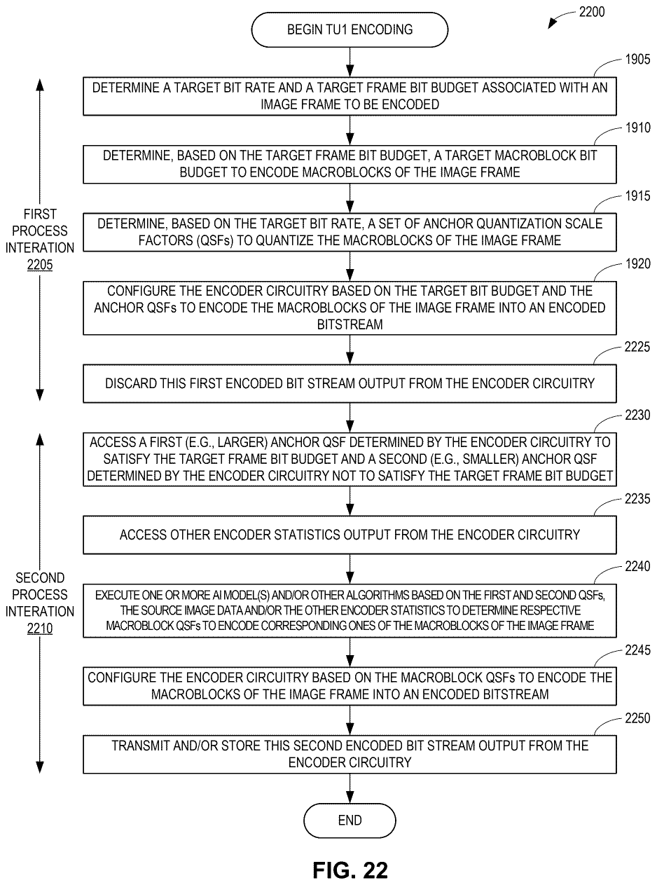

FIG. 22 is a flowchart representative of example machine-readable instructions and/or example operations 2200 that may be executed, instantiated, and/or performed by programmable circuitry implementing the encoder driver 102 to configure the video encoder circuitry 100 of FIGS. 1 and/or 2 in an example TU1 encoding mode. The example machine-readable instructions and/or the example operations 2000 of FIG. 20 begin with the encoder driver 102 configuring the video encoder circuitry 100 to perform an example first process iteration 2205 based on the operations of blocks 1905-1920 described above in connection with FIG. 19.

Next, the encoder driver 102 configures the video encoder circuitry 100 to perform an example second process iteration 2210 beginning at block 2225. At block 2225, the encoder driver 102 discards the first encoded bitstream output from the encoder circuitry during the first process iteration 2205, as shown above in connection with the example of FIG. 18. At block 2230, the encoder driver 102 accesses a first (e.g., larger) anchor QSF determined by the video encoder circuitry 100 in the first process iteration 2105 to satisfy the target frame bit budget, and accesses a second (e.g., smaller) anchor QSF determined by the video encoder circuitry 100 in the first process iteration 2105 not to satisfy the target frame bit budget, as described above. At block 2235, the encoder driver 102 accesses other encoder statistics output from the video encoder circuitry 100 during the first process iteration 2205, as described above. At block 2240, the encoder driver 102 executes one or more AI model(s) and/or other algorithm(s) based on the first and second anchor QSFs, the source image data 105 and/or the other encoder statistics to determine respective macroblock QSFs to encode corresponding ones of the macroblocks of the input image frame 105, as described above. For example, the other algorithm can be one or more of a region-of-interest (ROI) algorithm, a saliency algorithm, a just noticeable difference (JND) algorithm, etc., or any other algorithm(s) which may or may not involve AI, or any combination of such algorithms.

At block 2245, the encoder driver 102 configures, as described above, the video encoder circuitry 100 based on the macroblock QSFs determined for the different macroblocks to encode the macroblocks of the input image frame 105 into the output encoded bitstream 110. For example, the encoder driver 102 may configure the video encoder circuitry 100 according to the examples of FIGS. 6 and/or 18 described above. At block 2250, the encoder driver 102 causes the output encoded bitstream 110 from the video encoder circuitry 100 to be transmitted to one or more recipient devices and/or stored in one or more memories, storage devices, etc. The example machine-readable instructions and/or the example operations 2200 then end.

FIG. 23 is a block diagram of an example programmable circuitry platform 2300 structured to execute and/or instantiate the example machine-readable instructions and/or the example operations of FIGS. 19-22 to implement the video encoder circuitry 100 and the encoder driver 102 of FIGS. 1 and/or 2. The programmable circuitry platform 2300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 2300 of the illustrated example includes programmable circuitry 2312. The programmable circuitry 2312 of the illustrated example is hardware. For example, the programmable circuitry 2312 can be implemented by one or more integrated circuits, logic circuits, FPGAs, microprocessors, CPUs, GPUs, VPUs, DSPS, and/or microcontrollers from any desired family or manufacturer. The programmable circuitry 2312 may be implemented by one or more semiconductor based (e.g., silicon based) devices. In this example, the programmable circuitry 2312 implements the encoder driver 102.

The programmable circuitry 2312 of the illustrated example includes a local memory 2313 (e.g., a cache, registers, etc.). The programmable circuitry 2312 of the illustrated example is in communication with main memory 2314, 2316, which includes a volatile memory 2314 and a non-volatile memory 2316, by a bus 2318. The volatile memory 2314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 2316 may be implemented by flash memory and/or any other desired type of memory device. Access to the main memory 2314, 2316 of the illustrated example is controlled by a memory controller 2317. In some examples, the memory controller 2317 may be implemented by one or more integrated circuits, logic circuits, microcontrollers from any desired family or manufacturer, or any other type of circuitry to manage the flow of data going to and from the main memory 2314, 2316.

The programmable circuitry platform 2300 of the illustrated example also includes interface circuitry 2320. The interface circuitry 2320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 2322 are connected to the interface circuitry 2320. The input device(s) 2322 permit(s) a user (e.g., a human user, a machine user, etc.) to enter data and/or commands into the programmable circuitry 2312. The input device(s) 2322 can be implemented by, for example, an audio sensor, a microphone, a camera (still or video), a keyboard, a button, a mouse, a touchscreen, a trackpad, a trackball, an isopoint device, and/or a voice recognition system.

One or more output devices 2324 are also connected to the interface circuitry 2320 of the illustrated example. The output device(s) 2324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 2320 of the illustrated example, thus, typically includes a graphics driver card, a graphics driver chip, and/or graphics processor circuitry such as a GPU.

The interface circuitry 2320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 2326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 2300 of the illustrated example also includes one or more mass storage discs or devices 2328 to store firmware, software, and/or data. Examples of such mass storage discs or devices 2328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 2332, which may be implemented by the machine-readable instructions of FIGS. 19-22, may be stored in the mass storage device 2328, in the volatile memory 2314, in the non-volatile memory 2316, and/or on at least one non-transitory computer-readable storage medium such as a CD or DVD which may be removable.

FIG. 24 is a block diagram of an example implementation of the programmable circuitry 2312 of FIG. 23. In this example, the programmable circuitry 2312 of FIG. 23 is implemented by a microprocessor 2400. For example, the microprocessor 2400 may be a general-purpose microprocessor (e.g., general-purpose microprocessor circuitry). The microprocessor 2400 executes some or all of the machine-readable instructions of the flowcharts of FIGS. 19-22 to effectively instantiate the circuitry of FIGS. 1 and/or 2 as logic circuits to perform operations corresponding to those machine-readable instructions. In some such examples, the circuitry of FIGS. 1 and/or 2 is instantiated by the hardware circuits of the microprocessor 2400 in combination with the machine-readable instructions. For example, the microprocessor 2400 may be implemented by multi-core hardware circuitry such as a CPU, a DSP, a GPU, an XPU, etc. Although it may include any number of example cores 2402 (e.g., 1 core), the microprocessor 2400 of this example is a multi-core semiconductor device including N cores. The cores 2402 of the microprocessor 2400 may operate independently or may cooperate to execute machine-readable instructions. For example, machine code corresponding to a firmware program, an embedded software program, or a software program may be executed by one of the cores 2402 or may be executed by multiple ones of the cores 2402 at the same or different times. In some examples, the machine code corresponding to the firmware program, the embedded software program, or the software program is split into threads and executed in parallel by two or more of the cores 2402. The software program may correspond to a portion or all of the machine-readable instructions and/or operations represented by the flowcharts of FIGS. 19-22.

The cores 2402 may communicate by a first example bus 2404. In some examples, the first bus 2404 may be implemented by a communication bus to effectuate communication associated with one(s) of the cores 2402. For example, the first bus 2404 may be implemented by at least one of an Inter-Integrated Circuit (I2C) bus, a Serial Peripheral Interface (SPI) bus, a PCI bus, or a PCIe bus. Additionally or alternatively, the first bus 2404 may be implemented by any other type of computing or electrical bus. The cores 2402 may obtain data, instructions, and/or signals from one or more external devices by example interface circuitry 2406. The cores 2402 may output data, instructions, and/or signals to the one or more external devices by the interface circuitry 2406. Although the cores 2402 of this example include example local memory 2420 (e.g., Level 1 (L1) cache that may be split into an L1 data cache and an L1 instruction cache), the microprocessor 2400 also includes example shared memory 2410 that may be shared by the cores (e.g., Level 2 (L2 cache)) for high-speed access to data and/or instructions. Data and/or instructions may be transferred (e.g., shared) by writing to and/or reading from the shared memory 2410. The local memory 2420 of each of the cores 2402 and the shared memory 2410 may be part of a hierarchy of storage devices including multiple levels of cache memory and the main memory (e.g., the main memory 2314, 2316 of FIG. 23). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 2402 may be referred to as a CPU, DSP, GPU, etc., or any other type of hardware circuitry. Each core 2402 includes control unit circuitry 2414, arithmetic and logic (AL) circuitry (sometimes referred to as an ALU) 2416, a plurality of registers 2418, the local memory 2420, and a second example bus 2422. Other structures may be present. For example, each core 2402 may include vector unit circuitry, single instruction multiple data (SIMD) unit circuitry, load/store unit (LSU) circuitry, branch/jump unit circuitry, floating-point unit (FPU) circuitry, etc. The control unit circuitry 2414 includes semiconductor-based circuits structured to control (e.g., coordinate) data movement within the corresponding core 2402. The AL circuitry 2416 includes semiconductor-based circuits structured to perform one or more mathematic and/or logic operations on the data within the corresponding core 2402. The AL circuitry 2416 of some examples performs integer based operations. In other examples, the AL circuitry 2416 also performs floating-point operations. In yet other examples, the AL circuitry 2416 may include first AL circuitry that performs integer-based operations and second AL circuitry that performs floating-point operations. In some examples, the AL circuitry 2416 may be referred to as an Arithmetic Logic Unit (ALU).

The registers 2418 are semiconductor-based structures to store data and/or instructions such as results of one or more of the operations performed by the AL circuitry 2416 of the corresponding core 2402. For example, the registers 2418 may include vector register(s), SIMD register(s), general-purpose register(s), flag register(s), segment register(s), machine-specific register(s), instruction pointer register(s), control register(s), debug register(s), memory management register(s), machine check register(s), etc. The registers 2418 may be arranged in a bank as shown in FIG. 24. Alternatively, the registers 2418 may be organized in any other arrangement, format, or structure, such as by being distributed throughout the core 2402 to shorten access time. The second bus 2422 may be implemented by at least one of an I2C bus, a SPI bus, a PCI bus, or a PCIe bus.

Each core 2402 and/or, more generally, the microprocessor 2400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 2400 is a semiconductor device fabricated to include many transistors interconnected to implement the structures described above in one or more integrated circuits (ICs) contained in one or more packages.

The microprocessor 2400 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 2400, in the same chip package as the microprocessor 2400 and/or in one or more separate packages from the microprocessor 2400.

FIG. 25 is a block diagram of another example implementation of the programmable circuitry 2312 of FIG. 23. In this example, the programmable circuitry 2312 is implemented by FPGA circuitry 2500. For example, the FPGA circuitry 2500 may be implemented by an FPGA. The FPGA circuitry 2500 can be used, for example, to perform operations that could otherwise be performed by the example microprocessor 2400 of FIG. 24 executing corresponding machine-readable instructions. However, once configured, the FPGA circuitry 2500 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 2400 of FIG. 24 described above (which is a general purpose device that may be programmed to execute some or all of the machine-readable instructions represented by the flowchart(s) of FIGS. 19-22 but whose interconnections and logic circuitry are fixed once fabricated), the FPGA circuitry 2500 of the example of FIG. 25 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 19-22. In particular, the FPGA circuitry 2500 may be thought of as an array of logic gates, interconnections, and switches. The switches can be programmed to change how the logic gates are interconnected by the interconnections, effectively forming one or more dedicated logic circuits (unless and until the FPGA circuitry 2500 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 19-22. As such, the FPGA circuitry 2500 may be configured and/or structured to effectively instantiate some or all of the operations/functions corresponding to the machine-readable instructions of the flowchart(s) of FIGS. 19-22 as dedicated logic circuits to perform the operations/functions corresponding to those software instructions in a dedicated manner analogous to an ASIC. Therefore, the FPGA circuitry 2500 may perform the operations/functions corresponding to the some or all of the machine-readable instructions of FIGS. 19-22 faster than the general-purpose microprocessor can execute the same.

In the example of FIG. 25, the FPGA circuitry 2500 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 2500 of FIG. 25 may access and/or load the binary file to cause the FPGA circuitry 2500 of FIG. 25 to be configured and/or structured to perform the one or more operations/functions. For example, the binary file may be implemented by a bitstream (e.g., one or more computer-readable bits, one or more machine-readable bits, etc.), data (e.g., computer-readable data, machine-readable data, etc.), and/or machine-readable instructions accessible to the FPGA circuitry 2500 of FIG. 25 to cause configuration and/or structuring of the FPGA circuitry 2500 of FIG. 25, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 2500 of FIG. 25 may access and/or load the binary file to cause the FPGA circuitry 2500 of FIG. 25 to be configured and/or structured to perform the one or more operations/functions. For example, the binary file may be implemented by a bitstream (e.g., one or more computer-readable bits, one or more machine-readable bits, etc.), data (e.g., computer-readable data, machine-readable data, etc.), and/or machine-readable instructions accessible to the FPGA circuitry 2500 of FIG. 25 to cause configuration and/or structuring of the FPGA circuitry 2500 of FIG. 25, or portion(s) thereof.

The FPGA circuitry 2500 of FIG. 25, includes example input/output (I/O) circuitry 2502 to obtain and/or output data to/from example configuration circuitry 2504 and/or external hardware 2506. For example, the configuration circuitry 2504 may be implemented by interface circuitry that may obtain a binary file, which may be implemented by a bitstream, data, and/or machine-readable instructions, to configure the FPGA circuitry 2500, or portion(s) thereof. In some such examples, the configuration circuitry 2504 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 2506 may be implemented by external hardware circuitry. For example, the external hardware 2506 may be implemented by the microprocessor 2400 of FIG. 24.

The FPGA circuitry 2500 also includes an array of example logic gate circuitry 2508, a plurality of example configurable interconnections 2510, and example storage circuitry 2512. The logic gate circuitry 2508 and the configurable interconnections 2510 are configurable to instantiate one or more operations/functions that may correspond to at least some of the machine-readable instructions of FIGS. 19-22 and/or other desired operations. The logic gate circuitry 2508 shown in FIG. 25 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 2508 to enable configuration of the electrical structures and/or the logic gates to form circuits to perform desired operations/functions. The logic gate circuitry 2508 may include other electrical structures such as look-up tables (LUTs), registers (e.g., flip-flops or latches), multiplexers, etc.

The configurable interconnections 2510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 2508 to program desired logic circuits.

The storage circuitry 2512 of the illustrated example is structured to store result(s) of the one or more of the operations performed by corresponding logic gates. The storage circuitry 2512 may be implemented by registers or the like. In the illustrated example, the storage circuitry 2512 is distributed amongst the logic gate circuitry 2508 to facilitate access and increase execution speed.

The example FPGA circuitry 2500 of FIG. 25 also includes example dedicated operations circuitry 2514. In this example, the dedicated operations circuitry 2514 includes special purpose circuitry 2516 that may be invoked to implement commonly used functions to avoid the need to program those functions in the field. Examples of such special purpose circuitry 2516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 2500 may also include example general purpose programmable circuitry 2518 such as an example CPU 2520 and/or an example DSP 2522. Other general purpose programmable circuitry 2518 may additionally or alternatively be present such as a GPU, an XPU, etc., that can be programmed to perform other operations.

Although FIGS. 24 and 25 illustrate two example implementations of the programmable circuitry 2312 of FIG. 23, many other approaches are contemplated. For example, FPGA circuitry may include an on-board CPU, such as one or more of the example CPU 2520 of FIG. 24. Therefore, the programmable circuitry 2312 of FIG. 23 may additionally be implemented by combining at least the example microprocessor 2400 of FIG. 24 and the example FPGA circuitry 2500 of FIG. 25. In some such hybrid examples, one or more cores 2402 of FIG. 24 may execute a first portion of the machine-readable instructions represented by the flowchart(s) of FIGS. 19-22 to perform first operation(s)/function(s), the FPGA circuitry 2500 of FIG. 25 may be configured and/or structured to perform second operation(s)/function(s) corresponding to a second portion of the machine-readable instructions represented by the flowcharts of FIG. 19-22, and/or an ASIC may be configured and/or structured to perform third operation(s)/function(s) corresponding to a third portion of the machine-readable instructions represented by the flowcharts of FIGS. 19-22.

It should be understood that some or all of the circuitry of FIGS. 1 and/or 2 may, thus, be instantiated at the same or different times. For example, same and/or different portion(s) of the microprocessor 2400 of FIG. 24 may be programmed to execute portion(s) of machine-readable instructions at the same and/or different times. In some examples, same and/or different portion(s) of the FPGA circuitry 2500 of FIG. 25 may be configured and/or structured to perform operations/functions corresponding to portion(s) of machine-readable instructions at the same and/or different times.

In some examples, some or all of the circuitry of FIGS. 1 and/or 2 may be instantiated, for example, in one or more threads executing concurrently and/or in series. For example, the microprocessor 2400 of FIG. 24 may execute machine-readable instructions in one or more threads executing concurrently and/or in series. In some examples, the FPGA circuitry 2500 of FIG. 25 may be configured and/or structured to carry out operations/functions concurrently and/or in series. Moreover, in some examples, some or all of the circuitry of FIGS. 1 and/or 2 may be implemented within one or more virtual machines and/or containers executing on the microprocessor 2400 of FIG. 24.

In some examples, the programmable circuitry 2312 of FIG. 23 may be in one or more packages. For example, the microprocessor 2400 of FIG. 24 and/or the FPGA circuitry 2500 of FIG. 25 may be in one or more packages. In some examples, an XPU may be implemented by the programmable circuitry 2312 of FIG. 23, which may be in one or more packages. For example, the XPU may include a CPU (e.g., the microprocessor 2400 of FIG. 24, the CPU 2520 of FIG. 25, etc.) in one package, a DSP (e.g., the DSP 2522 of FIG. 25) in another package, a GPU in yet another package, and an FPGA (e.g., the FPGA circuitry 2500 of FIG. 25) in still yet another package.

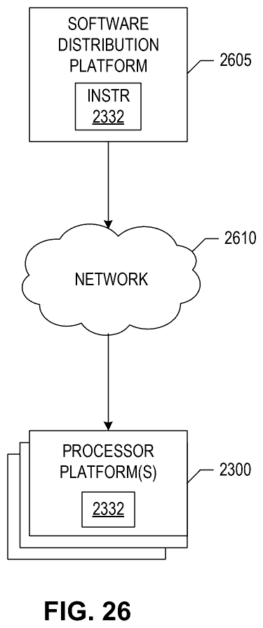

A block diagram illustrating an example software distribution platform 2605 to distribute software such as the example machine-readable instructions 2332 of FIG. 23 to other hardware devices (e.g., hardware devices owned and/or operated by third parties from the owner and/or operator of the software distribution platform) is illustrated in FIG. 26. The example software distribution platform 2605 may be implemented by any computer server, data facility, cloud service, etc., capable of storing and transmitting software to other computing devices. The third parties may be customers of the entity owning and/or operating the software distribution platform 2605. For example, the entity that owns and/or operates the software distribution platform 2605 may be a developer, a seller, and/or a licensor of software such as the example machine-readable instructions 2332 of FIG. 23. The third parties may be consumers, users, retailers, OEMs, etc., who purchase and/or license the software for use and/or re-sale and/or sub-licensing. In the illustrated example, the software distribution platform 2605 includes one or more servers and one or more storage devices. The storage devices store the machine-readable instructions 2332, which may correspond to the example machine-readable instructions of FIGS. 19-22, as described above. The one or more servers of the example software distribution platform 2605 are in communication with an example network 2610, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 2332 from the software distribution platform 2605. For example, the software, which may correspond to the example machine-readable instructions of FIG. 19-22, may be downloaded to the example programmable circuitry platform 2300, which is to execute the machine-readable instructions 2332 to implement the video encoder circuitry 100. In some examples, one or more servers of the software distribution platform 2605 periodically offer, transmit, and/or force updates to the software (e.g., the example machine-readable instructions 2332 of FIG. 23) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed to implement hardware-accelerated intra frame coding. Disclosed systems, apparatus, articles of manufacture, and methods improve the efficiency of using a computing device by implementing an example hardware-based video encoder that encodes an intra video frame to approach but not exceed specified size limitations without a priori information concerning the video content. Some examples accomplish encoding in just one frame encoding iteration. Some example hardware-based video encoders disclosed herein are able to determine the QSF(s) to encode macroblocks of an input video frame based on an examination of a relatively small subset of anchor QSFs rather than by examining the full range of possible QSFs. Some example hardware-based video encoders disclosed herein are able to discard excess encoded bits to achieve a specified target frame size with minimal visual impact. Example hardware-based video encoder are disclosed that achieve high compression speeds will maintaining acceptable subjecting and objective video encoding quality. Disclosed systems, apparatus, articles of manufacture, and methods are accordingly directed to one or more improvement(s) in the operation of a machine such as a computer or other electronic and/or mechanical device.

Further examples and combinations thereof include the following. Example 1 includes an apparatus comprising encoder circuitry to quantize alternating current (AC) coefficients of a macroblock based on a plurality of anchor quantization scale factors (QSFs) to determine respective numbers of bits used to encode the AC coefficients of the macroblock based on the corresponding anchor QSFs, and interpolate between the respective numbers of bits associated with at least two of the anchor QSFs to determine an estimated QSF, the estimated QSF to satisfy a target bit budget associated with encoding the macroblock, machine-readable instructions, and at least one programmable circuit to be programmed based on the instructions to configure the encoder circuitry.

Example 2 includes the apparatus of example 1, wherein one or more of the at least one programmable circuit is to provide the plurality of anchor QSFs and the target bit budget to the encoder circuitry.

Example 3 includes the apparatus of example 2, wherein the target bit budget is a first target bit budget, and one or more of the at least one programmable circuit is to divide a second target bit budget associated with encoding a frame by a number of macroblocks in the frame to determine the first target bit budget.

Example 4 includes the apparatus of any of examples 1 to 3, wherein the encoder circuitry is to interpolate between the respective numbers of bits associated with the at least two of the anchor QSFs via a piecewise linear interpolation.

Example 5 includes the apparatus of example 4, wherein the encoder circuitry is to at least one of (i) apply a nonlinear transform to the at least two of the anchor QSFs to compute nonlinear values corresponding to the at least two of the anchor QSFs, or (ii) apply the nonlinear transform to the respective numbers of bits associated with the at least two of the anchor QSFs to compute nonlinear values corresponding to the respective numbers of bits, and perform the piecewise linear interpolation based on at least one of (i) the nonlinear values corresponding to the at least two of the anchor QSFs, or (ii) the nonlinear values corresponding to the respective numbers of bits.

Example 6 includes the apparatus of example 5, wherein the nonlinear transform is a logarithmic function.

Example 7 includes the apparatus of any of examples 1 to 6, wherein the encoder circuitry is to quantize the macroblock based on the estimated QSF.

Example 8 includes the apparatus of example 1, wherein the macroblock is a first macroblock of an image frame, the respective numbers of bits are respective first numbers of bits to encode the AC coefficients of the first macroblock based on the corresponding anchor QSFs, the estimated QSF is a first estimated QSF, and the encoder circuitry is to quantize AC coefficients of a second macroblock of the image frame based on the anchor QSFs to determine respective second numbers of bits to encode the AC coefficients of the second macroblock based on the corresponding anchor QSFs, and interpolate between the respective second numbers of bits associated with at least two of the anchor QSFs to determine a second estimated QSF to encode the second macroblock to satisfy the target bit budget.

Example 9 includes the apparatus of example 1, wherein the respective numbers of bits are respective first numbers of bits to encode the AC coefficients of the macroblock based on the corresponding anchor QSFs, the estimated QSF is a first estimated QSF, the target bit budget is a first target bit budget, and the encoder circuitry is to quantize AC coefficients of respective ones of a plurality of macroblocks of an image frame based on the anchor QSFs to determine respective second numbers of bits used to encode the image frame based on the corresponding anchor QSFs, interpolate between the respective second numbers of bits associated with a first one of the anchor QSFs and a second one of the anchor QSFs to determine a second estimated QSF to satisfy a second target bit budget associated with encoding the image frame, the first one of the anchor QSFs to satisfy the second target bit budget, the second one of the anchor QSFs not to satisfy the second target bit budget, and at least one of output or store the second estimated QSF.

Example 10 includes the apparatus of example 9, wherein one or more of the at least one programmable circuit is to configure the encoder circuitry with the plurality of anchor QSFs and the first target bit budget to cause the encoder circuitry to perform a first process iteration to determine and output the second estimated QSF, and configure the encoder circuitry with the second estimated QSF to cause the encoder circuitry to perform a second process iteration to encode the image frame based on the second estimated QSF.

Example 11 includes the apparatus of example 10, wherein the second estimated QSF is a fractional QSF, and the encoder circuitry is to convert the fractional QSF to an integer QSF to be used to quantize the AC coefficients of the macroblocks of the image frame.

Example 12 includes the apparatus of example 10, wherein the second estimated QSF is a fractional QSF, and the encoder circuitry is to round the fractional QSF up to a first integer QSF to be used to quantize the AC coefficients of a first group of the macroblocks of the image frame, and round the fractional QSF down to a second integer QSF to be used to quantize the AC coefficients of a second group of the macroblocks of the image frame.

Example 13 includes the apparatus of example 9 wherein the encoder circuitry is to output the first one of the anchor QSFs and the second one of the anchor QSFs, and one or more of the at least one programmable circuit is to configure the encoder circuitry with the plurality of anchor QSFs and the first target bit budget to cause the encoder circuitry to perform a first process iteration to determine and output the first one of the anchor QSFs that satisfies the second target bit budget and the second one of the anchor QSFs that does not satisfy the second target bit budget, determine, based on the first one of the anchor QSFs and the second one of the anchor QSFs, respective macroblock QSFs to quantize corresponding ones of the macroblocks of the image frame, and configure the encoder circuitry with the macroblock QSFs to cause the encoder circuitry to perform a second process iteration to encode the image frame based on the macroblock QSFs.

Example 14 includes the apparatus of example 13, wherein one or more of the at least one programmable circuit is to initialize the macroblock QSFs to the first one of the anchor QSFs, and promote select ones of the macroblock QSFs to the second one of the anchor QSFs based on a rate distortion optimization (RDO) procedure and the second target bit budget.

Example 15 includes the apparatus of example 13, wherein one or more of the at least one programmable circuit is to initialize the macroblock QSFs to the second one of the anchor QSFs, and demote select ones of the macroblock QSFs to the first one of the anchor QSFs based on an RDO procedure and the second target bit budget.

Example 16 includes the apparatus of example 1, wherein the respective numbers of bits are respective first numbers of bits to encode the AC coefficients of the macroblock based on the corresponding anchor QSFs, the estimated QSF is a first estimated QSF, the target bit budget is a first target bit budget, and the encoder circuitry is to quantize AC coefficients of respective ones of a plurality of macroblocks of an image frame based on the anchor QSFs to determine respective second numbers of bits used to encode the image frame based on the corresponding anchor QSFs, and at least one of output or store the respective second numbers of bits used to encode the image frame based on the corresponding anchor QSFs, and one or more of the at least one programmable circuit is to determine, based on the respective second numbers of bits used to encode the image frame based on the corresponding anchor QSFs, respective macroblock QSFs to quantize corresponding ones of the macroblocks of the image frame to satisfy a second target bit budget associated with encoding the image frame, and configure the encoder circuitry with the macroblock QSFs to cause the encoder circuitry to perform a second process iteration to encode the image frame based on the macroblock QSFs.

Example 17 includes the apparatus of example 16, wherein one or more of the at least one programmable circuit is to select ones of the anchor QSFs to be the respective macroblock QSFs based on the respective second numbers of bits used to encode the image frame based on the corresponding anchor QSFs and an RDO operation.

Example 18 includes the apparatus of example 16, wherein one or more of the at least one programmable circuit is to select the respective macroblock QSF based on the respective second numbers of bits used to encode the image frame based on the corresponding anchor QSFs and an AI model.

Example 19 includes the apparatus of example 1, wherein the macroblock is a first macroblock of an image frame, the respective numbers of bits are respective first numbers of bits to encode the AC coefficients of the first macroblock based on the corresponding anchor QSFs, the estimated QSF is a first estimated QSF, the target bit budget is a first target bit budget, and the encoder circuitry is to quantize AC coefficients of a second macroblock of the image frame based on the anchor QSFs to determine respective second numbers of bits to encode the AC coefficients of the second macroblock based on the corresponding second anchor QSFs, and interpolate between the respective second numbers of bits associated with at least two of the anchor QSFs to determine a second estimated QSF to encode the second macroblock to satisfy a second target bit budget different from the first target bit budget.

Example 20 includes the apparatus of example 19, wherein the encoder circuitry is to quantize the AC coefficients of the first macroblock based on the first estimated QSF, and quantize the AC coefficients of a second macroblock based on the second estimated QSF.

Example 21 includes the apparatus of example 1, wherein the macroblock includes a first block and a second block, and the encoder circuitry is to quantize the macroblock based on one of the estimated QSF, a frame QSF determined by the encoder circuitry or a macroblock QSF specified by one or more of the at least one programmable circuit, the quantized macroblock including first quantized AC coefficients associated with the first block and second quantized AC coefficients associated with the second block, select a first one of the first quantized AC coefficients associated with the first block followed by a first one of the second quantized AC coefficients associated with the second block to be included in an output bitstream, repeatedly select a next one of the first quantized AC coefficients associated with the first block followed by a next one of the second quantized AC coefficients associated with the second block to be included in the output bitstream until a stopping condition is met, and pack the selected ones of the first quantized AC coefficients associated with the first block followed by the selected ones of the second quantized AC coefficients associated with the second block into the output bitstream.

Example 22 includes the apparatus of example 21, wherein the stopping condition is met when insufficient bits are available to include another one of the first quantized AC coefficients or the second quantized AC coefficients in the output bitstream.

Example 23 includes the apparatus of example 21 or example 22, wherein the stopping condition is met when all of the first quantized AC coefficients and the second quantized AC coefficients have been selected for inclusion in the output bitstream.

Example 24 includes the apparatus of any of examples 21 to 23, wherein the macroblock is a first macroblock, and the encoder circuitry is to use excess bits available after packing the first macroblock into the output bitstream to pack a subsequent second macroblock into the output bitstream.

Example 25 includes a system comprising means for encoding video, the means for encoding video to quantize alternating current (AC) coefficients of a macroblock based on a plurality of anchor quantization scale factors (QSFs) to determine respective numbers of bits used to encode the AC coefficients of the macroblock based on the corresponding anchor QSFs, and interpolate between the respective numbers of bits associated with at least two of the anchor QSFs to determine an estimated QSF, the estimated QSF to satisfy a target bit budget associated with encoding the macroblock, and means for configuring the means for encoding video.

Example 26 includes the system of example 25, wherein the means for configuring is to provide the plurality of anchor QSFs and the target bit budget to the means for encoding video.

Example 27 includes the system of example 25 or example 26, wherein the means for encoding video is to interpolate between the respective numbers of bits associated with the at least two of the anchor QSFs via a piecewise linear interpolation.

Example 28 includes the system of any of examples 25 to 27, wherein the means for encoding video is to encode the macroblock based on the estimated QSF, and perform a round-robin procedure to pack bits of the encoded macroblock into an output bitstream.

Example 29 includes at least one non-transitory computer-readable storage medium comprising instructions to cause at least programmable circuit to at least configure video encoder circuitry to (i) quantize alternating current (AC) coefficients of a macroblock based on a plurality of anchor quantization scale factors (QSFs) to determine respective numbers of bits used to encode the AC coefficients of the macroblock based on the corresponding anchor QSFs, and (ii) interpolate between the respective numbers of bits associated with at least two of the anchor QSFs to determine an estimated QSF, the estimated QSF to satisfy a target bit budget associated with encoding the macroblock, configure the video encoder circuitry to encode the macroblock based on the estimated QSF into an output bitstream, and cause at least one of transmission or storage of the output bitstream.

Example 30 includes the at least one non-transitory computer-readable storage medium of example 29, wherein the instructions are to cause one or more of the at least one programmable circuit to provide the plurality of anchor QSFs and the target bit budget to the video encoder circuitry.

Example 31 includes a video encoder comprising circuitry to quantize alternating current (AC) coefficients of a macroblock based on a plurality of anchor quantization scale factors (QSFs) to determine respective numbers of bits used to encode the AC coefficients of the macroblock based on the corresponding anchor QSFs, and interpolate between the respective numbers of bits associated with at least two of the anchor QSFs to determine an estimated QSF, the estimated QSF to satisfy a target bit budget associated with encoding the macroblock.

Example 32 includes the video encoder of example 31, wherein the circuitry is to interpolate between the respective numbers of bits associated with the at least two of the anchor QSFs via a piecewise linear interpolation.

Example 33 includes the video encoder of example 32, wherein the circuitry is to at least one of (i) apply a nonlinear transform to the at least two of the anchor QSFs to compute nonlinear values corresponding to the at least two of the anchor QSFs, or (ii) apply the nonlinear transform to the respective numbers of bits associated with the at least two of the anchor QSFs to compute nonlinear values corresponding to the respective numbers of bits, and perform the piecewise linear interpolation based on at least one of (i) the nonlinear values corresponding to the at least two of the anchor QSFs, or (ii) the nonlinear values corresponding to the respective numbers of bits.

Example 34 includes the video encoder of example 33, wherein the nonlinear transform is a logarithmic function.

Example 35 includes the video encoder of any of examples 31 to 34, wherein the encoder circuitry is to quantize the macroblock based on the estimated QSF.

Example 36 includes the video encoder of example 31, wherein the macroblock is a first macroblock of an image frame, the respective numbers of bits are respective first numbers of bits to encode the AC coefficients of the first macroblock based on the corresponding anchor QSFs, the estimated QSF is a first estimated QSF, and the circuitry is to quantize AC coefficients of a second macroblock of the image frame based on the anchor QSFs to determine respective second numbers of bits to encode the AC coefficients of the second macroblock based on the corresponding anchor QSFs, and interpolate between the respective second numbers of bits associated with at least two of the anchor QSFs to determine a second estimated QSF to encode the second macroblock to satisfy the target bit budget.

Example 37 includes the video encoder of example 31, wherein the respective numbers of bits are respective first numbers of bits to encode the AC coefficients of the macroblock based on the corresponding anchor QSFs, the estimated QSF is a first estimated QSF, the target bit budget is a first target bit budget, and the circuitry is to quantize AC coefficients of respective ones of a plurality of macroblocks of an image frame based on the anchor QSFs to determine respective second numbers of bits used to encode the image frame based on the corresponding anchor QSFs, interpolate between the respective second numbers of bits associated with a first one of the anchor QSFs and a second one of the anchor QSFs to determine a second estimated QSF to satisfy a second target bit budget associated with encoding the image frame, the first one of the anchor QSFs to satisfy the second target bit budget, the second one of the anchor QSFs not to satisfy the second target bit budget, and at least one of output or store the second estimated QSF.

Example 38 includes the video encoder of example 37, wherein the second estimated QSF is a fractional QSF, and the circuitry is to convert the fractional QSF to an integer QSF to be used to quantize the AC coefficients of the macroblocks of the image frame.

Example 39 includes the video encoder of example 37, wherein the second estimated QSF is a fractional QSF, and the circuitry is to round the fractional QSF up to a first integer QSF to be used to quantize the AC coefficients of a first group of the macroblocks of the image frame, and round the fractional QSF down to a second integer QSF to be used to quantize the AC coefficients of a second group of the macroblocks of the image frame.

Example 40 includes the video encoder of example 31, wherein the macroblock is a first macroblock of an image frame, the respective numbers of bits are respective first numbers of bits to encode the AC coefficients of the first macroblock based on the corresponding anchor QSFs, the estimated QSF is a first estimated QSF, the target bit budget is a first target bit budget, and the circuitry is to quantize AC coefficients of a second macroblock of the image frame based on the anchor QSFs to determine respective second numbers of bits to encode the AC coefficients of the second macroblock based on the corresponding second anchor QSFs, and interpolate between the respective second numbers of bits associated with at least two of the anchor QSFs to determine a second estimated QSF to encode the second macroblock to satisfy a second target bit budget different from the first target bit budget.

Example 41 includes the video encoder of example 40, wherein the encoder circuitry is to quantize the AC coefficients of the first macroblock based on the first estimated QSF, and quantize the AC coefficients of a second macroblock based on the second estimated QSF.

Example 42 includes the video encoder of example 31, wherein the macroblock includes a first block and a second block, and the circuitry is to quantize the macroblock based on one of the estimated QSF, a frame QSF determined by the encoder circuitry or a macroblock QSF specified by one or more of the at least one programmable circuit, the quantized macroblock including first quantized AC coefficients associated with the first block and second quantized AC coefficients associated with the second block, select a first one of the first quantized AC coefficients associated with the first block followed by a first one of the second quantized AC coefficients associated with the second block to be included in an output bitstream, repeatedly select a next one of the first quantized AC coefficients associated with the first block followed by a next one of the second quantized AC coefficients associated with the second block to be included in the output bitstream until a stopping condition is met, and pack the selected ones of the first quantized AC coefficients associated with the first block followed by the selected ones of the second quantized AC coefficients associated with the second block into the output bitstream.

Example 43 includes the video encoder of example 42, wherein the stopping condition is met when insufficient bits are available to include another one of the first quantized AC coefficients or the second quantized AC coefficients in the output bitstream.

Example 44 includes the video encoder of example 42 or example 43, wherein the stopping condition is met when all of the first quantized AC coefficients and the second quantized AC coefficients have been selected for inclusion in the output bitstream.

Example 45 includes the video encoder of any of examples 42 to 44, wherein the macroblock is a first macroblock, and the circuitry is to use excess bits available after packing the first macroblock into the output bitstream to pack a subsequent second macroblock into the output bitstream.

Example 46 includes a method comprising quantizing alternating current (AC) coefficients of a macroblock based on a plurality of anchor quantization scale factors (QSFs) to determine respective numbers of bits used to encode the AC coefficients of the macroblock based on the corresponding anchor QSFs, and interpolating between the respective numbers of bits associated with at least two of the anchor QSFs to determine an estimated QSF, the estimated QSF to satisfy a target bit budget associated with encoding the macroblock.

Example 47 includes the method of example 46, including providing the plurality of anchor QSFs and the target bit budget to the encoder circuitry.

Example 48 includes the method of example 47, wherein the target bit budget is a first target bit budget, and including dividing a second target bit budget associated with encoding a frame by a number of macroblocks in the frame to determine the first target bit budget.

Example 49 includes the method of any of examples 46 to 48, including interpolating between the respective numbers of bits associated with the at least two of the anchor QSFs via a piecewise linear interpolation.

Example 50 includes the method of example 49, including at least one of (i) applying a nonlinear transform to the at least two of the anchor QSFs to compute nonlinear values corresponding to the at least two of the anchor QSFs, or (ii) applying the nonlinear transform to the respective numbers of bits associated with the at least two of the anchor QSFs to compute nonlinear values corresponding to the respective numbers of bits, and performing the piecewise linear interpolation based on at least one of (i) the nonlinear values corresponding to the at least two of the anchor QSFs, or (ii) the nonlinear values corresponding to the respective numbers of bits.

Example 51 includes the method of example 50, wherein the nonlinear transform is a logarithmic function.

Example 52 includes the method of any of examples 46 to 51, wherein the encoder circuitry is to quantize the macroblock based on the estimated QSF.

Example 53 includes the method of example 46, wherein the macroblock is a first macroblock of an image frame, the respective numbers of bits are respective first numbers of bits to encode the AC coefficients of the first macroblock based on the corresponding anchor QSFs, the estimated QSF is a first estimated QSF, and including quantizing AC coefficients of a second macroblock of the image frame based on the anchor QSFs to determine respective second numbers of bits to encode the AC coefficients of the second macroblock based on the corresponding anchor QSFs, and interpolating between the respective second numbers of bits associated with at least two of the anchor QSFs to determine a second estimated QSF to encode the second macroblock to satisfy the target bit budget.

Example 54 includes the method of example 46, wherein the respective numbers of bits are respective first numbers of bits to encode the AC coefficients of the macroblock based on the corresponding anchor QSFs, the estimated QSF is a first estimated QSF, the target bit budget is a first target bit budget, and including quantizing AC coefficients of respective ones of a plurality of macroblocks of an image frame based on the anchor QSFs to determine respective second numbers of bits used to encode the image frame based on the corresponding anchor QSFs, interpolating between the respective second numbers of bits associated with a first one of the anchor QSFs and a second one of the anchor QSFs to determine a second estimated QSF to satisfy a second target bit budget associated with encoding the image frame, the first one of the anchor QSFs to satisfy the second target bit budget, the second one of the anchor QSFs not to satisfy the second target bit budget, and at least one of outputting or storing the second estimated QSF.

Example 55 includes the method of example 54, including configuring the encoder circuitry with the plurality of anchor QSFs and the first target bit budget to cause the encoder circuitry to perform a first process iteration to determine and output the second estimated QSF, and configuring the encoder circuitry with the second estimated QSF to cause the encoder circuitry to perform a second process iteration to encode the image frame based on the second estimated QSF.

Example 56 includes the method of example 55, wherein the second estimated QSF is a fractional QSF, and including converting the fractional QSF to an integer QSF to be used to quantize the AC coefficients of the macroblocks of the image frame.

Example 57 includes the apparatus of example 55, wherein the second estimated QSF is a fractional QSF, and including rounding the fractional QSF up to a first integer QSF to be used to quantize the AC coefficients of a first group of the macroblocks of the image frame, and rounding the fractional QSF down to a second integer QSF to be used to quantize the AC coefficients of a second group of the macroblocks of the image frame.

Example 58 includes the method of example 54 wherein the encoder circuitry outputs the first one of the anchor QSFs and the second one of the anchor QSFs, and including configuring the encoder circuitry with the plurality of anchor QSFs and the first target bit budget to cause the encoder circuitry to perform a first process iteration to determine and output the first one of the anchor QSFs that satisfies the second target bit budget and the second one of the anchor QSFs that does not satisfy the second target bit budget, determining, based on the first one of the anchor QSFs and the second one of the anchor QSFs, respective macroblock QSFs to quantize corresponding ones of the macroblocks of the image frame, and configuring the encoder circuitry with the macroblock QSFs to cause the encoder circuitry to perform a second process iteration to encode the image frame based on the macroblock QSFs.

Example 59 includes the method of example 58, including initializing the macroblock QSFs to the first one of the anchor QSFs, and promoting select ones of the macroblock QSFs to the second one of the anchor QSFs based on a rate distortion optimization (RDO) procedure and the second target bit budget.

Example 60 includes the method of example 58, including initializing the macroblock QSFs to the second one of the anchor QSFs, and demoting select ones of the macroblock QSFs to the first one of the anchor QSFs based on an RDO procedure and the second target bit budget.

Example 61 includes the method of example 46, wherein the respective numbers of bits are respective first numbers of bits to encode the AC coefficients of the macroblock based on the corresponding anchor QSFs, the estimated QSF is a first estimated QSF, the target bit budget is a first target bit budget, and including quantizing AC coefficients of respective ones of a plurality of macroblocks of an image frame based on the anchor QSFs to determine respective second numbers of bits used to encode the image frame based on the corresponding anchor QSFs, at least one of outputting or storing the respective second numbers of bits used to encode the image frame based on the corresponding anchor QSFs, determining, based on the respective second numbers of bits used to encode the image frame based on the corresponding anchor QSFs, respective macroblock QSFs to quantize corresponding ones of the macroblocks of the image frame to satisfy a second target bit budget associated with encoding the image frame, and configuring the encoder circuitry with the macroblock QSFs to cause the encoder circuitry to perform a second process iteration to encode the image frame based on the macroblock QSFs.

Example 62 includes the method of example 61, including selecting ones of the anchor QSFs to be the respective macroblock QSFs based on the respective second numbers of bits used to encode the image frame based on the corresponding anchor QSFs and an RDO operation.

Example 63 includes the method of example 61, wherein including selecting the respective macroblock QSF based on the respective second numbers of bits used to encode the image frame based on the corresponding anchor QSFs and an AI model.

Example 64 includes the method of example 46, wherein the macroblock is a first macroblock of an image frame, the respective numbers of bits are respective first numbers of bits to encode the AC coefficients of the first macroblock based on the corresponding anchor QSFs, the estimated QSF is a first estimated QSF, the target bit budget is a first target bit budget, and including quantizing AC coefficients of a second macroblock of the image frame based on the anchor QSFs to determine respective second numbers of bits to encode the AC coefficients of the second macroblock based on the corresponding second anchor QSFs, and interpolating between the respective second numbers of bits associated with at least two of the anchor QSFs to determine a second estimated QSF to encode the second macroblock to satisfy a second target bit budget different from the first target bit budget.

Example 65 includes the method of example 65, including quantizing the AC coefficients of the first macroblock based on the first estimated QSF, and quantizing the AC coefficients of a second macroblock based on the second estimated QSF.

Example 66 includes the method of example 46, wherein the macroblock includes a first block and a second block, and including quantizing the macroblock based on one of the estimated QSF, a frame QSF determined by the encoder circuitry or a macroblock QSF specified by one or more of the at least one programmable circuit, the quantized macroblock including first quantized AC coefficients associated with the first block and second quantized AC coefficients associated with the second block, selecting a first one of the first quantized AC coefficients associated with the first block followed by a first one of the second quantized AC coefficients associated with the second block to be included in an output bitstream, repeatedly selecting a next one of the first quantized AC coefficients associated with the first block followed by a next one of the second quantized AC coefficients associated with the second block to be included in the output bitstream until a stopping condition is met, and packing the selected ones of the first quantized AC coefficients associated with the first block followed by the selected ones of the second quantized AC coefficients associated with the second block into the output bitstream.

Example 67 includes the method of example 66, wherein the stopping condition is met when insufficient bits are available to include another one of the first quantized AC coefficients or the second quantized AC coefficients in the output bitstream.

Example 68 includes the method of example 66 or example 67, wherein the stopping condition is met when all of the first quantized AC coefficients and the second quantized AC coefficients have been selected for inclusion in the output bitstream.

Example 69 includes the method of any of examples 66 to 68, wherein the macroblock is a first macroblock, and including using excess bits available after packing the first macroblock into the output bitstream to pack a subsequent second macroblock into the output bitstream.

Example 70 includes at least one machine-readable medium comprising machine-readable instructions to cause at least one programmable circuit to perform the method of any one of examples 46 to example 69.

Example 71 includes an apparatus to perform the method of any one of examples 46 to example 69.

Example 72 includes a method performed by any one of the apparatus of examples 1 to example 24.

Example 73 includes at least one machine-readable medium comprising the machine-readable instructions of any one of the apparatus of examples 1 to example 24.

Example 74 includes a method performed by any one of the apparatus of examples 1 to example 24.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
encoder circuitry to:
quantize alternating current (AC) coefficients of a macroblock based on a plurality of anchor quantization scale factors (QSFs) to determine respective numbers of bits used to encode the AC coefficients of the macroblock based on the corresponding anchor QSFs; and
interpolate between the respective numbers of bits associated with at least two of the anchor QSFs to determine an estimated QSF, the estimated QSF to satisfy a target bit budget associated with encoding the macroblock;
machine-readable instructions; and
at least one programmable circuit to be programmed based on the instructions to configure the encoder circuitry.

2-3. (canceled)

4. The apparatus of claim 1, wherein the encoder circuitry is to interpolate between the respective numbers of bits associated with the at least two of the anchor QSFs via a piecewise linear interpolation.

5. The apparatus of claim 4, wherein the encoder circuitry is to:
at least one of (i) apply a nonlinear transform to the at least two of the anchor QSFs to compute nonlinear values corresponding to the at least two of the anchor QSFs, or (ii) apply the nonlinear transform to the respective numbers of bits associated with the at least two of the anchor QSFs to compute nonlinear values corresponding to the respective numbers of bits; and
perform the piecewise linear interpolation based on at least one of (i) the nonlinear values corresponding to the at least two of the anchor QSFs, or (ii) the nonlinear values corresponding to the respective numbers of bits.

6. The apparatus of claim 5, wherein the nonlinear transform is a logarithmic function.

7-8. (canceled)

9. The apparatus of claim 1, wherein the respective numbers of bits are respective first numbers of bits to encode the AC coefficients of the macroblock based on the corresponding anchor QSFs, the estimated QSF is a first estimated QSF, the target bit budget is a first target bit budget, and the encoder circuitry is to:
quantize AC coefficients of respective ones of a plurality of macroblocks of an image frame based on the anchor QSFs to determine respective second numbers of bits used to encode the image frame based on the corresponding anchor QSFs;
interpolate between the respective second numbers of bits associated with a first one of the anchor QSFs and a second one of the anchor QSFs to determine a second estimated QSF to satisfy a second target bit budget associated with encoding the image frame, the first one of the anchor QSFs to satisfy the second target bit budget, the second one of the anchor QSFs not to satisfy the second target bit budget; and
at least one of output or store the second estimated QSF.

10. The apparatus of claim 9, wherein one or more of the at least one programmable circuit is to:
configure the encoder circuitry with the plurality of anchor QSFs and the first target bit budget to cause the encoder circuitry to perform a first process iteration to determine and output the second estimated QSF; and
configure the encoder circuitry with the second estimated QSF to cause the encoder circuitry to perform a second process iteration to encode the image frame based on the second estimated QSF.

11. The apparatus of claim 10, wherein the second estimated QSF is a fractional QSF, and the encoder circuitry is to convert the fractional QSF to an integer QSF to be used to quantize the AC coefficients of the macroblocks of the image frame.

12. The apparatus of claim 10, wherein the second estimated QSF is a fractional QSF, and the encoder circuitry is to:
round the fractional QSF up to a first integer QSF to be used to quantize the AC coefficients of a first group of the macroblocks of the image frame; and
round the fractional QSF down to a second integer QSF to be used to quantize the AC coefficients of a second group of the macroblocks of the image frame.

13. The apparatus of claim 9 wherein the encoder circuitry is to output the first one of the anchor QSFs and the second one of the anchor QSFs, and one or more of the at least one programmable circuit is to:
configure the encoder circuitry with the plurality of anchor QSFs and the first target bit budget to cause the encoder circuitry to perform a first process iteration to determine and output the first one of the anchor QSFs that satisfies the second target bit budget and the second one of the anchor QSFs that does not satisfy the second target bit budget;
determine, based on the first one of the anchor QSFs and the second one of the anchor QSFs, respective macroblock QSFs to quantize corresponding ones of the macroblocks of the image frame; and
configure the encoder circuitry with the macroblock QSFs to cause the encoder circuitry to perform a second process iteration to encode the image frame based on the macroblock QSFs.

14. The apparatus of claim 13, wherein one or more of the at least one programmable circuit is to:
initialize the macroblock QSFs to the first one of the anchor QSFs; and
promote select ones of the macroblock QSFs to the second one of the anchor QSFs based on a rate distortion optimization (RDO) procedure and the second target bit budget.

15. The apparatus of claim 13, wherein one or more of the at least one programmable circuit is to:
initialize the macroblock QSFs to the second one of the anchor QSFs; and
demote select ones of the macroblock QSFs to the first one of the anchor QSFs based on an RDO procedure and the second target bit budget.

16. The apparatus of claim 1, wherein the respective numbers of bits are respective first numbers of bits to encode the AC coefficients of the macroblock based on the corresponding anchor QSFs, the estimated QSF is a first estimated QSF, the target bit budget is a first target bit budget, and:
the encoder circuitry is to:
quantize AC coefficients of respective ones of a plurality of macroblocks of an image frame based on the anchor QSFs to determine respective second numbers of bits used to encode the image frame based on the corresponding anchor QSFs; and
at least one of output or store the respective second numbers of bits used to encode the image frame based on the corresponding anchor QSFs; and
one or more of the at least one programmable circuit is to:
determine, based on the respective second numbers of bits used to encode the image frame based on the corresponding anchor QSFs, respective macroblock QSFs to quantize corresponding ones of the macroblocks of the image frame to satisfy a second target bit budget associated with encoding the image frame; and
configure the encoder circuitry with the macroblock QSFs to cause the encoder circuitry to perform a second process iteration to encode the image frame based on the macroblock QSFs.

17. The apparatus of claim 16, wherein one or more of the at least one programmable circuit is to select ones of the anchor QSFs to be the respective macroblock QSFs based on the respective second numbers of bits used to encode the image frame based on the corresponding anchor QSFs and an RDO operation.

18. The apparatus of claim 16, wherein one or more of the at least one programmable circuit is to select the respective macroblock QSF based on the respective second numbers of bits used to encode the image frame based on the corresponding anchor QSFs and an AI model.

19. The apparatus of claim 1, wherein the macroblock is a first macroblock of an image frame, the respective numbers of bits are respective first numbers of bits to encode the AC coefficients of the first macroblock based on the corresponding anchor QSFs, the estimated QSF is a first estimated QSF, the target bit budget is a first target bit budget, and the encoder circuitry is to:
quantize AC coefficients of a second macroblock of the image frame based on the anchor QSFs to determine respective second numbers of bits to encode the AC coefficients of the second macroblock based on the corresponding second anchor QSFs; and
interpolate between the respective second numbers of bits associated with at least two of the anchor QSFs to determine a second estimated QSF to encode the second macroblock to satisfy a second target bit budget different from the first target bit budget.

20. The apparatus of claim 19, wherein the encoder circuitry is to:
quantize the AC coefficients of the first macroblock based on the first estimated QSF; and
quantize the AC coefficients of a second macroblock based on the second estimated QSF.

21. The apparatus of claim 1, wherein the macroblock includes a first block and a second block, and the encoder circuitry is to:
quantize the macroblock based on one of the estimated QSF, a frame QSF determined by the encoder circuitry or a macroblock QSF specified by one or more of the at least one programmable circuit, the quantized macroblock including first quantized AC coefficients associated with the first block and second quantized AC coefficients associated with the second block;
select a first one of the first quantized AC coefficients associated with the first block followed by a first one of the second quantized AC coefficients associated with the second block to be included in an output bitstream;
repeatedly select a next one of the first quantized AC coefficients associated with the first block followed by a next one of the second quantized AC coefficients associated with the second block to be included in the output bitstream until a stopping condition is met; and
pack the selected ones of the first quantized AC coefficients associated with the first block followed by the selected ones of the second quantized AC coefficients associated with the second block into the output bitstream.

22. The apparatus of claim 21, wherein the stopping condition is met when insufficient bits are available to include another one of the first quantized AC coefficients or the second quantized AC coefficients in the output bitstream.

23. The apparatus of claim 21, wherein the stopping condition is met when all of the first quantized AC coefficients and the second quantized AC coefficients have been selected for inclusion in the output bitstream.

24. The apparatus of claim 21, wherein the macroblock is a first macroblock, and the encoder circuitry is to use excess bits available after packing the first macroblock into the output bitstream to pack a subsequent second macroblock into the output bitstream.

25-30. (canceled)
